(19) United States
(12) Patent Application Publication
(10) Pub. No.: US 2026/0248672 A1
(43) Pub. Date: Aug. 27, 2026

(54) SYSTEMS AND METHODS FOR SURGICAL POSITIONING

(71) Applicant: Mizuho Orthopedic Systems, Inc., Union CIty, CA (US)

(72) Inventors: Stephan Schmid, San Francisco, CA (US); Vincent Hodges, San Jose, CA (US); Peter Le, Union CIty, CA (US); Mike DeMaria, Union CIty, CA (US); Mark DeSilets, San Jose, CA (US)

(21) Appl. No.: 19/370,733

(22) Filed: Oct. 27, 2025

Related U.S. Application Data
(60) Provisional application No. 63/712,527, filed on Oct. 27, 2024.
(60) Provisional application No. 63/769,439, filed on Mar. 10, 2025.

(51) Int. Cl. A61G 13/12

(52) U.S. Cl. CPC A61G 13/1245; A61G 13/123; A61G 13/125; A61G 2200/325; A61G 2200/327

(57) ABSTRACT

A positioning system for a surgical procedure is provided. The positioning system may include a surgery table, a spar base, and a spar extending from the spar base to support at least one leg of a patient. The spar base may be positioned beneath a platform of the surgery table and may translate a distance along the surgery in a direction from the distal end to the proximal end of the surgery table.

### RELATED APPLICATION DATA

This application claims priority to U.S. Provisional Application No. 63/712,527, filed Oct. 27, 2024 the disclosure of which is hereby incorporated by reference in its entirety.

### FIELD

This invention relates to medical procedures, and more particularly, to surgery tables used for multiple types of surgeries.

### BACKGROUND

Patient support apparatuses assist in positioning and supporting a patient before, during, and after a medical procedure. Surgery tables are patient support apparatuses used in surgical procedures, and allow a surgeon access to a surgical site and the ability to maneuver, position, or reposition the patient before, during, and after the surgical procedure. Surgeons endeavor to adjust surgery tables while minimizing or preventing risk to the patient and by maintaining a sterile barrier between the surgical site and sources of contamination, e.g., surfaces of the patient's body, which may host pathogens that are harmful if they enter the patient through an incision, and surgical equipment, which may not be completely free of contaminants even after being sanitized. Surgical drapes may be used to create the sterile barrier by being draped over at least a portion of the patient and the surgery table.

### SUMMARY

In one general aspect, system may include a surgery table having a proximal end and a distal end, and a platform configured to support at least a portion of the patient. System may also include a spar base positioned beneath the platform at the proximal end. System may furthermore include a spar extending from the spar base and configured to support at least one leg of the patient. System may in addition include where the spar base is configured to translate a distance along the surgery table in a direction from the distal end to the proximal end. Other embodiments of this aspect include corresponding computer systems, apparatus, and computer programs recorded on one or more computer storage devices, each configured to perform the actions of the methods.

Implementations may include one or more of the following features.

System may include: a foot support configured to support at least one foot of the at least one leg of the patient, where the foot support is coupled to the spar. System where the surgery table further may include a traction mechanism coupled to the spar base, and where the traction mechanism is configured to translate the spar base along the surgery table such that a traction load is applied by the traction mechanism to the at least one leg of the patient. System where the traction mechanism may include a lead screw. System where the surgery table may include a platform, and where the platform may include the lead screw. System where the lead screw is coupled to and configured to translate the spar base. System where the traction mechanism is configured to apply traction by pushing the spar outwardly from the surgery table in an inferior direction. System where the surgery table further may include a strain gauge configured to measure a traction load. System where the surgery table further may include a display configured to indicate a measurement of the traction load. System where the spar base is configured to articulate the spar in a pitch direction, where the spar is configured to articulate in a downward pitch direction to a downward pitch angle from an axis extending along the spar when the spar is in a straight configuration, the downward pitch angle being up to about 45 degrees. System where a proximal end of the spar does not may include a traction mechanism. System where the proximal end of the spar may include a foot support module configured to support at least one foot of the at least one leg of the patient, and where the proximal end of the spar is configured to reach a position proximate a ground surface supporting the system when the spar is articulated in a downward pitch direction such that the foot of the patient is proximate the ground surface. System where the proximal end of the spar further may include a handle configured to allow an user to articulate the spar. System where the handle may include one or more buttons to unlock the spar to allow the spar to be articulated. System where a proximal end of the spar may include one or more first traction controls configured to adjust a traction load. System where the surgery table further may include one or more second traction controls configured to adjust the traction load. System where the second traction controls are disposed along the platform proximate the proximal end the surgery table. System where the second traction controls may include a first button configured to incrementally translate the spar in an inferior direction. System where the second traction controls may include a second button configured to incrementally translate the spar in a superior direction. System where the second traction controls may include a third button configured to allow for manual translation of the spar. System where the second traction controls may include a fourth button configured to rotate a foot support configured to support a foot of the patient. System may include a pendant, where the surgery table further may include one or more third traction controls configured to adjust the traction load, and where the pendant may include the third traction controls. System where the foot support is not pulled away from the surgical table from the distal end of the spar. System where the foot support may include one or more binding straps. System where the foot support may include a first binding strap configured to secure the at least one foot of the patient and a second binding strap configured to secure at least a portion of one leg of the patient. System where the foot support may include an upper pad configured to contact a top of the at least one foot of the patient. System where the foot support may include a lower pad configured to contact a back of the at least one foot of the patient, the back having the location where an Achilles tendon of the at least one foot of the patient is located, and where the lower pad may include one or more sides configured to contact the at least one foot of the patient at least partially above the malleolus. System where the foot support may include an inner plate and a cinch strap, and where the cinch strap is secured around the lower pad. System where the foot support may include an outer plate proximal to the inner plate. System where the cinch strap is coupled to the outer plate. System where the traction mechanism is configured to translate the spar base along the surgery table such that a traction load is applied to the at least one leg of the patient, and where the traction load being applied pushes the outer plate away from the inner plate to create a gap between the outer plate and the inner plate. System where the gap is reduced when the traction load is reduced or no longer applied. System where the cinch strap is pulled to secure the lower pad and the inner plate to the at least one foot of the patient as the traction load is applied. System where the cinch strap is released to release the lower pad from the at least one foot of the patient when the traction load is reduced or no longer applied. System where a length of the cinch strap that is pulled as the outer plate is pushed away from the inner plate is smaller than the size of the gap. System where the inner plate may include a foot portion and a leg portion, the foot portion and the leg portion of the inner plate being at an angle beta relative to one another, where the outer plate may include a foot portion and a leg portion, the foot portion and the leg portion of the outer plate being at an angle beta relative to one another, and where the angle alpha and the angle beta are obtuse angles. System where the upper pad and the lower pad are configured to hug curves of the at least one foot of the patient as the traction load is applied because of the angle alpha and the angle beta being obtuse angles. System where the inner plate and the outer plate are not right-angle plates. System where the inner plate may include a foot portion and a leg portion, the foot portion and the leg portion of the inner plate being at an angle beta relative to one another, and where the angle beta is an obtuse angle. System where the outer plate may include a foot portion and a leg portion, the foot portion and the leg portion of the outer plate being at an angle beta relative to one another, and where the angle alpha is an obtuse angle. System where the inner plate and the outer plate are coupled to one another by a bushing such that the outer plate is configured to slide relative to the inner plate. System where the outer plate is coupled to the spar. System where the inner plate is not coupled to the spar. System where the outer plate may include at least one universal sterile interface (USI) plug. System where the foot support may include a foot portion and a heel portion. System where the foot portion may include one or more openings and one or more slits. System where the foot portion may include a buckle. System may include: a foot support liner, where the foot support is configured to receive the liner. System where the liner is disposable. System where the liner may include a strap, where the buckle may include an opening configured to receive the strap, and where the strap may include a tab, the one or more slits configured to receive the tab. System where the tab may include a T-shape to retain strap in the one or more slits. System where the foot support and the liner are malleable such that the foot support and the liner are configured to wrap around the foot of the patient. System may include: a retention strap, where the retention strap is configured to secure around the foot, the foot support, and the liner. System where the retention strap is disposable. System where the foot support may include one or more USI plugs. System where the foot portion may include one or more USI plugs, and where the heel portion may include one or more USI plugs. System may include: a foot support module configured to support the at least one foot of the at least one leg of the patient, where the foot support module is coupled to the spar. System where the foot support module is in a working space. System where the foot support module and the foot support are separated by a drape. System where the foot support is in a sterile space. System where the drape may include a first hard point, the foot support configured to couple to the foot support module via the first hard point. System where the drape may include a fabric portion and a film portion. System where the proximal end of the spar further may include a handle configured to allow an user to articulate the spar, the film portion being disposed over the handle such that the user may view the handle through the drape. System where the film portion is a first film portion, and where the drape may include a second film portion configured to be disposed over one or more controls for the system. System may include: a femur hook module, where the second film portion is configured to be disposed over the femur hook module. System may include: a femur hook and a bracket, where the femur hook is coupled to the bracket, and the bracket is coupled to the femur hook module across the drape such that the femur hook and the bracket are in the sterile space and the femur hook module is in the working space. System where the drape may include a second hard point, the bracket configured to couple to the femur hook module via the second hard point. System where the foot support module and the femur hook module each may include one or more USI ports configured to receive two or more USI attachments, each of the USI attachments being distinct from another one of the USI attachments, where the two or more USI attachments may include the foot support and the bracket. System where the foot support and the bracket each may include one or more USI plugs configured to be received by each of the one or more USI ports. System where the foot support module may include an USI port configured to receive two or more USI attachments. System where the USI attachments may include the foot support such that the USI port is configured to receive the foot support. System may include: one or more USI ports configured to receive two or more USI attachments, each of the USI attachments being distinct from another one of the USI attachments, where the two or more USI attachments may include the foot support. System where the foot support may include one or more USI plugs configured to be received by each of the one or more USI ports. System may include: a second foot support configured to support at least one foot of the at least one leg of the patient, where the second foot support is coupled to the spar, where the foot support is a first foot support, and where the two or more USI attachments may include the first foot support and the second foot support. System where the surgery table further may include a pelvic port at the proximal end the surgery table, the pelvic port is configured to receive a plurality of attachments configured to support at least a portion of the patient. System where the pelvic port may include an electrical coupling. System may include a pelvic port adapter, where the pelvic port may include a rail, and where the pelvic port adapter may include a track, the track configured to receive the rail such that the pelvic port adapter is coupled to the pelvic port. System where the pelvic port adapter is configured to receive the plurality of attachments. System where the pelvic port adapter may include a protrusion. System where each of the plurality of attachments may include a receptacle configured to receive the protrusion of the pelvic port adapter. System where the plurality of attachments may include a pelvic center board. System where the pelvic center board is generally triangular. System where the pelvic center board may include a center portion and one or more lateral portions extending from the center portion. System where the one or more lateral portions is pivotable relative to the center portion. System where the pelvic center board may include a bottom portion having a curvature. System where the pelvic center board may include a distal end and a proximal end, and where the proximal end is thicker longitudinally than the distal end. System where the pelvic center board may include a cross-section having a generally trapezoidal shape. System where the pelvic center board may include a distal end and a proximal end, where the distal end may include the generally trapezoidal shape, and where the proximal end may include a cross-section having a generally trapezoidal shape. System where the pelvic center board may include a distal end and a proximal end, where the distal end may include an opening to receive a perineal post core. System where the surgery table further may include a perineal post core, and where the pelvic center board may include an opening to receive the perineal post core. System where the opening and the perineal post core may include a non-circular profile. System where the non-circular profile may include a general D-shape. System where the surgery table further may include a perineal post bolster and a perineal post cover, and where the perineal post core is configured to receive the perineal post bolster and the perineal post cover. System where the perineal post bolster and the perineal post cover are non-circular. System where the perineal post bolster and the perineal post cover may include a saddle shape. System where the saddle shape may include a top portion and a bottom portion, the bottom portion being wider than the top portion, and where the saddle shape may include a distal end and a proximal end, the distal end having a top portion and a bottom portion, the top portion of the distal end being generally vertical and the bottom portion of the distal end having a curvature extending from the top portion to a distal edge of the bottom portion. System where the non-circular shape of the opening and the perineal post core is configured to maintain an orientation of the saddle portion towards the patient. System where the perineal post bolster may include a vertical groove. System where the perineal post bolster may include a first foam, and the vertical groove may include a second foam inside of the vertical groove. System where the second foam is softer than the first foam. System where the first foam is within the second foam, the second foam having the vertical groove, the second foam proximate to the first foam at the vertical groove. System where the vertical groove is generally V-shaped. System where the perineal post bolster may include a foot, and where the perineal post core is surrounded by a sleeve configured to receive the foot to couple the perineal post bolster to the perineal post core. System where the foot may include a leaf spring configured to bias the foot toward the notch. System where a perineal post may include the perineal post bolster, the perineal post cover, and the perineal post core. System may include a latch to couple the perineal post to the pelvic center board, where the latch is radiolucent. System where the latch is mechanically actuated. System where the pelvic center board may include a pad having a distal end and a proximal end opposing the distal end, and where the distal end terminates distal to the opening. System where the pad is not disposed over the distal end of the pelvic center board. System where the pad does not may include an opening to receive the perineal post core. System where the surgery table further may include a perineal post bolster and a perineal post cover, and where the perineal post core is configured to receive the perineal post bolster and the perineal post cover. System where the perineal post bolster may include an extension configured to be disposed over the distal end of the pelvic center board. System may include: a traction pad, where the traction pad is not disposed over the distal end of the pelvic center board, and where the traction pad does not may include an opening to receive the perineal post core. System where the perineal post bolster may include a distal end and a proximal end opposing the distal end, where the proximal end is configured to be disposed over at least one of the pelvic center board pad, and where the distal end may include the extension, the distal end configured to be disposed over the pelvic center board. System where the pelvic center board may include a center portion that is generally triangular, where the pelvic center board may include one or more articulable wings, the center portion intermediate to the one or more articulable wings, and where the traction pad may include one or more removable components configured to be disposed over the one or more articulable wings, the one or more removable components configured to be removed from the traction pad when the one or more articulable wings are articulated in a posterior direction. System may include: a traction pad configured to facilitate maintaining a position of the patient when traction is applied. System where the traction pad may include one or more positioning handles configured to facilitate placing the traction pad along the platform, and where the one or more positioning handles extend from the traction pad such that the one or more positioning handles avoid an imaging window. System where the traction pad may include one or more center board straps configured to secure around the pelvic center board, and where the pelvic center board straps extend around the distal end of the pelvic center board. System where the one or more center board straps extend around a nose portion of the distal end. System where the traction pad is secured around angular portions of the pelvic center board. System may include: a foam top configured to be placed on the traction pad, the traction pad being more rigid than the foam top. System where the foam top and the traction pad form a traction pad assembly, and where the traction pad assembly is configured to maintain a position of the patient as traction is applied. System may include a pelvic combo pad, where pelvic combo pad is configured to be disposed along the pelvic center board, the pelvic combo pad configured to support at least a pelvic area of the patient. System where the pelvic combo pad may include an opening and an insert, and where the opening is configured to receive the insert, the insert configured to support at least a portion of the patient. System where the insert is disposed laterally into the opening. System where the pelvic combo pad further may include an opening restraint configured to limit extension of opening to retain the insert within the pelvic combo pad. System where the plurality of attachments may include a lateral board. System where the lateral board extends over at least a portion of the spar. System may include: one or more bolsters configured to be disposed over at least a portion of the spar. System where the one or more bolsters may include a first bolster configured to be disposed over the spar proximate a gluteus muscle of the patient. System where the one or more bolsters may include a second bolster, the second bolster being smaller than the first bolster. System where the second bolster is configured to be disposed over the spar proximate a femur of the patient. System where the second bolster is configured to be disposed over the spar proximate a tibia of the patient. System may include: one or more universal attachment interface (UAI) ports configured to receive two or more table modules, each of the table modules being distinct from another one of the table modules. System where the one or more table modules may include the one or more bolsters. System may include: a femur hook module, where the one or more table modules may include the femur hook module. System may include: an UAI offset arm, where the one or more UAI ports is further configured to receive the UAI offset arm, the UAI offset arm configured to couple to the one or more UAI ports, and where the UAI offset arm is selectively disposed on the surgery table at any of the one or more UAI ports. System where the UAI offset arm may include an UAI plug configured to be received by each of the one or more UAI ports. System where the UAI port may include first opening, a second opening, and a third opening between the first opening and the second opening, where the first opening and the second opening are substantially spherical, and where the third opening is substantially rectangular. System where the first opening and the second opening are configured to guide the UAI plug of the table module such that the UAI port receives the table module. System where the first opening and the second opening each may include a bevel shape configured to guide the UAI plug of the table module such that the UAI port receives the table module. System where the UAI plug may include a dog-bone shape. System where the UAI plug may include first portion, a second portion, and a third portion between the first portion and the second portion, where the first portion and the second portion are substantially spherical, and where the third portion is substantially rectangular. System where the first portion and the second portion are configured to guide the UAI plug of the respective table module such that the UAI port receives the table module. System where the UAI offset arm may include an arm having a distal end coupled to the UAI plug of the UAI offset arm and a proximal end having at least one UAI port of the one or more UAI ports. System where each of the one or more bolsters may include an arm, the UAI plug disposed at a proximal end of the arm. System where the arm may include aluminum. System where the arm is radiolucent. System where each of the one or more bolsters may include a base, the arm extending from the base. System where the base may include a pad. System where the base may include a hook and loop fastener to couple the pad to the base. System may include: a trunk pad configured to be disposed along the platform, the trunk pad configured to support at least a torso of the patient. System where the trunk pad may include a center pad configured to be disposed under the torso. System where the center pad may include an opening and a wedge insert, and where the trunk pad is configured to receive the wedge insert, the wedge insert configured to support at least a portion of the patient. System where the trunk pad may include one or more lateral pads configured to extend from the center pad in a lateral direction, the one or more lateral pads configured to support at least a portion of the patient. System where the trunk pad may include one or more hammock attachments, where each of the one or more lateral pads is coupled to the center pad via one of the one or more hammock attachments, and where each of the one or more hammock attachments may include a length of flexible material to adjust the extension of the respective lateral pad relative to the center pad. System may include: one or more lateral flaps configured to extend from the platform in the lateral direction. System where each of the one or more lateral flaps is configured to receive one of the lateral pads. System where each of the one or more lateral flaps is translatable such that the position of each of the one or more lateral flaps relative to the platform is adjustable in at least one of the lateral direction and the medial direction. System where each of the one or more lateral flaps is rotatable such that the pitch of the one or more lateral flaps relative to the platform is adjustable. System where each of the one or more lateral flaps is translatable and rotatable via a single control. System where each of the one or more lateral flaps is rotatable such that the pitch of the one or more lateral flaps relative to the platform is adjustable. System where each of the one or more lateral flaps is rotatable such that the position of each of the one or more lateral flaps relative to the platform is adjustable in at least one of an anterior direction and a posterior direction. System may include: a wrapper for at least a portion of the patient, where the wrapper may include a stretch portion that is generally square-shaped when unstretched and attachment points disposed at each corner of the stretch portion. System where wrapper further may include a stiction trim configured to adhere to the at least the portion of the patient. System where the portion of the patient may include pannus tissue, where the wrapper is configured to stretch around the pannus tissue, and where at least two of the attachment points are coupled to one another to hold the pannus tissue in the wrapper. Implementations of the described techniques may include hardware, a method or process, or a computer tangible medium. System where the spar may include a proximal end and a distal end, the distal end being distal to the proximal end, and where the distal end is coupled to the proximal end by a joint. System where the proximal end may include a locking mechanism configured to lock the orientation of the proximal end. System where the proximal end of the spar may include one or more links, where one or more links may include a first link and a second link, and where the locking mechanism is configured to lock the first link. System where the locking mechanism may include a pair of gears configured to alternately rotate and lock the first link. System where the locking mechanism may include a proximal rotational shaft, a distal rotational shaft coupled to the first link, and a pair of gears having a proximal gear coupled to the proximal rotational shaft and a distal gear coupled to the distal rotational shaft. System where the proximal gear and the distal gear are coupled to one another such that the distal rotational shaft is configured to rotate relative to the proximal rotational shaft and locking the proximal rotational shaft locks the distal rotational shaft to lock the first link. System where the locking mechanism further may include a slider-crank mechanism configured to control the orientation of the proximal end. System where the slider-crank mechanism may include an electromagnetic brake, a ball screw, a ball nut coupled to the ball screw, and a slider link coupled to the ball nut and the proximal rotational shaft, where the ball screw is configured to rotate such that the ball nut translates vertically when the electromagnetic brake is unlocked, and where the ball screw is configured to stop rotating when the electromagnetic brake is locked such that the slider link is locked in position to lock the proximal rotational shaft to lock the first link. System where the slider-crank mechanism may include an electromagnetic brake and a slider link coupled to the proximal rotational shaft, where the slider link is configured to rotate the proximal rotational shaft when the electromagnetic brake is unlocked, and where the slider link is locked in position when the electromagnetic brake is locked such that the proximal rotational shaft is locked to lock the first link. Implementations of the described techniques may include hardware, a method or process, or a computer tangible medium.

Features described above in respect of the preceding aspect may also apply to the next aspect.

In one general aspect, system may include The system. Other embodiments of this aspect include corresponding computer systems, apparatus, and computer programs recorded on one or more computer storage devices, each configured to perform the actions of the methods.

In one general aspect, traction boot may include an inner plate having a leg portion configured to receive at least a portion of a leg of a patient and a foot portion configured to receive at least a portion of a foot of the patient, the leg portion and the foot portion arranged at an angle relative to one another. Traction boot may also include where the angle may include an obtuse angle. Other embodiments of this aspect include corresponding computer systems, apparatus, and computer programs recorded on one or more computer storage devices, each configured to perform the actions of the methods.

Implementations may include one or more of the following features.

Traction boot where the angle is between about 95 and about 135. Traction boot where the angle may include about 110. Traction boot where the foot support may include one or more binding straps. Traction boot where the foot support may include a first binding strap configured to secure the at least one foot of the patient and a second binding strap configured to secure at least a portion of one leg of the patient. Traction boot where the foot support may include an upper pad configured to contact a top of the at least one foot of the patient. Traction boot where the foot support may include a lower pad configured to contact a back of the at least one foot of the patient, the back having the location where an Achilles tendon of the at least one foot of the patient is located, and where the lower pad may include one or more sides configured to contact the at least one foot of the patient at least partially above the malleolus. Traction boot where the foot support may include a lower pad configured to contact a back of the at least one foot of the patient, the back having the location where an Achilles tendon of the at least one foot of the patient is located, and where the lower pad may include one or more sides configured to contact the at least one foot of the patient at least partially above the malleolus. System may include: a cinch strap, where the foot support may include an upper pad configured to rest in a joint between a top of the at least one foot of the patient and at least one leg of the patient and a lower pad configured to rest in a joint between at least one heel and the at least one leg of the patient, and where the cinch strap is coupled to the upper pad and the lower pad in series, and configured such that pulling the strap is configured to cinch the lower pad and the inner plate against the at least one foot of the patient. Traction boot where the cinch strap is configured not to cinch the upper and lower pad against the at least one foot of the patient when the cinch strap is not being pulled such that the at least one foot of the patient and the at least one leg of the patient are not under traction, and where the traction is configured to support the at least one foot of the patient and the at least one leg of the patient when the foot and leg are not under traction. Traction boot where the cinch strap is configured to be pulled in an inferior direction. Traction boot where the cinch strap is configured to cinch the pads towards the respective joints, and the at least one foot of the patient in an inferior direction. Traction boot where the force vector of the cinch strap, the upper pad, and the lower pad is generally in the direction of traction. Traction boot where the cinch strap is further coupled to the foot portion of the inner plate in series at a location between the upper pad and the lower pad. Traction boot where the cinch strap is coupled in series to the upper pad, to the foot portion of the inner plate, to the lower pad, and to the upper pad. Traction boot may include: an outer plate having a leg portion and a foot portion, the leg portion of the outer plate being generally parallel to the leg portion of the inner plate, and the foot portion of the outer plate being generally parallel to the foot portion of the inner plate. Traction boot where the inner plate and the outer plate are coupled to one another by a bushing. Traction boot where the outer plate is coupled to the spar. Traction boot where the inner plate is not coupled to the spar. Traction boot where the outer plate is configured to slide relative to the inner plate. Traction boot where, under traction, the outer plate is pulled away from the inner plate to create a gap between the outer plate and the inner plate. Traction boot where the gap is reduced when traction is reduced or no longer applied. Traction boot where the cinch strap is pulled to secure the lower pad and the inner plate to the at least one foot of the patient under traction. Traction boot where the cinch strap is released to release the upper pad and the lower pad from the at least one foot of the patient when the traction load is reduced or no longer applied. System where a length of the cinch strap that is pulled as the outer plate is pushed away from the inner plate is smaller than the size of the gap. Implementations of the described techniques may include hardware, a method or process, or a computer tangible medium.

Features described above in respect of any of the preceding aspects may also apply to the next aspect.

In one general aspect, surgery table may include a proximal end. Surgery table may also include a distal end. Table may furthermore include a platform configured to support at least a portion of the patient. Table may in addition include a spar configured to support at least one leg of the patient. Table may moreover include a foot support coupled to the spar and configured to support at least one foot of the at least one leg of the patient. Table may also include where the spar is configured to translate such that a traction load is applied to the at least one leg of the patient. Other embodiments of this aspect include corresponding computer systems, apparatus, and computer programs recorded on one or more computer storage devices, each configured to perform the actions of the methods.

Implementations may include one or more of the following features. Surgery table where the spar may include a proximal end and a distal end, the distal end being distal to the proximal end, and where the distal end is coupled to the proximal end by a joint. System where the proximal end may include a locking mechanism configured to lock the orientation of the proximal end. System where the proximal end of the spar may include one or more links, where one or more links may include a first link and a second link, and where the locking mechanism is configured to lock the first link. System where the locking mechanism may include a pair of gears configured to alternately rotate and lock the first link. System where the locking mechanism may include a proximal rotational shaft, a distal rotational shaft coupled to the first link, and a pair of gears having a proximal gear coupled to the proximal rotational shaft and a distal gear coupled to the distal rotational shaft. System where the proximal gear and the distal gear are coupled to one another such that the distal rotational shaft is configured to rotate relative to the proximal rotational shaft and locking the proximal rotational shaft locks the distal rotational shaft to lock the first link. System where the slider-crank mechanism may include an electromagnetic brake, a ball screw, a ball nut coupled to the ball screw, and a slider link coupled to the ball nut and the proximal rotational shaft, where the ball screw is configured to rotate such that the ball nut translates vertically when the electromagnetic brake is unlocked, and where the ball screw is configured to stop rotating when the electromagnetic brake is locked such that the slider link is locked in position to lock the proximal rotational shaft to lock the first link. System where the slider-crank mechanism may include an electromagnetic brake and a slider link coupled to the proximal rotational shaft, where the slider link is configured to rotate the proximal rotational shaft when the electromagnetic brake is unlocked, and where the slider link is locked in position when the electromagnetic brake is locked such that the proximal rotational shaft is locked to lock the first link. System where the locking mechanism further may include a slider-crank mechanism configured to control the orientation of the proximal end. Implementations of the described techniques may include hardware, a method or process, or a computer tangible medium.

Features described above in respect of any of the preceding aspects may also apply to the next aspect.

In one general aspect, foot support may include an outer plate coupled to a spar configured to support at least one leg of a patient. Foot support may also include an inner plate, the outer plate proximal to the inner plate. Support may furthermore include a cinch strap coupled to the inner plate around at least one foot of the patient. Support may in addition include where the outer plate is configured to slide relative to the inner plate, the cinch strap securing around the at least one foot of the patient when the outer plate is pushed proximally away from the inner plate to create a gap between the outer plate and the inner plate. Other embodiments of this aspect include corresponding computer systems, apparatus, and computer programs recorded on one or more computer storage devices, each configured to perform the actions of the methods.

Features described above in respect of any of the preceding aspects may also apply to the next aspect.

In one general aspect, foot support may include a foot portion configured to receive at least a portion of a foot of a patient. Foot support may also include a heel portion configured to receive at least a portion of a heel of the patient. Support may furthermore include a first USI plug disposed along the foot portion. Support may in addition include a second USI plug disposed along the heel portion. Support may moreover include where the first USI plug and the second USI plug are configured to couple the foot support to a surgery table. Other embodiments of this aspect include corresponding computer systems, apparatus, and computer programs recorded on one or more computer storage devices, each configured to perform the actions of the methods.

Features described above in respect of any of the preceding aspects may also apply to the next aspect.

In one general aspect, spar may include a proximal end coupled to a spar base of a surgery table. Spar may also include a distal end coupled to the proximal end of the spar. Spar may furthermore include where the spar may include a straight spar configuration in which spar is not pitched or yawed. Spar may in addition include where the spar is configured to pitch in an upward direction from the straight spar configuration between about 10 degrees and about 30 degrees, pitch in a downward direction from the straight spar configuration between about 20 degrees and about 40 degrees, and yaw from the straight spar configuration between about 10 degrees and about 50 degrees. Other embodiments of this aspect include corresponding computer systems, apparatus, and computer programs recorded on one or more computer storage devices, each configured to perform the actions of the methods.

Implementations may include one or more of the following features. Spar where the spar is configured to pitch in the upward direction from the straight spar configuration about 20 degrees. Spar where the spar is configured to pitch in the downward direction from the straight spar configuration about 36 degrees. Spar where the spar is configured to yaw from the straight spar configuration inward about 20 degrees. Spar where the spar is configured to yaw from the straight spar configuration outward about 40 degrees. Spar where the spar extends along a horizontal plane of the surgical table and along axes generally parallel to a centerline of the surgical table in the straight spar configuration, and where yaw inward and outward of the spar is relative to the centerline. Implementations of the described techniques may include hardware, a method or process, or a computer tangible medium.

Features described above in respect of any of the preceding aspects may also apply to the next aspect.

In one general aspect, a system may include a surgery table having a distal end and a proximal end opposing the distal end, and a platform configured to support at least a portion of a patient. The system may further include a spar base coupled to the surgery table and positioned beneath the platform, a spar coupled to and extending from the spar base and configured to support a leg of the patient, and an electromechanical driver comprised by at least one of the spar base or the surgery table and configured to translate the spar base a distance along the surgery table between the distal end and the proximal end of the surgery table. The system may additionally include one or more controls configured to control the electromechanical driver.

Implementations may include one or more of the following features. The spar base may include a spar mount configured to releasably couple the spar, the spar mount having a spar mount electrical connection, and the spar may include a spar electrical connection configured to releasably couple to the spar mount electrical connection. The spar base may include one or more joints configured to articulate the spar mount. A pitch axis about which the spar is configured to pitch and a yaw axis about which the spar is configured to yaw may intersect distal to the distal end of the surgery table, and the pitch axis and the yaw axis may not be provided by a ball joint. The spar base may be configured to articulate the spar in a pitch direction, including to articulate the spar in a downward pitch direction to a downward pitch angle from an axis extending along the spar when the spar is in a straight configuration, the downward pitch angle being up to about 45 degrees. The spar may include a distal end and a proximal end opposing the distal end, and the proximal end of the spar may be devoid of a traction mechanism. The electromechanical driver may include a lead screw coupled to and configured to translate the spar base, and may be further configured to apply traction to the patient by translating the spar base toward the distal end, such as by pushing the spar outwardly from the surgery table in an inferior direction, and the controls may be configured to adjust a traction load. The one or more controls may include a first control configured to incrementally translate the spar in an inferior direction, a second control configured to incrementally translate the spar in a superior direction, a third control configured to disengage the electromechanical driver and allow for manual translation of the spar, and a fourth control configured to rotate a foot support. The surgery table may include a first side extending between the proximal end and the distal end, and the spar base may be disposed along the first side such that the spar extends from the first side and is configured to extend anterior to a hip and at least a portion of a leg of the patient. The one or more controls may be disposed along the platform proximate the distal end of the surgery table.

Features described above in respect of any of the preceding aspects may also apply to the next aspect.

In one general aspect, a system may include a platform comprising a distal end, a proximal end opposing the distal end, and opposing lateral sides comprising a first lateral side and a second lateral side, the platform configured to support at least a portion of a patient; a spar base positioned beneath the platform at the distal end of the platform and disposed along at least one of the lateral sides; a spar configured to extend from the spar base and configured to support a leg of the patient, the spar comprising an inside edge and further configured to extend lateral to a hip and at least a portion of the leg of the patient; and a top-down lower body imaging window bounded on two adjacent sides by a superior side located at least at the distal end of the platform and a lateral side at the inside edge of the spar, wherein any portion of the system comprised within the lower body imaging window is radiolucent.

Implementations may include one or more of the following features. System where the spar is at least partially comprised within the top-down imaging window. System where the spar consists essentially of carbon fiber. System where the spar comprises a generally hexagonal cross-section configured to minimize x-ray attenuation and avoid imaging artifacts. System further including a pelvic center board coupled to the platform at the distal end and configured to support a pelvis of the patient, and further configured to allow imaging of at least one of at least a portion of a hip of the patient or at least a portion of a pelvis of the patient. System where the pelvic center board is at least partially comprised within the top-down imaging window, and where the pelvic center board consists essentially of carbon fiber. System where the pelvic center board comprises a length, a distal end, a proximal end opposing the distal end, and a bottom portion, where the pelvic center board comprises a thickness, where a thickness of the proximal end is thicker longitudinally than a thickness of the distal end, where the bottom portion comprises a curvature from the proximal end to the distal end, where the pelvic center board comprises a generally triangular shape, and where the distal end and the proximal end each comprises a cross-section comprising a generally trapezoidal shape. System where the pelvic center board comprises a shape configured to allow C-arm access from below a proximal end of the platform for oblique imaging. System where the combined height comprises a distance of about 20 inches. System where the pelvic center board comprises a length configured to allow imaging of at least a portion of a lumbar spine starting at an L3 of a patient of a size of a 98th percentile. System where the pelvic center board comprises a mount configured to couple the pelvic center board to the platform, where the mount is further configured to extend about one inch beyond the distal end of the platform and further configured to be outside of the top-down imaging window, and where the superior side of the top-down imaging window is located about one inch inferior to the distal end of the platform.

In another general aspect, a system may include a surgery table comprising a distal end, a proximal end opposing the distal end, a platform configured to support at least a portion of a patient, a column configured to support the platform, and a base configured to support the column; a pelvic center board coupled to the surgery table at the distal end and configured to allow imaging of at least one of at least a portion of a hip of the patient or at least a portion of a pelvis of the patient; a perineal post coupled to the pelvic center board; an adapter configured to couple the pelvic center board to the surgery table; an imaging path configured to allow a portion of a C-arm under the platform and adjacent to the column and to image at least one of a hip or a pelvis of a patient at an imaging angle of between about 45 degrees and about 55 degrees, wherein the system is configured not to block the imaging path; and a spar configured to extend from the surgery table and configured to support a leg of the patient and further configured to extend lateral to a hip and at least a portion of the leg of the patient, where a combined height of the spar, the pelvic center board, and the perineal post comprises a distance between about 15 inches and about 30 inches.

Implementations may include one or more of the following features. System further including an oblique lower body imaging window bounded at least by at least a portion of the column and at least a portion of the base, wherein any portion of the system comprised within the lower body imaging window is radiolucent. System where the pelvic center board consists essentially of carbon fiber. System where the pelvic center board comprises a shape configured to allow C-arm access for oblique imaging. System where the pelvic center board is elongated in a proximal direction such that the pelvic center board comprises a length configured to allow imaging of at least a portion of a lumbar spine starting at an L3 of a patient of a size of a 98th percentile. System where the adapter comprises an articulating adapter configured to couple the pelvic center board to the surgery table, where the articulating adapter is not comprised within the imaging path. System where the articulating adapter comprises at least one of a curvature or a chamfer configured to allow C-arm access for oblique imaging. System where the adapter comprises a static adapter configured to couple the pelvic center board to the surgery table, where the static adapter is not comprised within the imaging path. System where the imaging angle comprises an angle of about 50 degrees.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 shows a perspective view of a system for supporting a patient during a surgical procedure according to exemplary embodiments.

FIG. 2 shows a perspective view of a portion of a surgery table according to exemplary embodiments.

FIG. 3 shows a perspective view of a spar according to exemplary embodiments.

FIG. 4 shows an enlarged side view of the spar of FIG. 3.

FIG. 5 shows an enlarged side view of the spar of FIG. 3.

FIG. 6 shows an enlarged perspective view of the spar of FIG. 3.

FIG. 7A shows an enlarged perspective view of the spar of FIG. 3.

FIG. 7B shows an enlarged perspective view of the spar of FIG. 3.

FIG. 8 shows a side cross-section view of the spar of FIG. 3 along line 8-8.

FIG. 9 shows a top view of the system of FIG. 1.

FIG. 10A shows an enlarged perspective view of the spar base of FIG. 10A.

FIG. 10B shows an enlarged perspective view of the spar base of FIG. 10A.

FIG. 11A shows an enlarged perspective view of the spar base of FIG. 10A.

FIG. 11B shows an enlarged perspective view of the spar base of FIG. 10A.

FIG. 12 shows a side cross-section view of the spar base of FIG. 10B along line 12-12.

FIG. 13 shows a perspective view of the spar of FIG. 3 and the spar base of FIG. 10A.

FIG. 14 shows a schematic of the spar base of FIG. 10A.

FIG. 15 shows a schematic of the spar base of FIG. 10A.

FIG. 16 shows a schematic of the spar base of FIG. 10A.

FIG. 17 shows a perspective view of the portion of the surgery table of FIG. 2.

FIG. 18 shows a perspective view of the system of FIG. 1.

FIG. 19 shows a side view of the system of FIG. 1.

FIG. 20 shows a perspective view of the system of FIG. 1.

FIG. 21 shows a perspective view of the system of FIG. 1.

FIG. 22 shows a perspective view of the system of FIG. 1.

FIG. 23 shows a perspective view of the system of FIG. 1.

FIG. 24 shows a perspective view of a drape according to exemplary embodiments.

FIG. 25 shows a side view of an inner foot plate and an outer foot plate according to exemplary embodiments.

FIG. 26 shows a side view of a foot support according to exemplary embodiments.

FIG. 27 shows a perspective view of the foot support of FIG. 26.

FIG. 28 shows a perspective view of the foot support of FIG. 26.

FIG. 29 shows a side view of a foot support and a table module according to exemplary embodiments.

FIG. 30 shows a perspective view of a USI plug according to exemplary embodiments.

FIG. 31 shows a perspective view of a foot support according to exemplary embodiments.

FIG. 32 shows a perspective view of the foot support of FIG. 31.

FIG. 33 shows a side view of the foot support of FIG. 31.

FIG. 34 shows a perspective view of the foot support of FIG. 31.

FIG. 35 shows a perspective view of the foot support of FIG. 31.

FIG. 36 shows a perspective view of the table module of FIG. 29.

FIG. 37 shows an enlarged perspective view of the table module of FIG. 29.

FIG. 38 shows an enlarged perspective view of the spar of FIG. 3.

FIG. 39 shows a perspective view of a table module according to exemplary embodiments.

FIG. 40 shows a perspective view of the table module of FIG. 39.

FIG. 41 shows a side view of the table module of FIG. 39.

FIG. 42 shows a top view a UAI offset arm according to exemplary embodiments.

FIG. 43 shows a perspective view the UAI offset arm of FIG. 42.

FIG. 44 shows a perspective view of a bolster according to exemplary embodiments.

FIG. 45 shows a perspective view of the bolster of FIG. 44.

FIG. 46 shows a perspective view of the bolster of FIG. 44.

FIG. 47 shows a perspective view of the portion of the surgery table of FIG. 2 and the spar of FIG. 3.

FIG. 48 shows a rear view of the portion of the surgery table of FIG. 2.

FIG. 49 shows a perspective view of a pelvic port adapter according to exemplary embodiments.

FIG. 50 shows a perspective view of an attachment for a pelvic port according to exemplary embodiments.

FIG. 51 shows a side view of the attachment of FIG. 50.

FIG. 52 shows a cross-section view of the attachment of FIG. 51 along line 52-52.

FIG. 53 shows a cross-section view of the attachment of FIG. 51 along line 53-53.

FIG. 54 shows a perspective view of a pelvic port pad according to exemplary embodiments.

FIG. 55 shows an assembly view of a perineal post bolster according to exemplary embodiments.

FIG. 56 shows a perspective view of a perineal post core according to exemplary embodiments.

FIG. 57 shows a perspective view of a perineal post cover according to exemplary embodiments.

FIG. 58 shows a perspective view of a perineal post bolster according to exemplary embodiments.

FIG. 59 shows a side view of the perineal post bolster of FIG. 58.

FIG. 60 shows a perspective view of the perineal post bolster of FIG. 58.

FIG. 61 shows a cross-section view of the perineal post bolster of FIG. 58 along line 61-61.

FIG. 62 shows a perspective view of a perineal post bolster according to exemplary embodiments.

FIG. 63 shows a perspective view of the perineal post bolster of FIG. 62.

FIG. 64 shows a perspective view of a portion of a perineal post bolster according to exemplary embodiments.

FIG. 65 shows a perspective view of the perineal post bolster of FIG. 58, the attachment of FIG. 50, and a pelvic center board pad according to exemplary embodiments.

FIG. 66 shows a perspective view of a perineal post sleeve and a perineal post lock according to exemplary embodiments.

FIG. 67 shows a cross-section view of the perineal post sleeve and the perineal post lock along line 67-67.

FIG. 68 shows a perspective view of a pelvic combo pad according to exemplary embodiments.

FIG. 69 shows a perspective view of a traction pad according to exemplary embodiments.

FIG. 70 shows a perspective view of the traction pad of FIG. 69 and the attachment of FIG. 50.

FIG. 71 shows a schematic view of a pannus wrapper according to exemplary embodiments.

FIG. 72 shows a perspective view of a trunk pad according to exemplary embodiments.

FIG. 73 shows a perspective view of a lateral flap and a portion of the trunk pad of FIG. 49 according to exemplary embodiments.

FIG. 74 shows a perspective view of a shoulder cover according to exemplary embodiments.

FIG. 75 shows a perspective view of an elbow cover according to exemplary embodiments.

FIG. 76 shows a perspective view of the elbow cover of FIG. 75.

FIG. 77 shows a perspective view of an end cover according to exemplary embodiments.

FIG. 78 shows an enlarged side view of the portion of the surgery table of FIG. 2.

FIG. 79 shows a perspective view of a pendant according to exemplary embodiments.

FIG. 80 shows an enlarged perspective view of the table module of FIG. 29.

FIG. 81 shows a perspective view of a manual lock according to exemplary embodiments.

FIG. 82 shows a perspective view of a head support according to exemplary embodiments.

FIG. 83 shows a perspective view of the head support of FIG. 82.

FIG. 84 shows a perspective view of a spar according to exemplary embodiments.

FIG. 85 shows an enlarged top view of the spar of FIG. 84.

FIG. 86 shows an enlarged perspective view of the spar of FIG. 84.

FIG. 87 shows an enlarged side view of the spar of FIG. 84.

FIG. 88 shows an enlarged perspective view of the spar of FIG. 84.

FIG. 89 shows an enlarged side view of the spar of FIG. 84.

FIG. 90 shows an enlarged perspective view of the spar of FIG. 84.

FIG. 91 shows a perspective view of a traction pad according to exemplary embodiments and the attachment of FIG. 50.

FIG. 92 shows a perspective view of the traction pad of FIG. 91 and the system of FIG. 1.

FIG. 93 shows a perspective view of a C-arm in the system of FIG. 1.

FIG. 94 shows a perspective view of the C-arm of FIG. 93.

FIG. 95 shows a perspective view of the C-arm of FIG. 93.

FIG. 96 shows a perspective view of an extension control according to exemplary embodiments.

FIG. 97 shows a perspective view of a foot support according to exemplary embodiments.

FIG. 98 shows a perspective view of a pelvic port adapter according to exemplary embodiments.

FIG. 99 shows a perspective view of lateral portions of the pelvic center board of FIG. 65.

FIG. 100 shows a perspective view of a lateral board according to exemplary embodiments.

FIG. 101 shows a perspective view of an imaging board according to exemplary embodiments.

FIG. 102 shows a perspective view of a leg tunnel according to exemplary embodiments.

FIG. 103 shows a perspective view of a leg cradle according to exemplary embodiments.

FIG. 104 shows a perspective view of a well leg holder according to exemplary embodiments.

FIG. 105 shows a perspective view of a gluteal support, femoral support, and tibial support according to exemplary embodiments.

FIG. 106A shows a perspective view of the tibial support of FIG. 105.

FIG. 106B shows a perspective view of the tibial support of FIG. 105.

FIG. 107 shows a pelvic center board pad according to exemplary embodiments.

FIG. 108 shows a side view of the C-arm of FIG. 93.

### DETAILED DESCRIPTION

In the following detailed description of embodiments, reference is made to the accompanying drawings, which form a part hereof and in which are shown, by way of illustration, specific embodiments in which the invention may be practiced. Specific details disclosed herein are in every case a non-limiting embodiment representing concrete ways in which the concepts of the invention may be practiced. This serves to teach one skilled in the art to employ the present invention in virtually any appropriately detailed system, structure or manner consistent with those concepts. It will be seen that various changes and alternatives to the specific described embodiments and the details of those embodiments may be made within the scope of the invention. Because many varying and different embodiments may be made within the scope of the inventive concepts herein described and in the specific embodiments herein detailed without departing from the scope of the present invention, it is to be understood that the details herein are to be interpreted as illustrative and not as limiting.

Patient support apparatuses, such as surgery tables, must position and support a patient for the particular procedure being conducted while minimizing or preventing risk to the patient. Systems and methods described herein provide a patient positioning apparatus. The system may include a surgery table that is convertible between a general-purpose surgery table and a spar table configured for orthopedic surgery. In addition, the surgery table may be configured for hip surgery. The surgery table may include various attachments to support at least a portion of a patient. Spars, or leg supports, may extend from the distal end of the table to support at least a portion of the legs of the patient. The spars may be maneuverable in pitch and yaw directions, and may include joints that may be released to flex, or fold, the spars. A foot support may be coupled to the spar of the operable leg of the patient and may support at least a portion of the foot of the operable leg. The foot support may include a user interface that may allow a user to translate the spar in the inferior direction to apply traction for hip arthroscopy. Additional user interfaces may allow control of pitch or yaw of the spar. The spars may be yawed away from one another devoid of distal mechanisms for hip arthroscopy. Instead, the surgery table, such as the platform, may house a traction mechanism, such that the spars are pushed outwardly from the table to apply traction. Therefore, a surgeon may move the spars in a pitch direction further downward in the posterior direction, as no intermediate traction structures limit the pitch movement. One or more surgical drapes configured for the hip surgery may be draped over the system. The drapes may also include film, or windows, over user interfaces to allow the user to view user interfaces positioned under the drapes for maneuvering the spars. Reference will now be made to the figures.

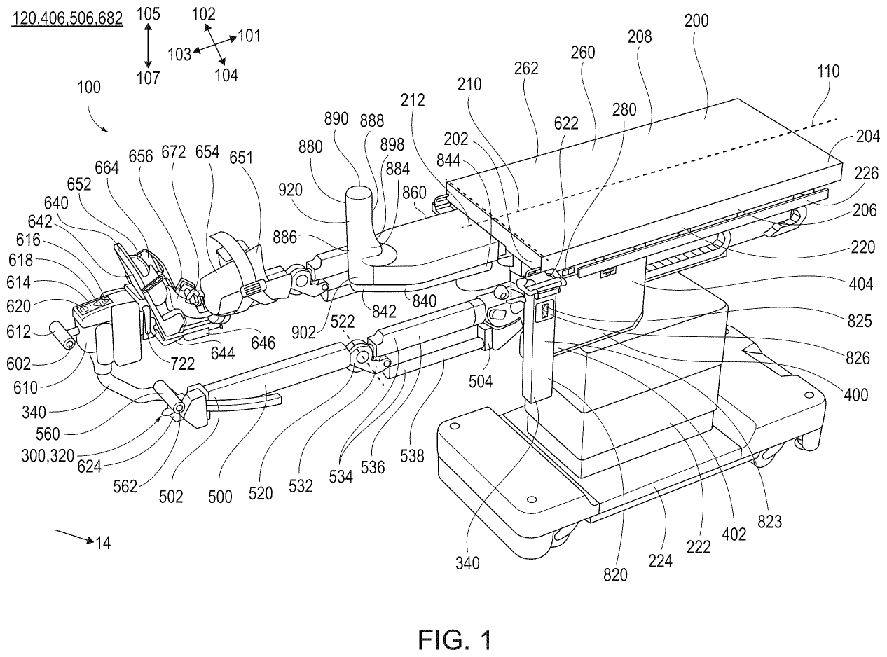

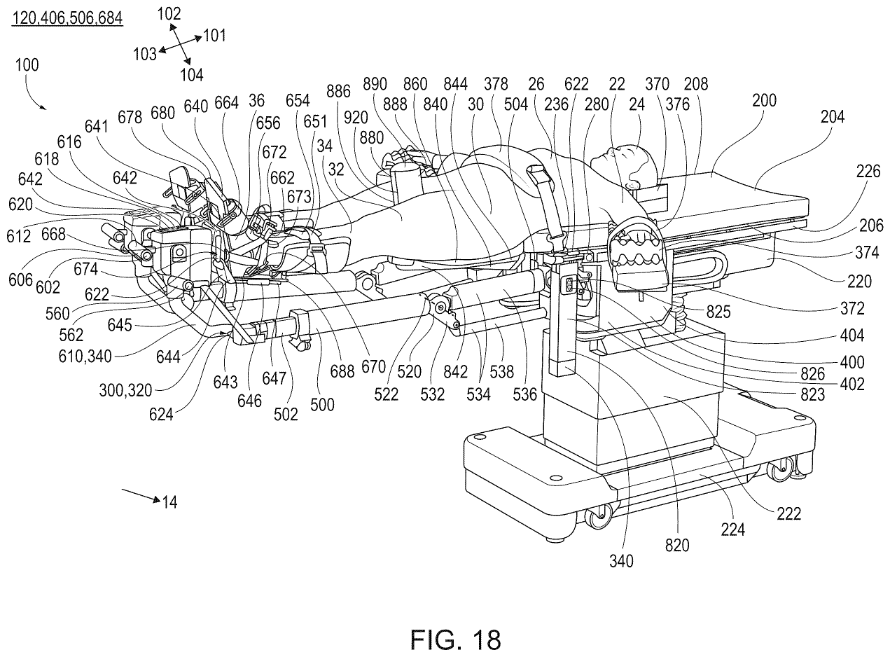

FIG. 1 shows a perspective view of a positioning system 100 for supporting a patient 20 (FIG. 18) for a surgical procedure according to exemplary embodiments. Positioning system 100 may be a modular system in which a surgery table 200 of positioning system 100 may receive one or more removable attachments. Additionally or alternatively, surgery table 200 may include one or more of the attachments when coupled to surgery table 200 such that surgery table 200 may have the functionality of positioning system 100 to support the patient. Additionally or alternatively, each attachment may function separate from positioning system 100, such as with other positioning systems, surgery tables, or apparatuses thereof.

All components of positioning system 10 may be rapidly disinfected. Components may be devoid of or include minimal crevices, openings, and sharp edges to reduce infection risk. As will be discussed, mechanical and software/control interlocks may prevent accidental activation or movement. Individual components may include cutoff switches to negate power and release coupled components for addition fail-safety. Electrical contacts may be covered when not in use, and software may disable power when no component that requires power is attached.

Positioning system 100, surgery table 200, and components thereof may be described with reference to an operable leg 32 (FIG. 18) of patient 20. Operable leg 32 may be a left leg, as shown herein. Accordingly, a medial direction 102 and a lateral direction 104 shown in FIG. 1 may be with reference to operable leg 32 being a left leg. Additionally or alternatively, operable leg 32 may be a right leg. Positioning system 100, surgery table 200, and components thereof may function with operable leg 32 being a left leg, a right leg, or both legs.

Surgery table 200 may be convertible between a general-purpose surgery table and a specialty surgery table. for example, surgery table 200 may be configured for orthopedic surgeries. As discussed herein, surgery table 200 may be configured for hip surgery and trauma surgery. In other embodiments, surgery table 200 may be configured for knee surgery.

In an embodiment, surgery table 200 may include features that are functional separately and in combination. As shown in FIG. 1, surgery table 200 may include a distal end 202 and a proximal end 204. Distal end 202 may be proximal to proximal end 204. In other words, proximal end 204 may oppose distal end 202 and may be superior relative to distal end 202. When patient 20 (FIG. 18) is positioned on surgery table 200, distal end 202 may be closer to legs 32 (FIG. 18) of patient 20 relative to proximal end 204. Distal end 202 may include at least the edge of surgery table 200. Proximal end 204 may include at least the proximal edge of surgery table 200.

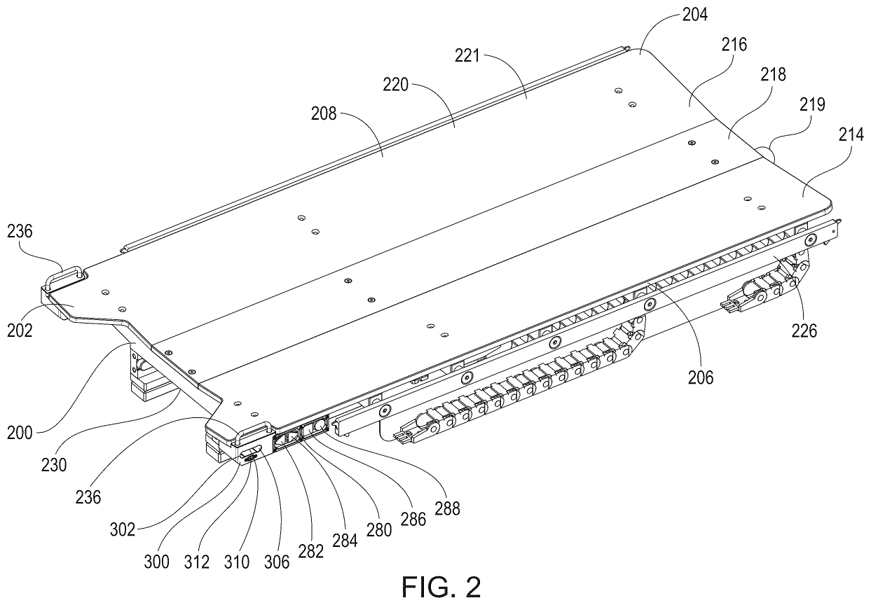

In embodiments, surgery table 200 may also include a platform 220. Platform 220 may support at least a portion of patient 20. For example, platform 220 may support at least the upper body of patient 20 (FIG. 18). A top portion 221 of platform 220, shown in FIG. 2 according to exemplary embodiments, may receive at least a portion of patient 20. Top portion 221 may be generally flat. Alternatively, top portion 221 may include one or more static flaps to form a curved profile that may follow natural curves of patient 20, for example. As shown, top portion 221 may include a first static flap 214, a second static flap 216, and a center static flap 218 intermediate to first static flap 214 and second static flap 216. First static flap 214 may be at an angle 219 relative to center static flap 218. Angle 219 may be between about 0 degrees and about 15 degrees, such as between about 5 degrees and about 10 degrees. Second static flap 216 may similarly be at an angle relative to center static flap 218 such as an angle similar to angle 219. Alternatively, first static flap 214, second static flap 216, and center static flap 218 may form a continuous curved profile. A distance from bottom-most point of center static flap 218 and a top-most point of first static flap 214 and second static flap 216 may be between about half an inch and about three inches, such as about one inch.

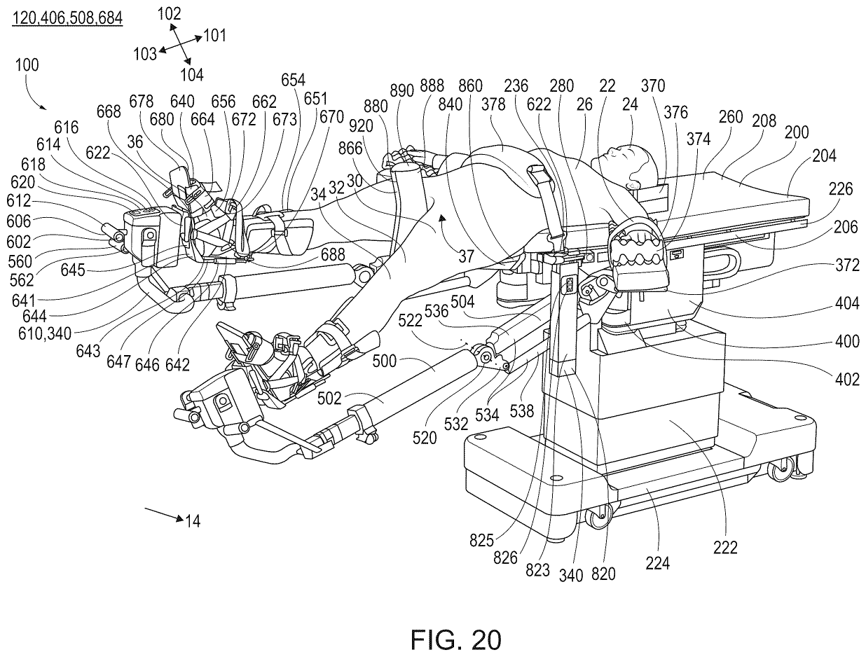

Top portion 221 may be generally rigid. Referring again to FIG. 1, top portion 221 may receive one or more pads to support patient 20 (FIG. 18). As shown, a trunk pad 260 may be disposed along platform 220. Trunk pad 260 may support at least a portion of patient 20, such as at least a torso 26 (FIG. 20) of patient 20. Trunk pad 260 will be described further below. Platform 220 may extend from distal end 202 to proximal end 204 such that distal end 202 includes the distal area of platform 220 and proximal end 204 includes the proximal area of platform 220. Platform 220 may also extend from lateral sides of surgery table 200 such that the lateral sides include platform 220. Surgery table 200 may include lateral sides, such as first side 206 and second side 208. First side 206 may oppose second side 208 and may be on opposite sides of a centerline 110 of positioning system 100.

In embodiments, surgery table 200 may include a base 224 that may contact a ground surface 14 of the operating room. Surgery table may include a column 222 coupled to base 224 and platform 220, column 222 being intermediate to platform 220 and base 224. In one embodiment, column 222 may adjust the height of surgery table 200, and therefore positioning system 100, by raising surgery table 200 in an anterior direction 105 or lowering surgery table 200 in a posterior direction 107. In other words, platform 220 may be raised or lowered relative to base 224 between a low position and a high position. Platform 220 may also translate in a superior direction 101 and an inferior direction 103, pitch or Trendelenburg about an axis 210 at distal end 202, and roll or tilt about an axis 212, which may coincide with centerline 110. Base 225 may include a floor lock system to alternately allow or prevent motion of surgery table 200 and/or a drive assist user interface module to permit an operator of surgery table 200 to selectively control movement of surgery table 200, as disclosed in U.S. patent application Ser. No. 15/610,486, the disclosure of which is hereby incorporated by reference in its entirety.

An embodiment may include a spar base 400 is shown in FIG. 1. In an embodiment, spar base 400 may be part of positioning system 100. In another embodiment, spar base 400 may be a part of surgery table 200. In another embodiment, spar base 400 may function separately, such as with other positioning systems, surgery tables, or apparatuses thereof. In an example, spar base 400 may include features that are functional separately and in combination.

As shown in the embodiment of FIG. 1, spar base 400 may be positioned beneath platform 220. Spar base 400 may be positioned beneath platform 220 at distal end 202. Surgery table 200 may include a rail 226 along first side 206 and second side 208 for receiving various accessories having a corresponding rail clamp, including spar base 400. Spar bases 400 may be coupled to surgery table 200 along at least one of first side 206 and second side 208, such as both first side 206 and second side 208. Spar bases 400 may be disposed below rails 226.

Spars 500 are also shown in the embodiment of FIG. 1. In an example, spar 500 may be part of positioning system 100. In another example, spar 500 may be a part of surgery table 200. In another example, spar 500 may function separately, such as with other positioning systems, surgery tables, or apparatuses thereof. In an example, spar 500 may include features that are functional separately and in combination.

One or more spars 500 may extend from spar base 400, such as from a distal end 402 of spar base 400. Each spar 500 may support at least one leg 32 (FIG. 20) of patient 20 (FIG. 18). Spar base 400 may include a distal end 402 and a proximal end 404. Distal end 402 may be distal to proximal end 404. In other words, proximal end 404 may oppose distal end 402 and may be superior relative to distal end 402. Distal end 402 may be at distal end 202 of surgery table 200 such that spar 500 may extend from distal end 202 of surgery table 200. Spar base 400 may translate a distance along surgery table 200 between distal end 202 and proximal end 204 of surgery table 200. Accordingly, spar 500 may translate as spar base 400 translates because spars 500 extend from spar base 400. Spar base 400 may translate along surgery table 200 such that it translates relative to platform 220, column 222, and base 224. Spar base 400 may translate in superior direction 101 such that spar 500 may extend from a point superior to distal end 202 of surgery table 200. Spar base 400 may translate in inferior direction 103 after translating in superior direction 101 to be positioned at distal end 202 of surgery table 200.

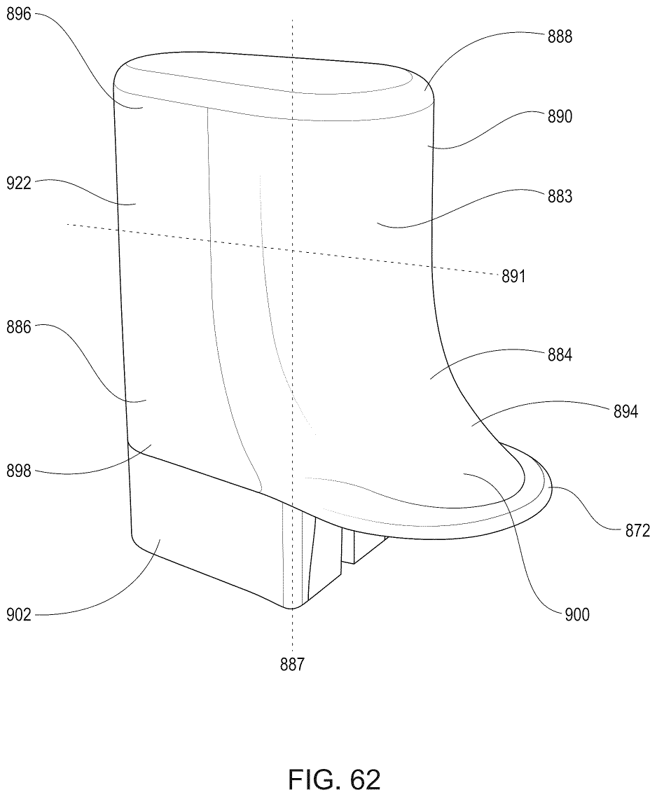

Spar base 400 may electromagnetically be translated. Spar base 400 may include an electromagnetic driver (not shown). Additionally or alternatively, another part of surgery table 200 may include an electromagnetic driver. The electromagnetic driver may translate spar base 400 a distance along surgery table 200 between distal end 202 and proximal end 204 of surgery table 200. One or more controls may control the electromagnetic driver, such as one or more traction controls 280 (FIG. 62), which will be discussed further below.

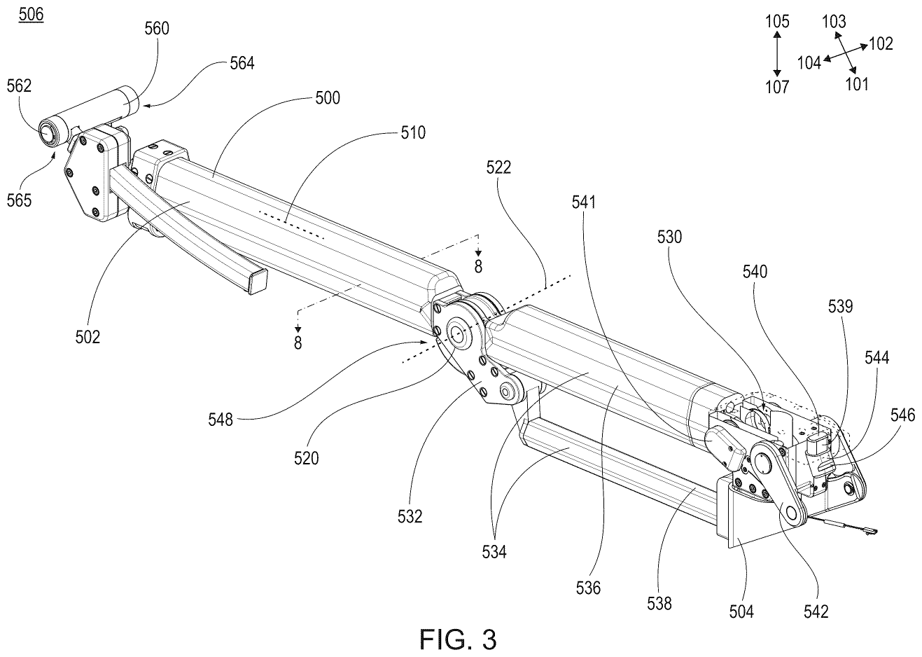

Spar 500 is shown in FIGS. 3-8 according to exemplary embodiments. With reference to FIG. 3, spar 500 may include a distal end 502 and a proximal end 504. Distal end 502 may be distal to proximal end 504. In other words, proximal end 504 may oppose distal end 502 and may be superior relative to distal end 502. In one embodiment, distal end 502 may be length-adjustable. For example, distal end 502 may include a telescoping portion that is retractable to reduce the length of spar 500 and extendable to increase the length of spar 500. In this way, spar 500 may be adapted for different sized patients. Distal end 502 of spar 500 may receive two or more table modules 340 (FIG. 1), which may interface with surgery table 200 such as by drawing power from surgery table 200 and inheriting the articulation of spar 500. Table modules 340 may include a foot support module 350, which may receive one or more foot supports, such as foot support 640 such as to support at least one foot 36 (FIG. 20) of patient 20 (FIG. 18). Table modules 340, foot support module 350, and foot support 640 will be described further below.

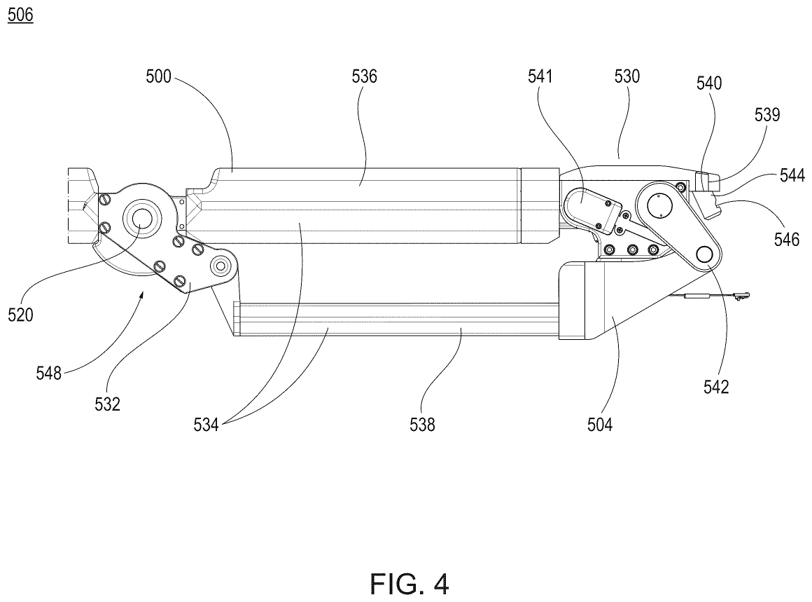

In embodiments, distal end 502 of spar 500 may be coupled to proximal end 504 by a joint 520. Joint 520 is alternately locked and releasable to allow spar 500 to fold, or flex, by rotation about a joint axis 522. As shown in FIGS. 3-4, spar 500 may be in a straight spar configuration 506. In straight spar configuration 506, spar 500 may be generally straight, e.g., distal end 502 and proximal end 504 may be generally aligned along the same plane as spar 500 may extend along a horizontal spar axis 510 extending along spar 500 when spar 500 is in straight spar configuration 506. From straight spar configuration 506, spar 500 may pitch such that spar 500 is angled up in anterior direction 105 or angled down in posterior direction 107. Spar 500 may also move in a yaw direction, such as in medial direction 102 or lateral direction 104. Proximal end of spar 504 may be coupled to surgery table 200, such as to spar base 400, such that distal end 502 of spar 500 pitches and yaws relative to proximal end of spar 504.

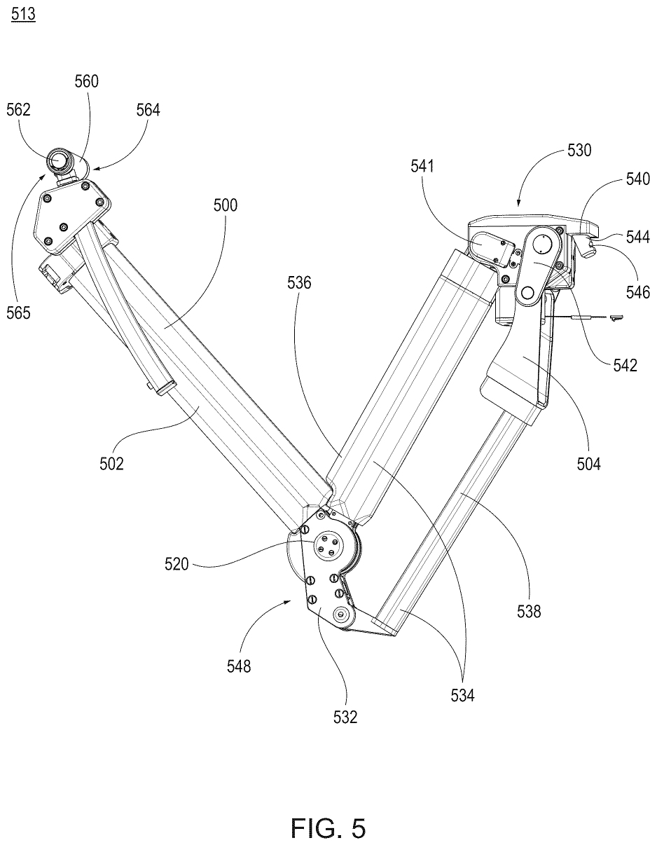

In embodiments, in addition to pitch and yaw, spar 500 may flex such that distal end 502 folds toward proximal end 504, as shown in FIG. 5. Spar 500 may thus be in a folded spar configuration 513. In folded spar configuration 513, spar 500 may be at least partially folded, or flexed. In other words, in folded spar configuration 513, spar 500 may be folded, or flexed, at least partially or fully along a range of motion of spar 500 flex. When folding toward proximal end 504, distal end 502 may raise or lower relative to joint 520. Joint 520 may be released to raise or lower distal end 502 such that distal end 502 may be at an angle of up to and about 70 degrees relative to proximal end 504. Spar 500 may be fully flexed such that distal end 502 may be about 70 degrees from proximal end 504. Spar 500 may be at least partially flexed such that distal end 502 is between about 185 degrees and about 75 degrees, such as between about 150 degrees and about 90 degrees.

When joint 520 is released, spar 500 may move between straight spar configuration 506 shown in FIGS. 3-4 and folded spar configuration 513, one folded spar configuration 513 shown in FIG. 5. Spar 500 may fold less or more than as shown in FIG. 5, and any configuration in between. As shown, an angle 503 between distal end 502 and proximal end 504 may be manipulated as spar 500 is folded. Joint 520 may include angle 503 between distal end 502 and proximal end 504. Angle 503 may be about 180 degrees when spar 500 is in straight spar configuration 506. Angle 503 may be reduced as joint 520 is rotated. Angle 503 may be reduced to between about 30 degrees and about 150 degrees, such as between about 60 degrees and about 120 degrees, such as between about 70 degrees and about 90 degrees. Spar 500 may be easily movable. For example, spar 500 may be lightweight. Spar 500 may include minimal attachments to be lightweight. For example, distal end 502 of spar 500 may be devoid of a traction mechanism such that spar 500 is lightweight and distal end 502 of spar is directly accessible from inferior direction 103.

In embodiments, joint 520 may be locked in a particular orientation when a corresponding user interface is released. Accordingly, spar 500 may be stiff, or generally immovable, when joint 520 is locked. For example, distal end 502 of spar 500 may include a handle 560 having one or more joint controls, such as a control 562, a control 564, and a control 565. At least one of control 562, control 564, and control 565 may include joint controls. Control 562, control 564, and control 565 may each include a button actuator or another actuation mechanism, such as a switch, lever, or slider, for example. In certain embodiments, the operation of joint controls from handle 560 may depend on whether a table module 340 is coupled to spar 500 at distal end 502, and the operation of joint controls from handle 560 may change depending on which table module 340 is attached. For example, foot support module 350 may allow for handle 560 to flex spar 500 by articulating joint 520. However, another table module 340 coupled to spar 500 may prevent handle 560 from operating to flex spar 500. Accordingly, joint 520 may be released, or unlocked, via one or more joint controls remote from joint 520.

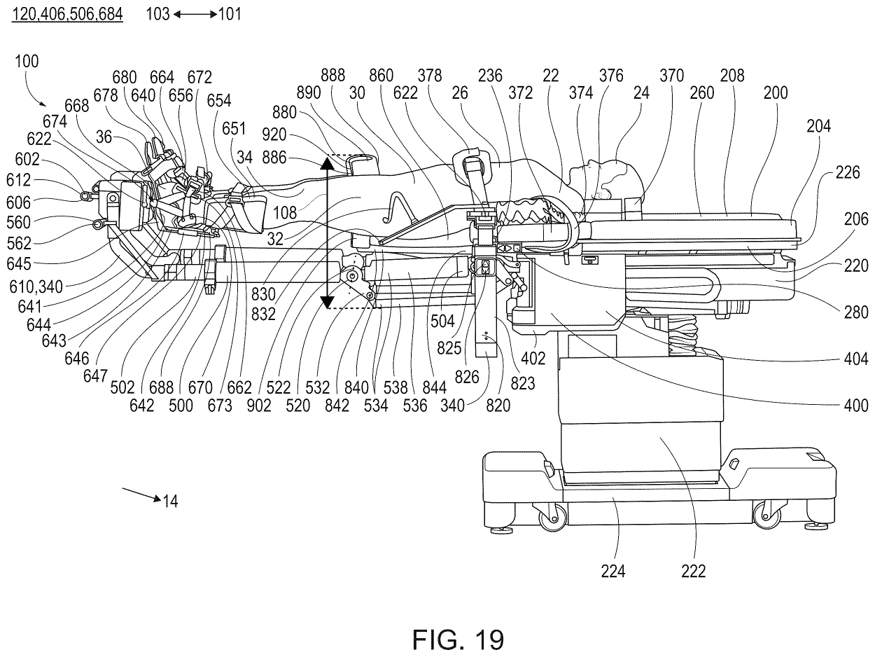

Instead of control 562, control 564, and control 565, and other controls integrated into a component of positioning system 10 (FIG. 1), a user 40 (FIG. 19) may have access to portable controls, or a relocatable user interface (not shown). Such portable controls may be distinct from a pendant, and may be within a housing and colloquially called a “button box.” The button box may be flexibly placed on any component of positioning system 10, such as spar 500, one or more drapes, handle 560, or surgery table 200 (FIG. 1), for example. The button box may be a wireless controller. The button box may include tactile physical buttons and/or touch screens. Controls on the button box may include control 562, control 564, and control 565, and other controls described herein. Controls on the button box may be user-selectable and programmable to allow each user 40 to select control placement and functions according to personal preference.

Proximal end 504 may also include one or more links, bars, or arms, such as links 534, a passive link 532, a stationary link 541, and a rotating link 542. Joint 520 may be coupled to passive link 532, which may be coupled to one or more gears 530 via one or more links 534. One or more links 534 may include a first link 536 and a second link 538. First link 536 and second link 538 may be parallel links. As shown in FIGS. 3-5, first link 536 and second link 538 may be parallel in straight spar configuration 506 and folded spar configuration 513. In other words, first link 536 and second link 538 may be parallel through the range of motion of spar 500. The orientation of at least one of first link 536 and second link 538 may be controlled by one or more gears 530. For example, one or more gears 530 may control the orientation of first link 536 to control the orientation of proximal end 504. First link 536 may be coupled to stationary link 541. Second link 538 may be coupled to rotating link 542. Stationary link 541 and rotating link 542 may be coupled to one or more gears 530 to control the orientation of proximal end 504. As proximal end 504 is folded, a 4-bar linkage is formed with at least rotating link 542, passive link 532, first link 536, and second link 538 rotating around passive link 532. The orientation control of at least one of first link 536 and second link 538 will be discussed further below. Those skilled in the art understand that a 4-bar (or four-bar) linkage is considered to be a type of movable closed chain linkage. It consists of four bodies, called bars or links, connected in a loop by four joints. Generally, in some embodiments, the joints are configured so the links move in parallel planes.

As spar 500 flexes, proximal end 504 may fold toward distal end 502. Referring to FIG. 5, in certain embodiments, proximal end 504 may include one or more gears 530 that may control the orientation of proximal end 504. For example, one or more gears 530 may include two gears 530. Gears 530 may be arranged as a pair. Gears 530 may counterrotate relative to one another and mesh together. A first gear 530 of the pair may include a shaft coupled to stationary link 541 to control the orientation of stationary link 541. A second gear 530 of the pair may include a shaft coupled to rotating link 542 to control the orientation of rotating link 542. Stationary link 541 may be coupled to first link 536 of spar 500. As the first gear 530 rotates, stationary link 541 may remain generally stationary, and link 536 may rotate around stationary link 541. Rotating link 542 may be coupled to second link 538 of spar 500 by gears 530. As the second gear 530 rotates, link 542 may be permitted to rotate by the intermeshing gears 530, and link 538 may rotate relative to link 542. Gears 530 counterrotating and meshing may cause rotating link 542 to rotate at substantially the same time as gears 530 rotate. Rotating link 542 may rotate towards stationary link 541, as shown in FIG. 5. Accordingly, link 536 and link 538 may be moved such that link 536 and link 538 remain parallel to one another. Passive link 532 may rotate in inferior direction 103 (FIG. 1) to compensate for rotating link 542 rotating toward stationary link 541. Rotating link 542 may be rotated away from stationary link 541 and passive link 532 may rotate in superior direction 105 (FIG. 1) as spar 500 is unfolded at least partially, such as unfolded fully, to reach straight spar configuration 506 (FIG. 3). Accordingly, in embodiments, the pitch of distal end 502 may be controlled by rotation of passive link 532, which is linked via gears 530 to rotation of proximal end 504.

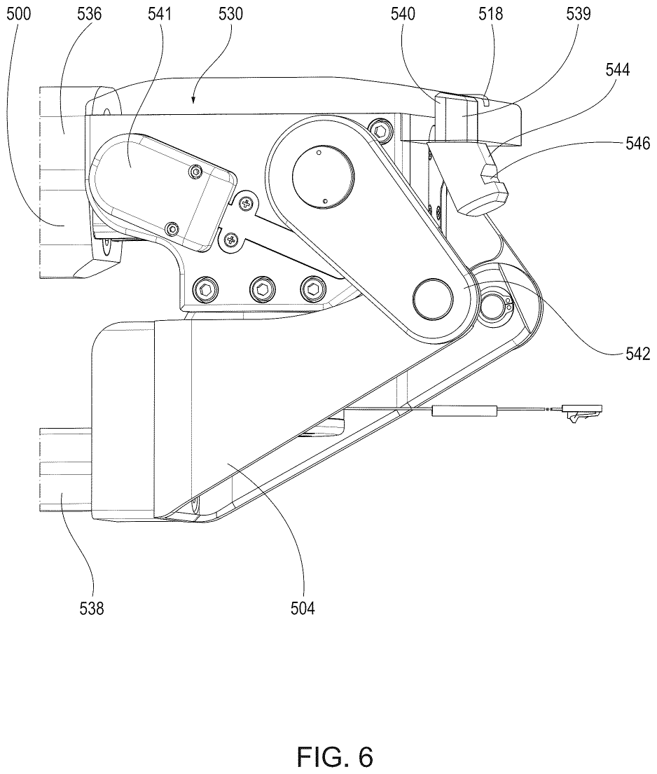

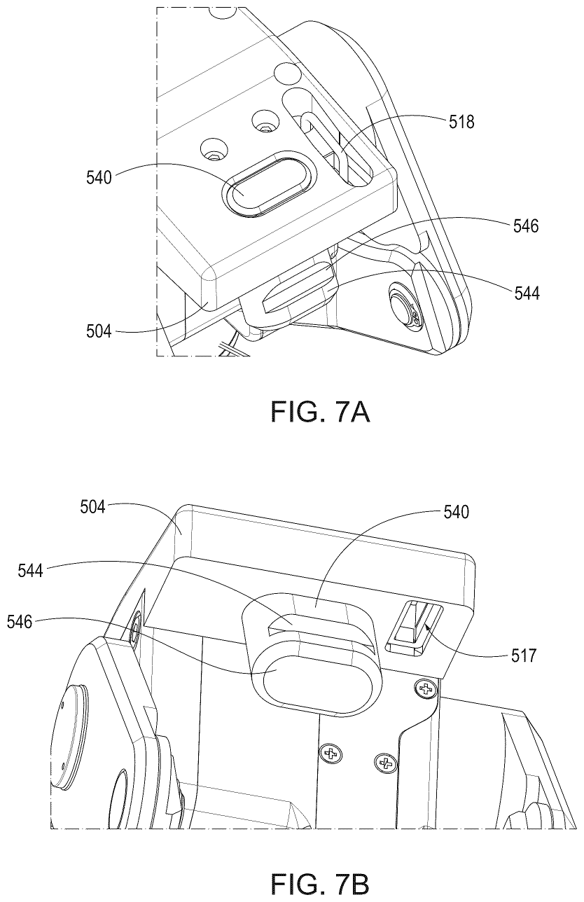

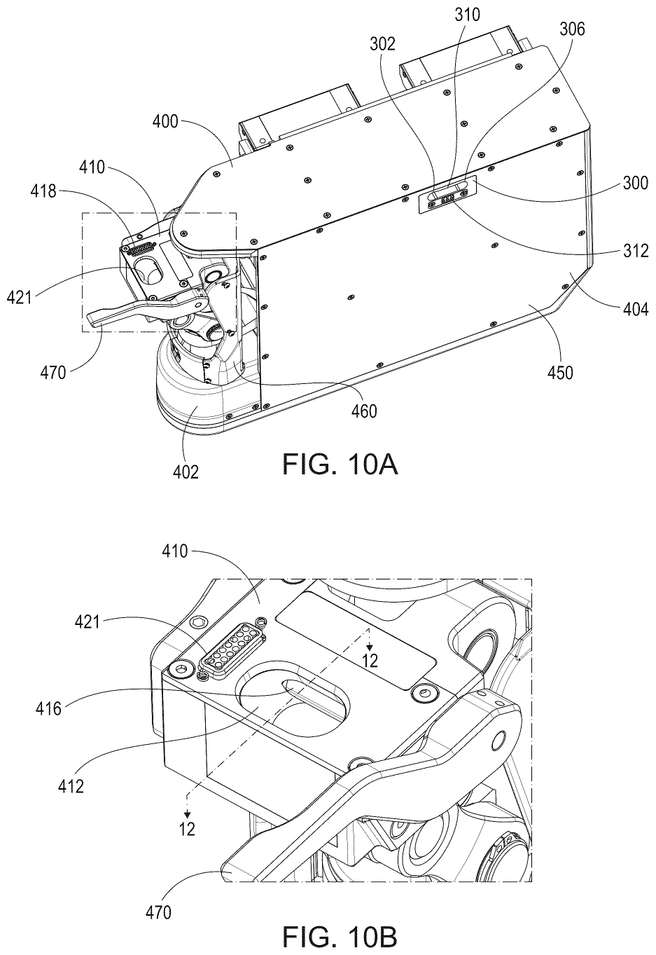

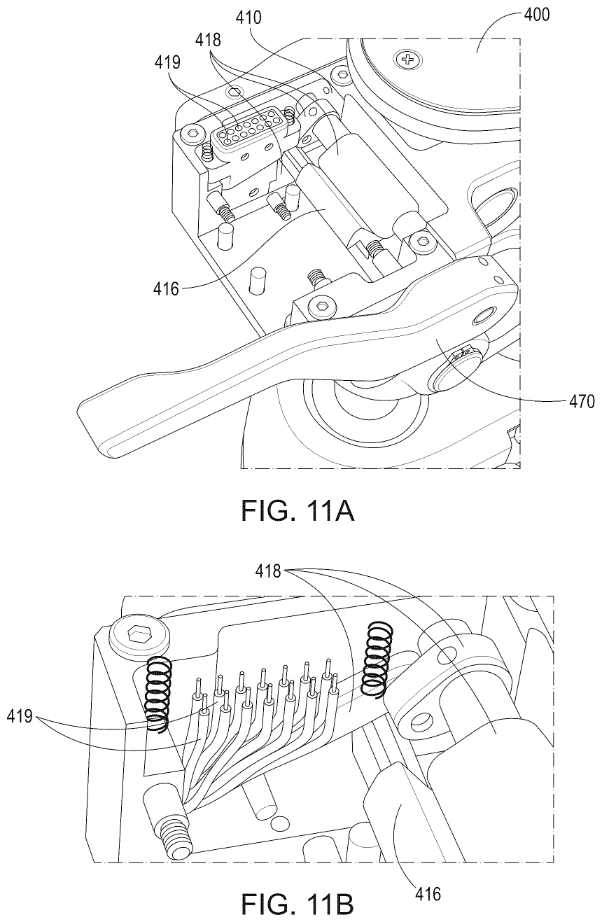

In embodiments, proximal end 504 of spar 500 may couple to spar base 400 (FIG. 10A). With reference to FIG. 6, proximal end 504 of spar 500 may include a projection 540, which may extend outwardly from proximal end 504. Projection 540 may include an inclined face 544 and a notch 546. Notch 546 may receive a boss 416 (FIG. 10B) inside of spar base 400. Projection 540 may be received by spar base 400 to couple spar 500 to spar base 400. In embodiments, spar 500 may include a pin 518 and/or an electrical receptacle 517 as shown with reference to FIGS. 7A-B. Pin 518 and electrical receptacle 517 may couple to an electrical connection 418 (FIG. 11B) of spar base 400 to allow spar 500 to receive power from, and communicate with, positioning system 100 and components thereof.

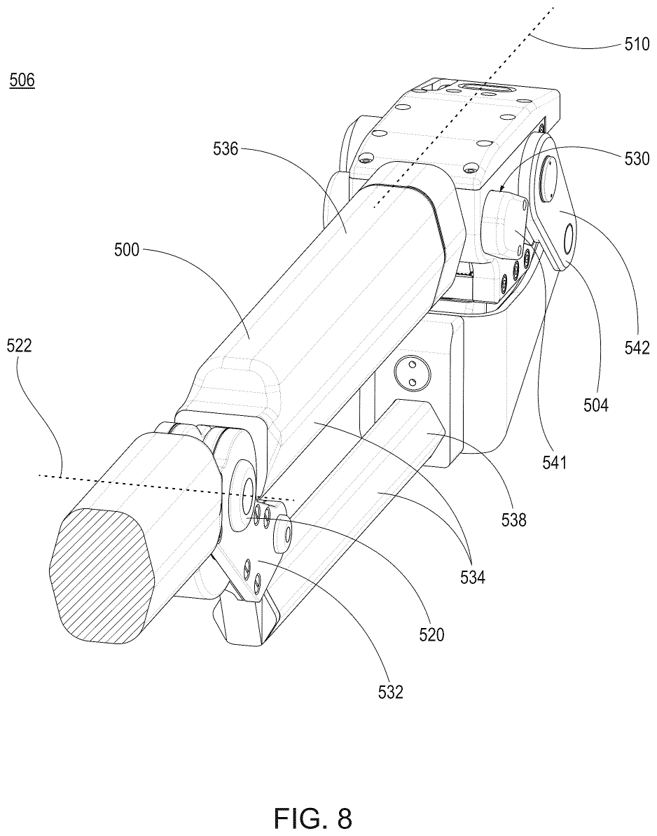

With reference to FIG. 8, in certain embodiments, spar 500 may include one or more profiles that may enhance radiolucency and/or radio-uniformity. As shown, spar 500 may include a cross-section having a substantially hexagonal shape. Accordingly, material may be minimized toward edges of spar 500 to enhance radiolucency. In other words, the angled walls provided by the substantially hexagonal shape minimize the x ray path length and reduce attenuation lines in x ray images. In addition, edges of spar 500 may be rounded rather than sharp. Including curves rather than sharp edges may enhance to enhance radiolucency and/or radio-uniformity. Spar 500 may include a portion that is substantially radiolucent. Alternatively, spar 500 may be mostly or entirely radiolucent. For example, spar 500 may consist essentially of carbon fiber. In other words, spar 500 may be composed mostly or entirely of carbon fiber. In this way, spar 500 may be radiolucent when it is composed of radiolucent carbon fiber material. In certain embodiments, proximal end 504 of spar 500 may be at least partially non-radiolucent by including metal. For example, one or more gears 530 may include metal, such as steel. Spar 500 may be translated in superior direction 101 to move at least a portion of proximal end 504 superior to and outside of any imaging window to avoid metal of proximal end 504 from being within the imaging window. Remaining portions of spar 500 may be substantially radiolucent. Accordingly, one or more gears 530 may not be radiolucent. One or more links 534 passive link 532, joint 520, first link 536, and second link 538 may be include a portion that is substantially radiolucent. Alternatively, one or more links 534 passive link 532, joint 520, first link 536, and second link 538 may be mostly or entirely radiolucent. For example, one or more links 534 passive link 532, joint 520, first link 536, and second link 538 may consist essentially of carbon fiber. In other words, these components may be composed mostly or entirely of carbon fiber. In this way, these components may be radiolucent.

In still further embodiments, spar 500 may be substantially hollow. Spar 500 may include wires 570 (not shown) to connect spar 500 from spar base 400 (FIG. 10A) at electrical connection 418 (FIG. 11B) to one or more controls, such as controls of handle 560, e.g., button 662, control 564, and control 565, and manual lock 548. Wires 570 may also connect spar 500 to UAI port 300 at distal end 504 of spar 500. Wires 570 may be made substantially or completely of carbon fiber. Alternatively, wires 570 may be made substantially or completely of copper, or another metal. The metal of wires 570 may be located inside spar 500 adjacent to an outside edge of spar 500, and therefore may not materially affect the translucency of spar 500. Wires 570 may conduct electricity and/or an electrical signal. In still further embodiments, spar 500 may be substantially or entirely made of carbon fiber between distal end 502 where table modules 340, such as foot support module 350 (FIG. 1), are mounted and proximal ends of first link 536 and second link 538.

In embodiments, spar base 400 (FIG. 10A) may be radiolucent like spar 500. Alternatively, spar base 400 may include metal. For example, components of spar base 400 may include steel. In other embodiments, spar base 400 is not radiolucent.

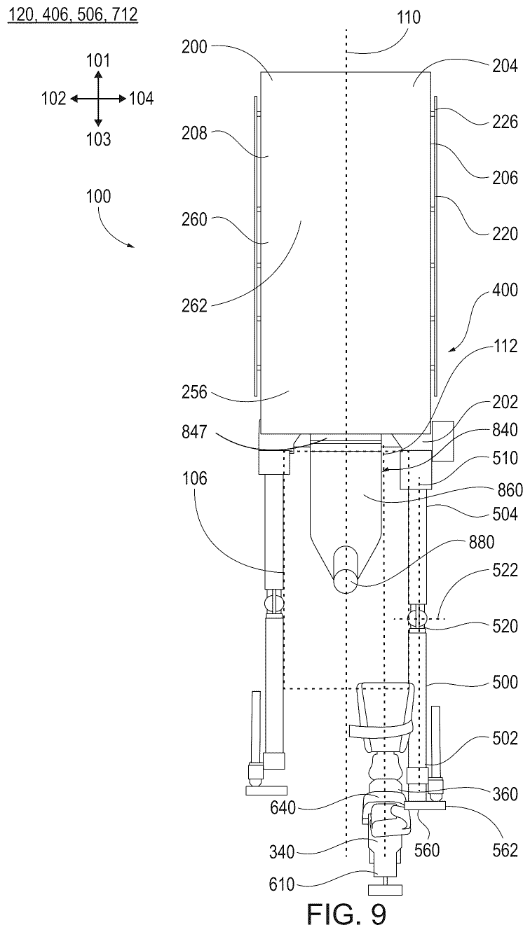

Imaging of patient 20 (FIG. 18) may be conducted from a top-down view in the posterior direction 107 (FIG. 1), shown with reference to FIG. 9 according to exemplary embodiments. A top-down lower body imaging window 106 is shown in FIG. 9. Surgery table 200 may include top-down lower body imaging window 106 to facilitate x ray and other imaging for knee orthopedic surgeries. positioning system 10 (FIG. 1) may also facilitate side imaging and oblique imaging.

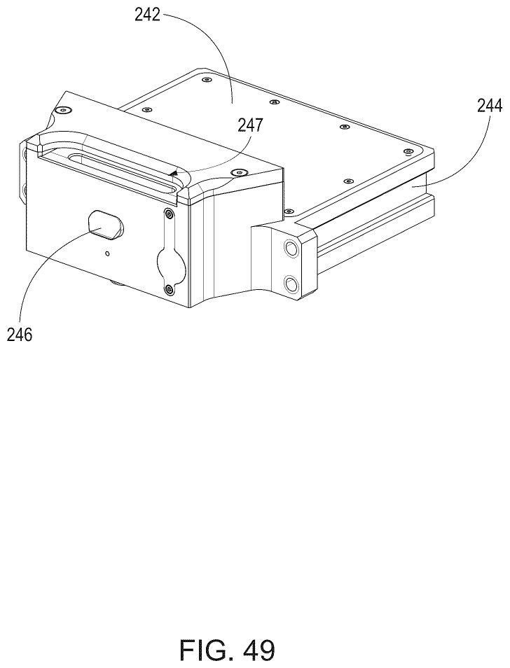

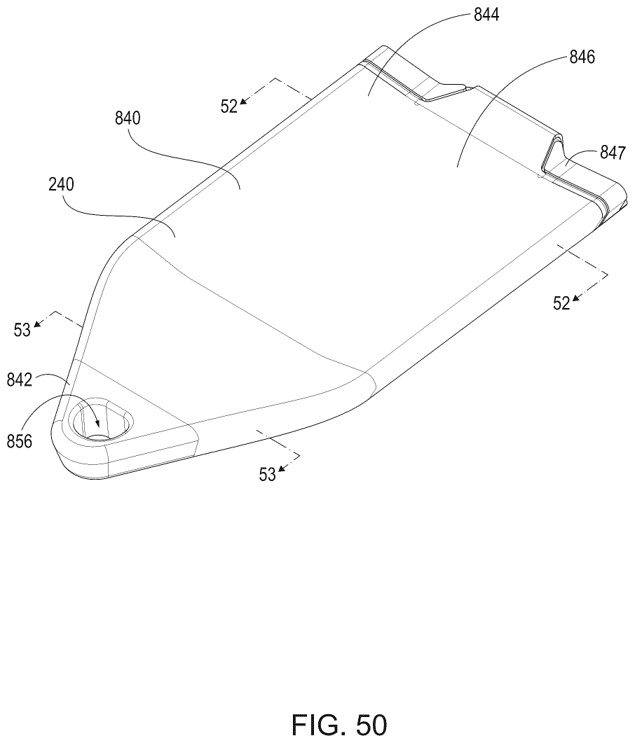

Top-down imaging window 106 may vary based on the configuration of positioning system 100 (FIG. 1). FIG. 9 may show a configuration for hip surgeries. In this embodiment, spar base 400, which may include metal, may be superior to top-down imaging window 106. Spar base 400 may extend to distal end 202 of surgery table 202 and top-down imaging window 106 may extend from distal end 202. Therefore, in embodiments, spar base 400 may be excluded from top-down imaging window 106. In addition, a mount 847 of a pelvic center board 840 (FIGS. 49-50), which will be described further below, may include metal that may be superior to top-down imaging window 106. A static pelvic port adapter 242 (FIG. 49) may include a notch 247 (FIG. 49) to receive mount 847, thereby housing at least a portion of any metal of pelvic center board 840. Alternative to static pelvic port adapter 242, pelvic center board 840 may coupled to an articulating pelvic port adapter 248. Static pelvic port adapter 242 and articulating pelvic port adapter 248 may also be superior to top-down imaging window 106 such that any metal of pelvic center board 840 may be superior to top-down imaging window 106. Top-down imaging window 106 may have a superior end based on the configuration of positioning system 100.

For hip surgeries, proximal end 504 of spar 500, which may include metal, may intrude into top-down imaging window 106. However, these metal portions of proximal end 504 of spar 500 may not be imageable, which may be clinically acceptable for some hip procedures.

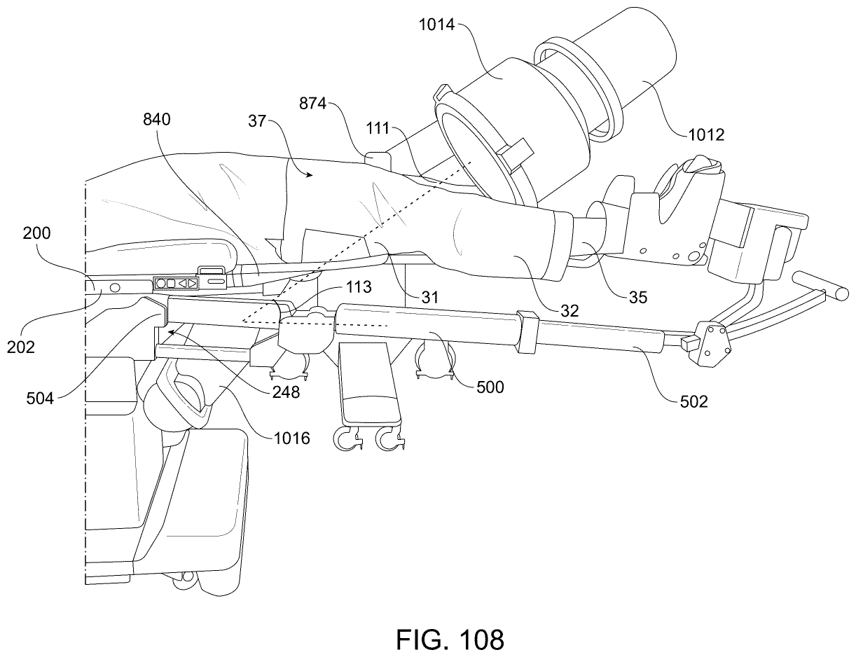

For pelvic imaging, the entire pelvic region 37 (as best shown in FIG. 20) may be visualized such that the entire pelvis and the lower lumbar spine, such as the spine up to the L3 vertebrae for most demographics, such as about 98% of patients, proximal end 504 of spar 500 may be excluded from top-down imaging window 106. Spar base 400 may be translated further superior such that spar 500 coupled to spar base 400 is at least partially superior to distal end 202 of surgery table 200. In this way, any metal at proximal end 504 of spar 500 may be superior to and outside of top-down imaging window 106. Spar 500 may thus be retracted into surgery table 200 such that proximal end 504 is superior to top-down imaging window 106. Spar 500 retracted in this way is shown in FIG. 108 according to exemplary embodiments. The ability to apply traction to spar 500 and conduct pelvic imaging up to the L3 vertebrae is beneficial.

In embodiments, the entirety of spar 500 may also be excluded from top-down imaging window 106. As discussed, spar 500 may extend from spar base 400. As spar base 400 may be disposed along a lateral edge of surgery table 200, such as first side 206 or second side 208, spar 500 may extend from a lateral edge of surgery table 200. As shown, spar 500 may extend from a lateral edge of surgery table 200 along horizontal spar axis 510. Leg 32 (FIG. 20) of patient 20 (FIG. 18) may extend away from spar 500 to foot support 640. Foot support module 350 may be mounted medial to the spar 500, and extend outwardly from spar 500 in medial direction 102 such that such that spar 500 is laterally offset from foot support module 350, and therefore at least a portion of leg 32 of patient 20. Thus, horizontal spar axis 510 may be lateral to a limb axis 112, which may extend along leg 32. In other words, leg 32 may be interior to spar 500. In embodiments, top-down imaging window 106 may surround leg 32 but not spar 500. Accordingly, leg 32 may be within top-down imaging window 106 while spar 500 may be laterally offset from imaging window 106. Alternatively, spar 500 may be at least partially, or fully, included in top-down imaging window 106. As discussed, spar 500 may be radiolucent such that spar 500 does not inhibit imaging if at least partially, or fully, included in top-down imaging window 106.

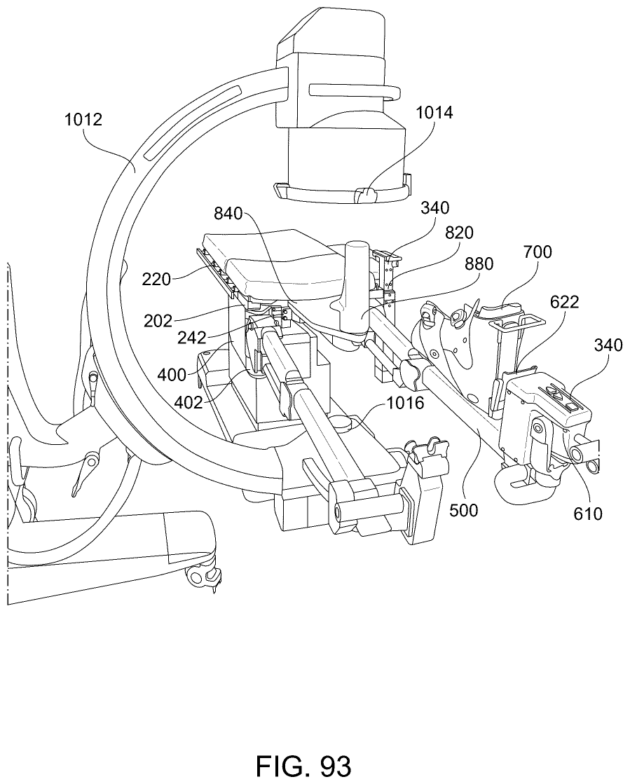

A top-down imaging setup may be seen in FIG. 93 according to exemplary embodiments. As shown, a C-arm 1012 may be positioned to provide x ray imaging, or other imaging. C-arm 1012 can include an intensifier 1014 and an x ray generator 1016 that may create an x ray pathway within top-down imaging window 106 (FIG. 9). A transverse length of positioning system 10 (FIG. 10) within top-down imaging window 106 can be minimized to provide greater flexibility to maneuver C-arm 1012. With reference to FIG. 19 according to exemplary embodiments, a transverse height 108 between a bottom of spar 500 and a top of perineal post bolster 874, which will be discussed further below, transverse height 108 is between about 15 inches and about 25 inches, such as between about 16 inches and about 20 inches, such as about 18 inches.

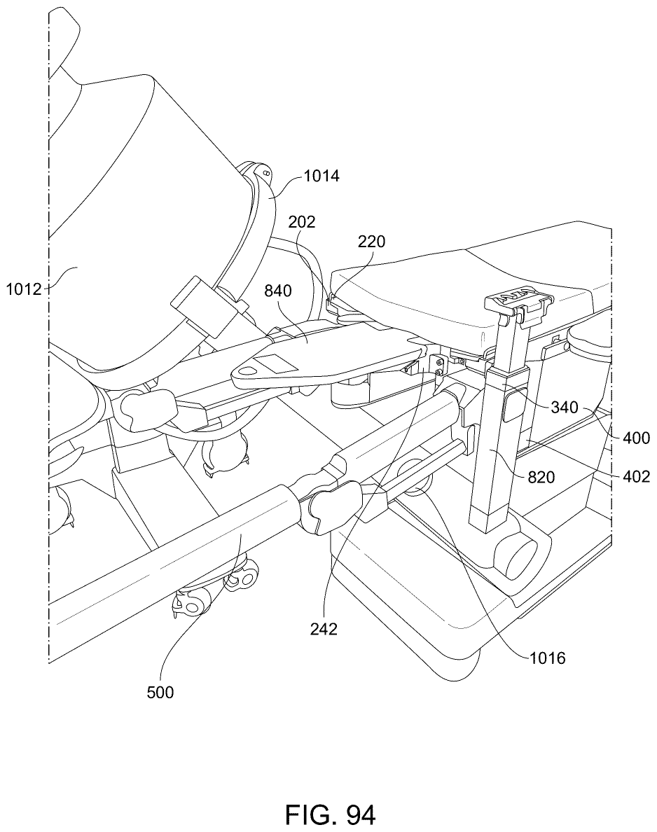

Oblique imaging, or oblique pelvic outlet imaging, is shown in FIGS. 94 and 108 according to exemplary embodiments. As with top-down imaging, spar base 400 and other metal of surgery table 100 (FIG. 1) may be outside an imaging window for oblique imaging. The oblique imaging window may be bounded by column 222 (FIG. 1) and base 224 (FIG. 1) of surgery table 200 and one or more attachments to surgery table 200, such as static pelvic port adapter 242 or articulating pelvic port adapter 248, which will be described further below. Static pelvic port adapter 242 or articulating pelvic port adapter 248 may include a rounded, or chamfered inferior end to allow clearance of C-arm 1016. Similarly, the geometry of pelvic center board 840 may facilitate oblique imaging by allowing clearance of C-arm 1012. As shown, x ray generator 1016 can be positioned under platform 220 proximate column 22 and base 224 to form the oblique x ray path. In certain embodiments, the oblique imaging window may be defined by a plane parallel to x ray imaging path 11, bounded on either side by the spars 500, and terminating at column 222 and/or base 224, and beginning at intensifier 1014. The oblique imaging window may not intersect with spars 500, pelvic center board 840 and articulating pelvic port adapter 248, depending on the x ray path 111. In other embodiments, the oblique imaging window may not intersect with articulating pelvic port adapter 248 and other metal included in surgery table 200. In still further embodiments, portions of surgery table 200 that intersect the oblique imaging window comprise carbon fiber and are radiolucent and/or radiouniform.

As shown in FIG. 108, an x ray path 111 may be at an angle 113 relative to a horizontal, such as spar 500 in straight spar configuration 506 (FIG. 3) or the ground surface. Angle 113 may be between about 30 degrees and about 60 degrees, such as about 40 degrees, or about 45 degrees, or about 50 degrees. C-arm 1012 may facilitate a greater x ray angle, such as about 50 degrees based on tight nesting between spars 500 and close placement to pelvic region 37 such that C-arm is positioned between spars 500 and other components. Spars 500 may be yawed outwardly to allow C-arm 1012 placement therebetween. As shown, x ray path 111 may not intersect with spars 500, pelvic center board 840 and articulating pelvic port adapter 248, depending on the x ray path. In other embodiments, x ray path 111 may not intersect with articulating pelvic port adapter 248 and other metal. In still further embodiments, portions of surgery table 200 that intersect the x ray path 111 comprise carbon fiber and are radiolucent and/or radiouniform. In one embodiment, at least one of articulating pelvic port adapter 248 and Static pelvic port adapter 242 include a shape that does not comprise any metal in the x ray path 111. In some embodiments, the shape includes a chamfer in the area of the x-ray path 111.

In some embodiments, platform 202 (FIG. 1) may be translatable along with spars 500 in inferior direction 103 (FIG. 1). Accordingly, C-arm 1012 may have additional clearance toward column 222 (FIG. 1) and base 224 (FIG. 1) of surgery table 200 to enable oblique imaging at greater than about 50 degrees.

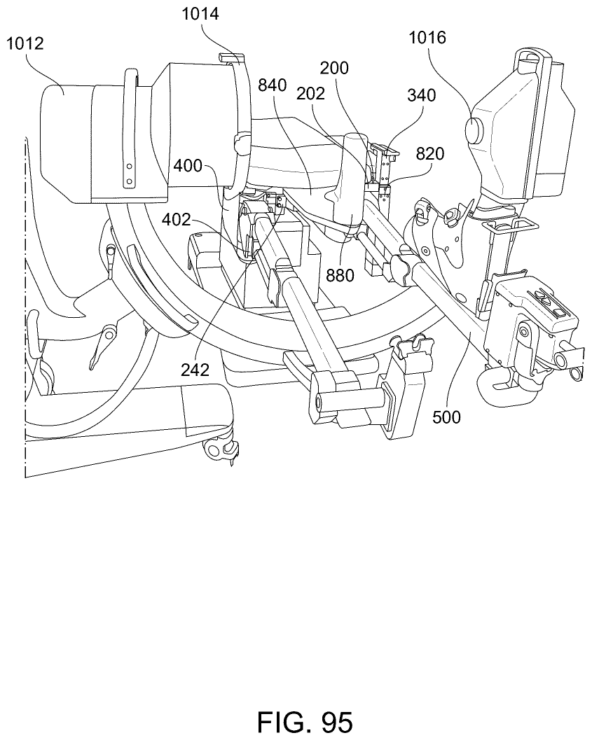

A side imaging setup may be seen in FIG. 95 according to exemplary embodiments. The transverse and lateral lengths of positioning system 10 within the oblique imaging window may provide greater flexibility to maneuver C-arm 1012 for side imaging.

Spar base 400 is shown in FIGS. 10A-13 according to exemplary embodiments. With reference to FIGS. 10A-12, spar base 400 may include a spar mount 410 to receive spar 500 (FIG. 3). Spar mount 410 may include a receptacle 412 having an inclined wall 414. Accordingly, spar mount 410 may receive projection 540 (FIG. 4) of spar 500 as receptacle 412 may have inclined wall 414 to receive inclined face 544 (FIG. 4) of projection 540. Receptacle 412 may also include an electrical connection 421 and a boss 416. Boss 416 may be a projection that is retractable to alternately actuate and release electrical connection between spar base 400 and spar 500. Boss 416 may project into notch 546 (FIG. 4) such that electrical connection 421 of spar base 400 is coupled to pin 518 (FIG. 7A) through electrical receptacle 518 (FIG. 7B) of spar 500. For example, electrical receptacle 518 may be an opening that may receive electrical connection 421, which may include one or more electrical connector pins 419, shown in FIGS. 11A-B. Boss 416 may couple to notch 546 when spar 500 is coupled to spar base 400 at distal end 402 of spar base 400.

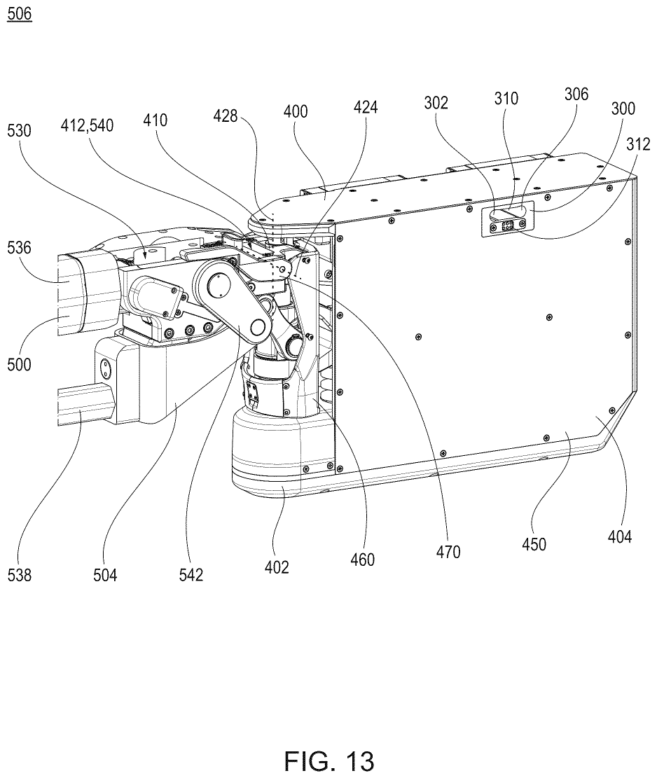

Spar 500 coupled to spar base 400 by spar mount 410 receiving projection 540 is shown in FIG. 13. A handle 470 may be pivoted up to unlock spar 500 and allow spar 500 to be removed from spar base 400, and pivoted down to lock spar 500 into spar base 400. Handle 470 may also be pivoted to alternately actuate and release the electrical connection between spar 500 and spar base 400. Another mechanism for locking spar 500 to spar base 400 may be used, such as a button, switch, or other control.

Handle 470 shown in FIG. 13 may be in a pivoted down position to lock spar 500 (FIG. 3) and actuate the electrical connection between spar 500 and spar base 400. Referring again to FIGS. 11A-B, handle 470 may be pivoted down, causing electrical connection 421 to elevate. Boss 416 may be a projection that is shaped such that it is retractable as handle 470 rotates upward. Pivoting handle 470 down such that boss 416 engages notch 546 and electrical connection 421 is raised and coupled to pin 518 (FIG. 7A) and electrical receptacle 517 (FIG. 7B) of spar 500 (FIG. 3) may rotate a series of linkages 418. Linkages 418 may raise pins 419 inside of electrical connection 421 in order to provide an electrical connection through spar base 400 to spar 500.

Retracting boss 416 may also retract electrical connection 418. Rotating handle 470 upward such that boss 416 and electrical connection 421 are retracted may rotate linkages 418 such that pins 419 are lowered and the electrical connection through spar base 400 is disconnected. Boss 416 may be retracted from notch 546 of spar 500 and spar 500 may be removed from spar base 400.

With reference to FIGS. 3-4 and 12-13, as projection 540 of spar 500 is inserted into receptacle 412, projection 540 may both be inserted and moved in superior direction 101 (FIG. 1) inside of receptacle 412 by nature of inclined face 544 of projection 540 and inclined wall 414 of spar base 400. Electrical connection 421 and pins 419 may be lowered during insertion such that electrical connection 421 and pins 419 are clear from any shear induced by spar 500, such as projection 540, as spar 500, such as projection 540 are moved in superior direction 101 during insertion. Only when spar 500 and projection 540 are seated, electrical connection 421 and pins 419 may be raised vertically in anterior direction 105 (FIG. 1) into connection with pin 518 (FIG. 7A) and electrical receptacle 517 (FIG. 7B).

Referring to FIGS. 3-13, pin 518, electrical receptacle 517, projection 540, pins 419, and spar mount 410 may be generally at an angle at about which spar 500 is installed, e.g., generally an angle of inclined face 544 of projection 540 of spar 500. In this way, components of spar 500 and spar base 400 may be nested during coupling of spar 500 and spar base 400.

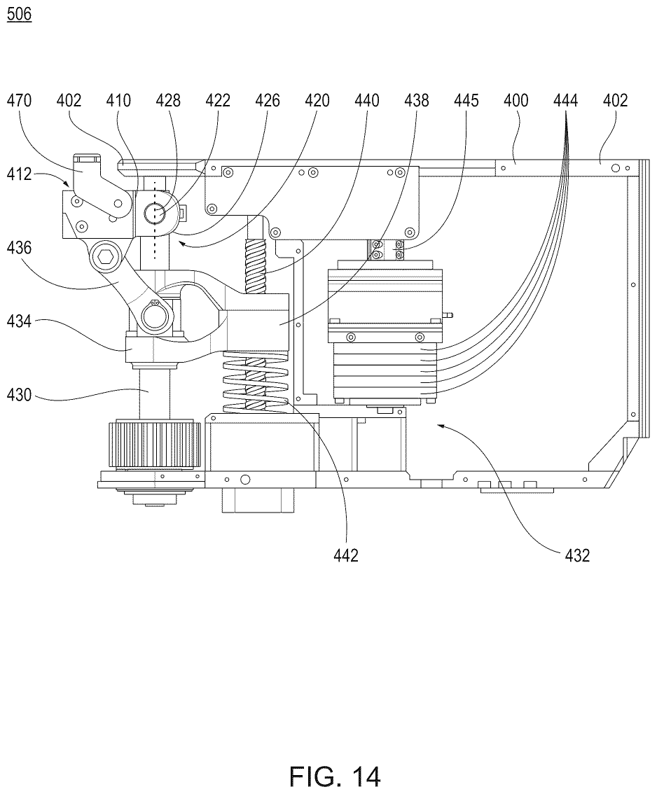

A housing face 450 and a pivot post housing 460 are removed to show additional spar base 400 components as shown in FIG. 14 according to exemplary embodiments. As discussed, spar 500 may be maneuvered in pitch and yaw directions. In embodiments, spar base 400 may include one or more joints 420 to articulate spar mount 410. In further embodiments, the one or more joints 420 may include metal. In other embodiments, spar base 400 may be excluded from top-down imaging window 106 (FIG. 9) such that components of spar base 400 may not affect imaging.

In certain embodiments, spar base 400 may include a pivot post 430 as shown in FIG. 14. Pivot post 430 may extend from distal end 402 of spar base 400. One or more joints 420 may include a first joint 422 to articulate spar mount 410 in a pitch direction such that first joint 422 may be a pitch joint. First joint 422 may be rotatably coupled to pivot post 430. For example, spar mount 410 may be rotatably coupled to pivot post 430 and may include first joint 422. First joint 422 may cause rotation of spar mount 410 about a first rotational axis 424 (FIG. 13), which may be a pitch axis. One or more joints 420 may also include a second joint 426 such that second joint 426 may be a yaw joint. Second joint 426 may be rotatably coupled to pivot post 430. For example, spar mount 410 may be rotatably coupled to pivot post 430 and may include second joint 426. First joint 422 may cause rotation of spar mount 410 about a second rotational axis 428, which may be a yaw axis. As shown in FIG. 11, first rotation axis 424 for first joint 422 and second rotation axis 428 for second joint 426 may intersect.

Referring to FIGS. 13-14, in another embodiment, first rotation axis 424 (FIG. 13) for first joint 422 and second rotation axis 428 for second joint 426 may intersect. In other words the pitch and yaw axes of spar 500 may intersect. First rotation axis 424 for first joint 422 and second rotation axis 428 for second joint 426 may intersect superior to an imaging window, such as top-down imaging window 106 (FIG. 9). In this way, one or more joints 420 are superior to and outside of an imaging window. In addition, first rotation axis 424 for first joint 422 and second rotation axis 428 for second joint 426 may translate as spar base 400 translates a distance along surgery table 200 (FIG. 1) between distal end 202 (FIG. 1) and proximal end 204 (FIG. 1) of surgery table 200 (FIG. 1). Accordingly, spar 500 may translate as spar base 400 translates because spar 500 extends from spar base 400, and spar base 400 also includes the pitch and yaw joints and axes for spar 500.

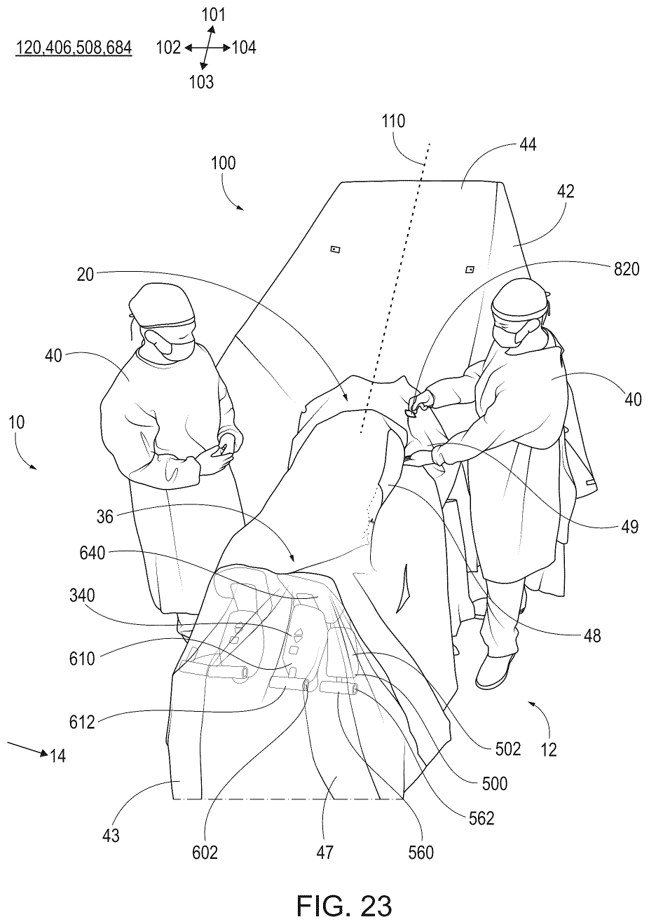

Spar base 400 may also assist spar 500 in pitch motion. In other words, spar base 400 may provide gravity compensation to lift and lower spar 500 in anterior direction 105 (FIG. 1) and posterior direction 107 (FIG. 1), respectively, without a user 40 (FIG. 23) having to lift or lower the full weight of spar 500, in other words “lift assist.” In another embodiment, spar base 400 includes the pitch and yaw axis for spar 500, translates spart 500 and includes lift assist for spar 500.

A lift assist mechanism 432 of spar base 400 is shown in FIGS. 14-16 according to exemplary embodiments. Lift assist mechanism 432 may include a combination of linear and rotation spring assist to provide lift assist to spar 500. Linear motion along pivot post 430 may transfer the moment load to rotational motion via a back-driven ball nut 438 and screw 440, which will be described further below. The rotational motion may travel through a gearbox 446, which will be described further below, into an input shaft of a lift assist and brake assembly. In one embodiment, the total mechanical advantage from ball nut 438 and screw 440 and gearbox 446 is about 80:1.

In an embodiment, lift assist mechanism 432 may be part of positioning system 100. In another example, lift assist mechanism 432 may be a part of surgery table 200. In another example, lift assist mechanism 432 may be a part of spar base 400. In another example, lift assist mechanism 432 may function separately, such as with other positioning systems, surgery tables, or apparatuses thereof. In an example, lift assist mechanism 432 may include features that are functional separately and in combination.

FIG. 14 shows lift assist mechanism 432 when spar 500 (FIG. 3) is in straight spar configuration 506. Accordingly, spar 500 is not being lifted or lowered and instead is horizontal relative to ground surface 14 (FIG. 1). In straight spar configuration 506, a linkage 436 of lift assist mechanism 432 is not actuating spar mount 410. Thus, spar mount 410 appears generally horizontal relative to ground surface 14. Lift assist mechanism 432 may include a slider 434 to actuate spar mount 410 such that spar mount 410 is non-horizontal relative to ground surface 14. Slider 434 may translate along pivot post 430 to actuate spar mount 410. Either directly or operatively, slider 434 may be coupled to spar mount 410 such that actuating slider 434 may actuate spar mount 410. For example, slider 434 may be coupled to spar mount 310 by a linkage 436. Thus, linkage 436 may be actuated by slider 434 to actuate spar mount 410.

In one embodiment, lift assist mechanism 432 may also include a ball nut 438 and a screw 440. Slider 434 may be coupled to ball nut 438, which may translate along screw 440, such as in anterior direction 105 (FIG. 1) and posterior direction 107 (FIG. 1). In one embodiment, as shown in FIG. 11, lift assist mechanism 423 may include a first spring 442. In one embodiment, first spring 442 may be a coil spring. In addition, first spring 442 may be a die spring and may be coupled to screw 440. Accordingly, like ball nut 438, first spring 442 may move relative to screw 440. First spring 442 may also be coupled to ball nut 438. Accordingly, ball nut 438 may translate in anterior direction 105 (FIG. 1) or posterior direction 107 (FIG. 1) to respectively expand or compress first spring 442.

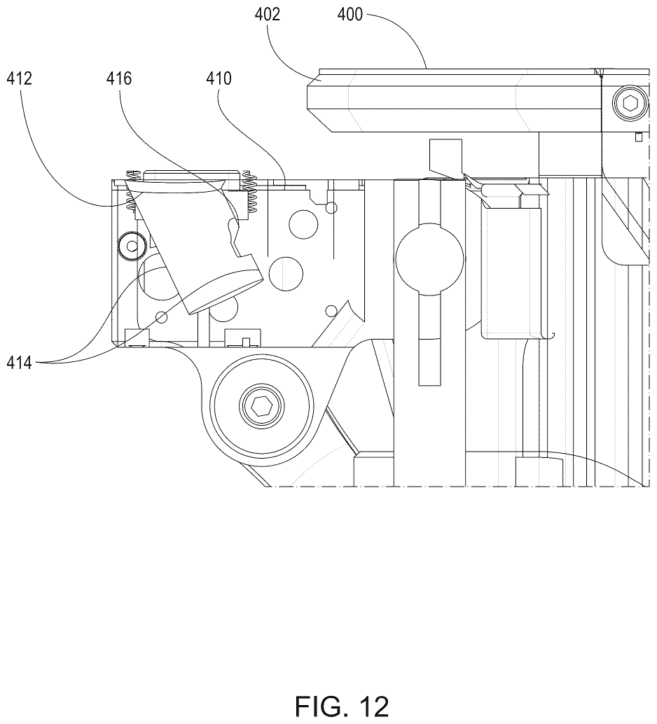

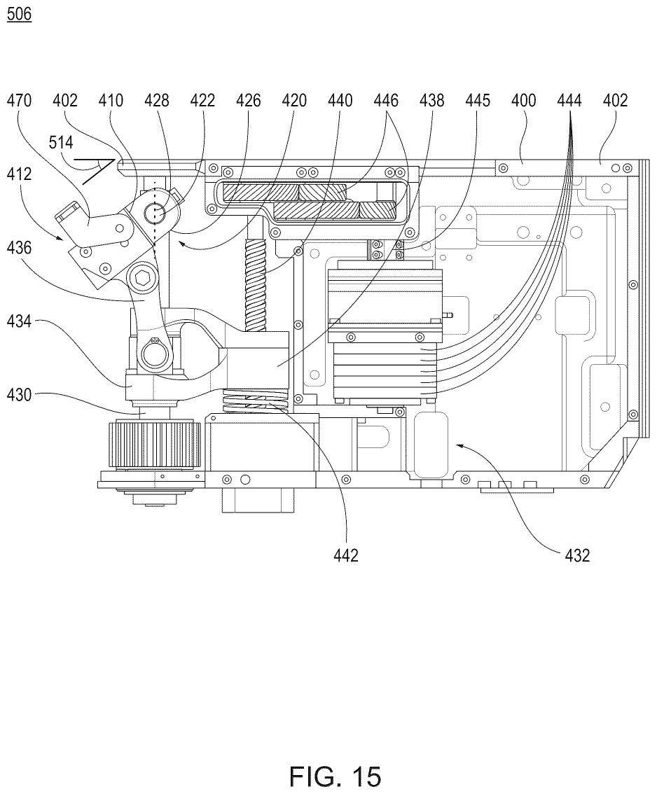

FIG. 15 shows lift assist mechanism 432 when spar 500 (FIG. 3) is in a pitched down configuration 508. With reference to FIG. 12, first spring 442 may provide lift assist for spar 500 to articulate spar 500 in a downward pitch direction, such as posterior direction 107 (FIG. 1). As shown in FIG. 12, first spring 442 may be compressed to allow spar mount 410 to articulate spar 500 in the downward pitch direction. Ball nut 438 may move in posterior direction 107 by rotation of screw 440 to compress first spring 442. Ball nut 438 may also be coupled to slider 434 such that slider 434 may translate along pivot post 430, also in posterior direction 107, thereby pulling linkage 436 in posterior direction 107 and causing spar mount 410 to be articulated downwardly. Spar mount 410 may be articulated such that a downward pitch angle 514 may form. In one embodiment, downward pitch angle 514 may be up to about 45 degrees, such as up to about 40 degrees. In other words, user 40 (FIG. 23) may pitch spar 500 downward in posterior direction 107 such that spar 500 is at downward pitch angle 514 relative to horizontal spar axis 510 (FIG. 3).

When spar is pitched downward to pitched down configuration 508 from straight spar configuration 506, first spring 442 may provide resistance as it compresses, reducing the weight felt by the user at the distal end of the spar 502. In the orientation of FIG. 15, spring 442 may be fully compressed and providing maximum force to spar 500 (FIG. 3) by way of spar mount 410, linkage 436, slider 434, and ball nut 438 all being coupled. Consequently, when user 40 (FIG. 23) begins raising spar 500, spring 442 may provide a “lift assist” to user 40 as spring 442 actuates in reverse. Spring 442 may provide a “lift assist” until spring 442 reaches the limit of its height, at which point it no longer provides a force against ball nut 438.

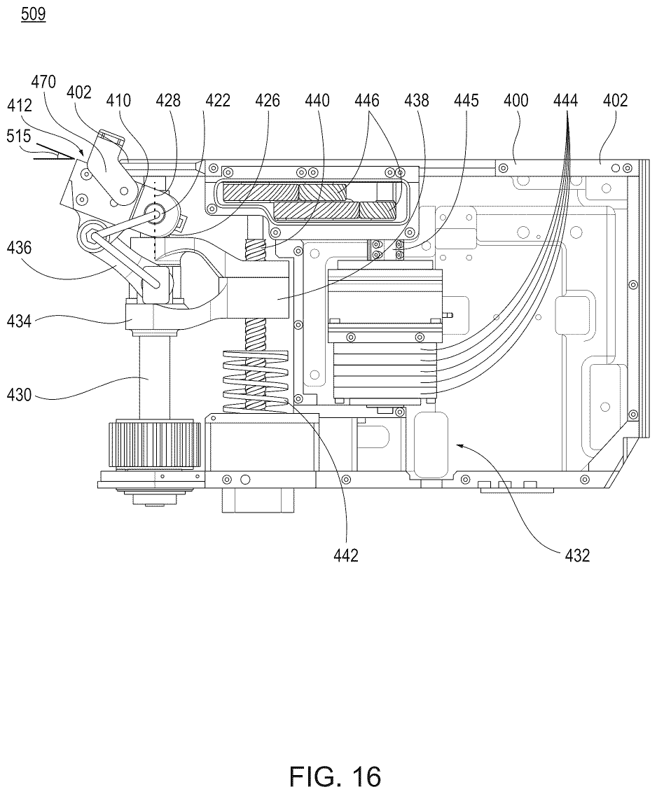

FIG. 16 shows lift assist mechanism 432 when spar 500 (FIG. 3) is in a pitched up configuration 509. In one embodiment, lift assist mechanism 432 may include a gearbox 446 having one or more gears and one or more second springs 444. Each second spring 444 may include a mainspring coupled to a mainspring shaft 445 Mainspring shaft 445 may be coupled to gearbox 446, and gearbox 446 may be coupled to screw 440. In one embodiment, gearbox 446 may multiply the torque exerted by second springs 444 on mainspring shaft 445 incident on screw 440. The first spring 442, second springs 444 may reduce the weight felt by user 40 (FIG. 23) at distal end of the spar 502 when spar 500 (FIG. 1) is pitched downward to pitched down configuration 508. The mainsprings in second springs 444 are wound, and provide lift assist for spar 500 to articulate spar 500 in an upward pitch direction, such as anterior direction 105 (FIG. 1), as mainsprings in second springs 444 are unwound. One or more second springs 444 may include a plurality of springs stacked on top of one another, each second spring 444 coupled to mainsprings shaft 445, in order to provide torque for lift assist mechanism 432. In one embodiment, second springs 444 include one spring, one to three springs, and up to about six second springs 444 in a stacked configuration.

Similar to first spring 442, second springs 444 may be compressed or wound to allow spar mount 410 to articulate spar 500 in the downward pitch direction. Second springs 44 may store energy and may release stored energy when spar 500 (FIG. 3) is lifted, providing a “lift assist.” First spring 442 may be expanded to allow spar mount 410 to articulate spar 500 in the upward pitch direction. Ball nut 438 may move in anterior direction 105 by rotation of screw 440 to expand first spring 442. Ball nut 438 may also be coupled to slider 434 such that slider 434 may translate along pivot post 430, also in anterior direction 105, thereby pushing linkage 436 in anterior direction 105 and causing spar mount 410 to be articulated upwardly. Spar mount 410 may be articulated such that an upward pitch angle 515 may form. In one embodiment, upward pitch angle 515 may be up to about 30 degrees, such as up to about 21 degrees. In other words, user 40 (FIG. 23) may pitch spar 500 upward in anterior direction 105 such that spar 500 is at upward pitch angle 515 relative to horizontal spar axis 510 (FIG. 3). In one embodiment, lift assist mechanism 432 may include first spring 442. In another embodiment, lift assist mechanism 432 may include second springs 444 and gearbox 446. In another embodiment, lift assist mechanism 432 may include both first spring 442 and second springs 444, and gearbox 446.

Referring to FIGS. 3 and 15, as discussed, in one embodiment, user 40 (FIG. 23) may pitch spar 500 downward in posterior direction 107 such that spar 500 is at downward pitch angle 514 of up to about 45 degrees. Distal end 502 of spar 500 may reach a position proximate ground surface 14 (FIG. 1) when spar 500 is articulated in a downward pitch direction such that foot 36 (FIG. 20) of at least one leg 32 (FIG. 20) of patient 20 (FIG. 18) is proximate ground surface 14. Spar 500, and in some embodiments, distal end 502, may be devoid of a distal traction mechanism, or a device for generating traction. Spar 500 being devoid of a distal traction mechanism may shorten a length of spar 500 as additional structure distal to leg 32 of patient 20 is not needed. In other words, spar 500, and in some embodiments, distal end 502, may be generally coextensive with leg 32 of patient 20 and not extend substantially beyond leg 32. Spar 500 may not extend as far as a spar with a distal traction mechanism. In this way, spar 500 may be pitched further downward up to about 45 degrees.

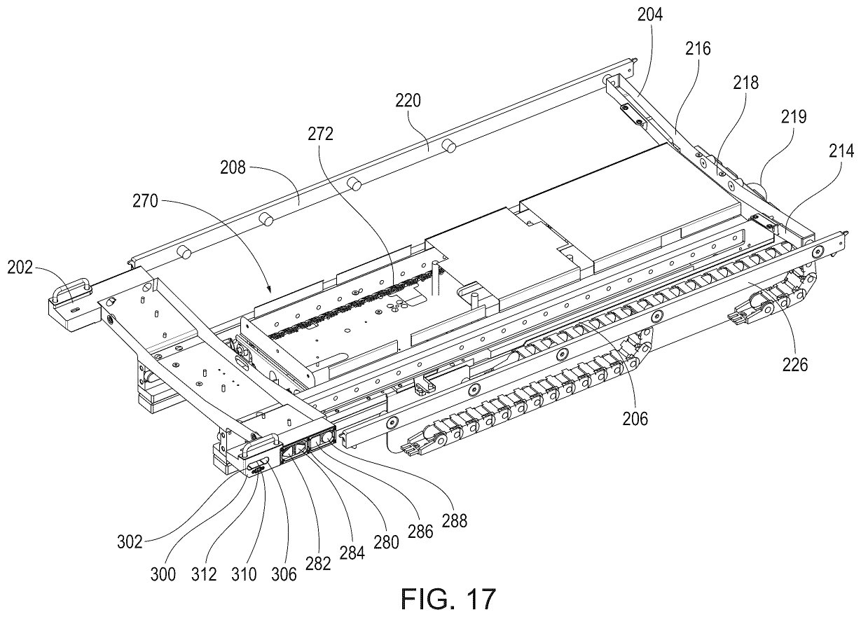

Surgery table 200 (FIG. 1) described herein may include a traction mechanism 270 as shown in FIG. 17 according to exemplary embodiments. However, instead of being at distal end 502 (FIG. 3) of spar 500, traction mechanism 270 may be along surgery table 200 (FIG. 1), such as along platform 220. Spar base 400 (FIG. 1) may be coupled to traction mechanism 270 such that a traction load is applied by traction mechanism 270 to at least one leg 32 (FIG. 20) of patient 20 (FIG. 18) as spar base 400 translates along surgery table 200. Instead of including a traction mechanism, distal end 502 of spar 500 may include handle 560 to allow user 40 to articulate spar 500, the handle 560 including one or more buttons, such as control 562 (FIG. 3), control 564 (FIG. 3), and control 565 (FIG. 3), to unlock spar 500 to allow spar 500 to be articulated. In addition, spar 500 may include foot support module 350 (FIG. 1) to support at least one foot 36 (FIG. 20) of at least one leg 32 of patient 20. Accordingly, distal end 502 may include one or more first spar controls to articulate spar 500 and foot support module 350. Thus, distal end 502 of spar 500 may extend minimally beyond leg 32 in inferior direction 103 (FIG. 1). Distal end 502 may include various features that do not include a traction mechanism. Spar 500 being devoid of a traction mechanism may also reduce the weight of spar 500 to allow spar 500 to be more easily articulated by user 40 (FIG. 23).

FIG. 17 shows platform 220 without top portion 221 (FIG. 2) to view one or more lead screws 272, which may be coupled to spar base 400 (FIG. 1). Platform 220 may include lead screw 272 to translate spar base 400. Lead screw 272 may extend between distal end 202 and proximal end 204 of surgery table 200 (FIG. 1), such as platform 220. Accordingly, as spar base 400 translates a distance between distal end 202 and proximal end 204, a traction load may be applied or released. Lead screw 272 may apply traction as spar 500 (FIG. 3) is pushed outwardly from surgery table 200 in inferior direction 103 (FIG. 1). Lead screw 272 may reduce traction in the opposite direction. In other words, when patient is stationary on surgery table 200, and foot 36 of patient 20 (FIG. 18) is coupled to distal end 502 of spar 500, traction may be applied to leg 32 (FIG. 20) of patient 20 by moving the spar base 400 by lead screw 272, which may be coupled to spar 500, which may be coupled to foot support module 350, which may be coupled to foot 36 of patient 20. Spar base 400 may translate along a profiled ball-bearing linear rail. A bracket (not shown) may connect spar base 400 to a housing (not shown) containing a lead nut and a load cell. Lead screw 272 may pass through the housing such that force applied by lead screw 272 in applying traction is transmitted through the load cell to measure the traction force.

Surgery table 200 may also include a strain gauge (not shown) to measure the traction load and a display (not shown) to indicate a measurement of the traction load. The display may be located along surgery table 200 where user 40 (FIG. 23) may be located, such as along platform 220 or along spar 500, or another user control. User 40 may then understand the traction load being applied to patient 20 (FIG. 18) and adjust accordingly.

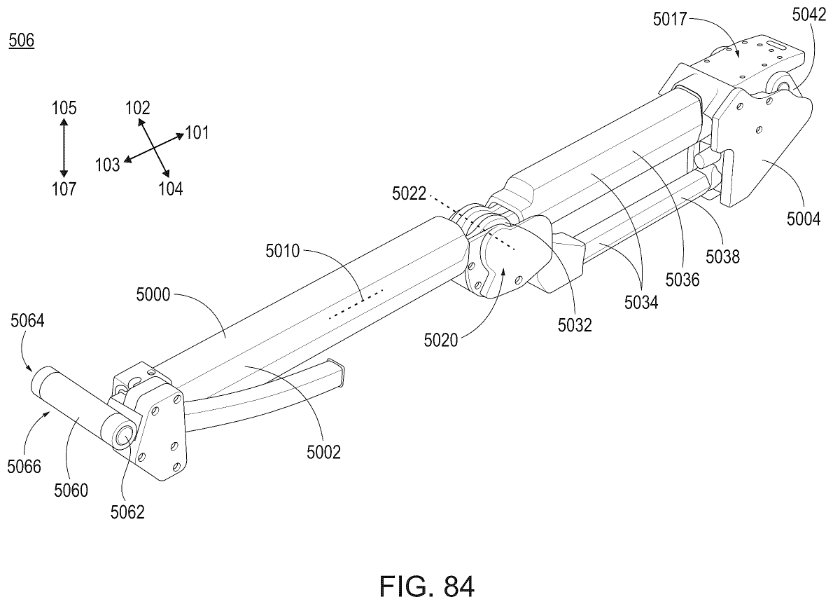

With reference to FIGS. 1-17, surgery table 200 may be convertible between a general-purpose surgery table and a specialty surgery table for orthopedic surgery, for example. Examples of surgery table 200 and surgery table 200 configured for knee surgery are described in U.S. Provisional Patent Application No. 63/712,518 filed Oct. 27, 2024 titled “Systems and Methods for Surgical Positioning,” U.S. Provisional Patent Application No. 63/769,429 filed Mar. 10, 2025 titled “Systems and Methods for Surgical Positioning,” U.S. patent application Ser. No. ______ filed Oct. 27, 2025 titled “Systems and Methods for Surgical Positioning,” and U.S. patent application Ser. No. ______ filed Oct. 27, 2025 titled “Systems and Methods for Surgical Positioning,” which are hereby incorporated by reference in their entireties. In addition, surgery table 200 may be configured for hip surgery or trauma surgery with one or more of the features described previously in addition to including features specific for hip surgery or trauma surgery. Surgery table 200 configured for hip surgery or trauma surgery will now be described with reference to FIGS. 18-84.

Positioning system 100 is shown in FIGS. 18-19 according to exemplary embodiments. In a first position 120 of positioning system 100, spar base 400 may be at a first position 406 at distal end 202 of surgery table 200, and spar 500 may be in straight spar configuration 506. As shown, foot 36 of patient 20 may be secured in foot support 640. In other words, foot 36 may be secured by upper pad 656 and lower pad 658, in addition to foot 36 being secured by one or more binding straps 651. Spar base 400 may be translated such that spar base 400 is moved from first position 406. For example, spar base 400 may translate a distance along surgery table 200 in a direction from proximal end 204 to distal end 202. As discussed with reference to FIG. 17, traction mechanism 270 may apply traction and may be disposed in surgery table 200, such as platform 220. At distal end 502, spar 500 does not a include traction mechanism, and foot support 640 may not be pulled away from surgical table 200 from distal end 502 of spar 500. Rather, spar 500 may be pushed outwardly in inferior direction 103 from surgery table 200 to apply additional traction to leg 32 as foot 36 is secured in foot support 640. Embodiments of foot support 640 will be described further below. In certain embodiments, traction is applied and removed by movement of spar base 400.

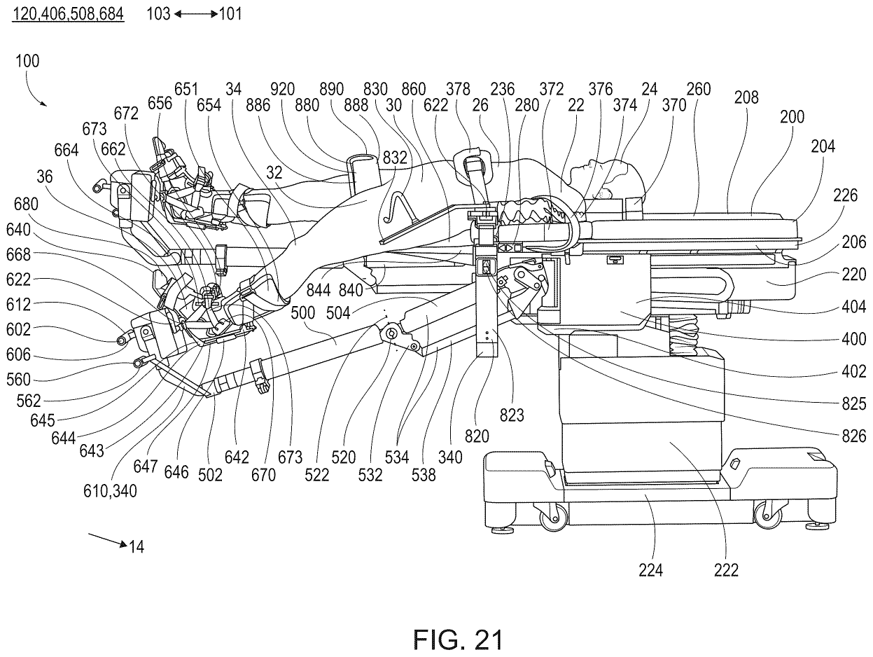

In FIGS. 20-21, positioning system 100 may be in a pitch position 126 according to exemplary embodiments. In pitch position 126, spar base 400 may be at first position 406 at distal end 202 of surgery table 200, and spar 500 may be in pitched down configuration 508. Thus, spar 500 may be pitched downward in posterior direction 107 (FIG. 1) such that spar 500 is at downward pitch angle 514 of up to about 45 degrees. Proximal end 502 of spar 500 may be pitched further toward ground surface 14 as spar 500, such as distal end 502 of spar 500, may be devoid of, or not include, a traction mechanism. Spar 500 being devoid of a traction mechanism may shorten a length of spar 500 as additional structure distal to leg 32 of patient 20 for applying traction is not needed. In other words, spar 500, and in some embodiments, distal end 502, may be generally coextensive with leg 32 of patient 20 and not extend substantially beyond leg 32. In this way, spar 500 may be pitched further downward up to about 45 degrees, than if spar 500 included a traction mechanism distal to the foot 36.

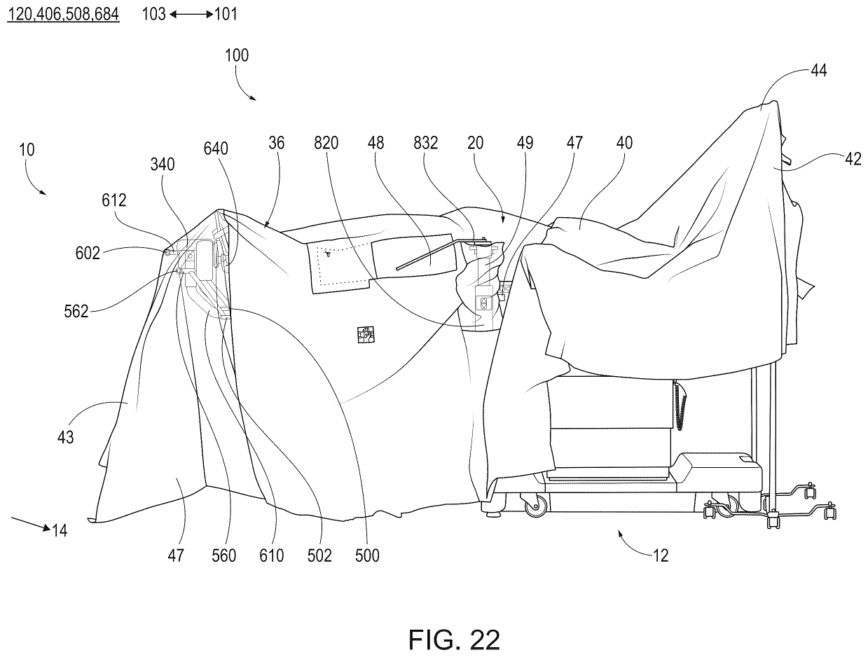

In a surgical procedure, it is important to maintain a sterile environment. Several tools may be used to create and maintain the sterile environment, such as a drape 42, shown in FIGS. 22-24, according to exemplary embodiments. In an embodiment, drape 42 may be part of positioning system 100. In another example, drape 42 may be a part of surgery table 200. In another example, drape 42 may function separately, such as with other positioning systems, surgery tables, or apparatuses thereof. In an example, drape 42 may include features that are functional separately and in combination.

With reference to FIG. 22-24, drape 42 may be used for positioning system 100 to separate a sterile space 10 and a working space 12. Sterile space 10 may include a surgical site, and working space 12 may include various equipment for facilitating a surgical procedure, such as surgery table 200 (FIG. 1), spar 500, and non-operative portions of the patient 20, and non-operative portions of positioning system 100 and patient 20. Drape 42 may facilitate the surgical procedure as well. For example, as discussed, distal end 502 of spar 500 may include foot support module 350 to support at least one foot 36 of at least one leg 32 of patient 20. In addition, foot support 640 may support at least one foot 36 of at least one leg 32 of patient 20. Foot support module 350 may be coupled to foot support 640. However, foot support module 350 may be in working space 12. foot support 640 may be in working space 10 as well, as shown in FIG. 22. As shown, foot support 640 and foot support module 350 are not separated by drape 42. However, other foot supports may be in sterile space 10 and separated from foot support module 350, or other table modules 340, by drape 42, or another drape. The coupling between foot support module 350 and foot support 640 will be described further below.

Distal end 502 of spar 500 and foot support module 340 may include various controls for articulating spar 500 and foot support 640, such as handle 560 having control 562 located in working space 12. Accordingly, a user 40 who is positioned in sterile space 10 may require access to these controls through drape 42. Instead of lifting drape 42 to access these controls directly from working space 12 in which controls are disposed, which would breach the sterile barrier formed by drape 42, user 40 may access the controls from sterile space 10. As shown, drape 42 may include one or more film portions that may allow user 40 visual access to controls such that user 40 may actuate controls from sterile space 10 through drape 42.

Drape 42 may have one or more film portions 47. Film portions 47 may be transparent to form one or more windows through drape 42, while maintaining a sterile barrier. Film portion 96 may be between distal end 43 and proximal end 44 of drape 42. In this way, film portion 47 may be disposed over a portion of surgery table 200 (FIG. 1), such as a portion of platform 220 (FIG. 1), such as over one or more traction controls 280 (FIG. 1) disposed on platform 220, which will be described further below. In this way, user 40 may view and actuate traction controls 280 through drape 42. In another example, film portion 47 may be disposed over at least a portion of table modules 340, such as foot support module 610. For example, drape 42 may include film portion 47 disposed over handle 560 to allow user 40 to articulate spar 500. Film portion 47 may be disposed over handle 560 such that user 40 may view and actuate handle 560 through drape 42.

Drape 42 may include a second film portion 47 disposed over one or more controls for positioning system 100. For example, drape 42 may be for hip surgery such that film portions are disposed at locations on drape 42 to facilitate hip surgery. As shown, positioning system 100 may include a femur hook module 820 for hip surgery. Femur hook module 820 may be visible through film portion 47 of drape 42. Drape 42 may include a femur hook module sleeve 49, or a second film portion. Femur hook module sleeve 49 may include film portion 47 such that femur hook module sleeve 49 is transparent and may allow user 40 visual access through femur hook module sleeve 49. Femur hook module sleeve 49 may be disposed over femur hook module 820 when drape 42 is deployed. Accordingly, femur hook module 820 may be visible through drape 42, and may be actuated by user 40. Femur hook module 820 will be discussed further below.

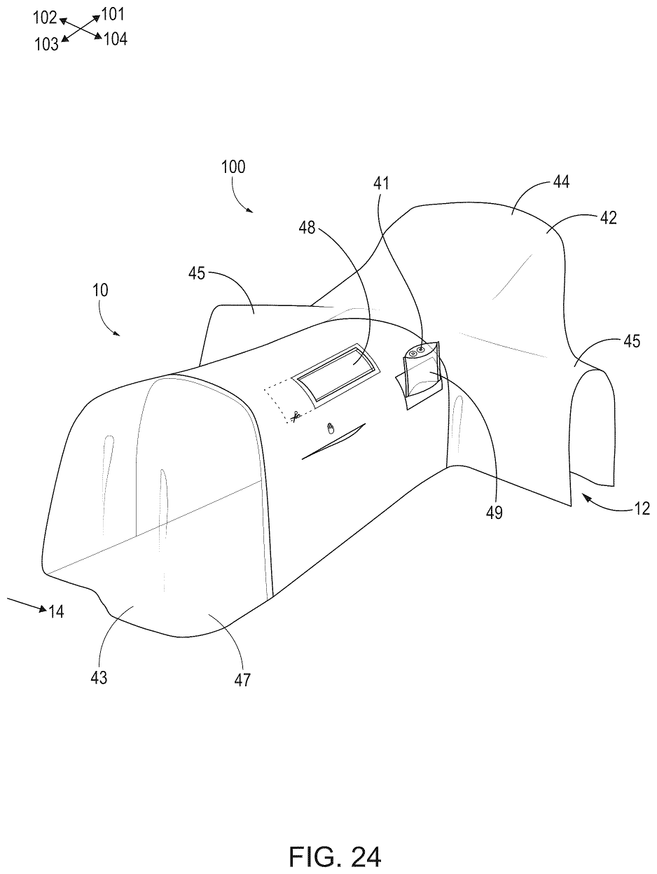

With reference to FIGS. 22-24 according to exemplary embodiments, another aspect of drape 42 for hip surgery may include a fenestration window 48, shown in FIG. 24. In addition, drape 42 may contact various parts of patient 20 and positioning system 100. For example, drape 42 may include one or more arm portions 45. Arm portions 45 may cover one or more arms 22 of patient 20 as one or more arms 22 extend laterally from patient 20. Patient 20 may be positioned such that arms 22 extend laterally to allow for direct lateral access to leg 32 without arms 22 being in the way. Without arm portions 45, arms 22 would be proximate leg 32 and therefore intermediate to leg 32 and user 40.

In addition, drape 42 may include one or more hard points 41. Hard point 41 may be made of a rubber or polymer material. Hard point 41 may be integral with drape 42. Hard points 41 may be disposed along drape 42 to allow coupling between components of positioning system 100 in sterile space 10 with components of positioning system 100 in working space 12 without breaking the sterile barrier formed by drape 42. Accordingly, hard point 41 may be a sterile interface that may allow components in sterile space 10 to remain sterile when coupling to components in working space 12. Drape 42 may be substantially similar to or identical to drapes described in U.S. Provisional Application No. 63/712,500 filed Oct. 27, 2024 titled “Drape for Use in Surgical Procedures” and U.S. patent application Ser. No. 19/370,426 filed Oct. 27, 2025 titled “Drape for Use in Surgical Procedures,” which are hereby incorporated by reference in their entireties. Hard point 41 may be substantially similar or identical to hard points described in U.S. Provisional Application No. 63/712,500.

Hard point 41 may be a sterile interface that may allow components in sterile space 10 to remain sterile when coupling to components in working space 12. For example, as shown in FIG. 22 positioning system 100 may include a bracket 832. Positioning system 100 may also include a femur hook 830. Femur hook 830 may be positioned proximate to fenestration window 48 via bracket 832. Femur hook 830 may be coupled to bracket 832. Bracket 832 may be coupled to femur hook module 820 across drape 42. Accordingly, femur hook 830 and bracket 832 may be in sterile space 10 and femur hook module 820 may be in working space 12. Bracket 832 may couple to femur hook module 820 via hard point 41. Other components in sterile space 10 may couple to hard point 41 in addition to bracket 832. In addition, drape 42 may include additional hard points 41 to receive these components. These components in sterile space 10 couple to hard points 41 that may be distinct from bracket 832 such that hard point 41 is a universal sterile interface (USI) that may couple two or more distinct components, or USI attachments 630. In other words, bracket 832 may be one of two or more USI attachments 630, each USI attachment 630 being distinct from another USI attachment 630. Bracket 832 may be a USI attachment 630. Foot support 640 may be another USI attachment 630.

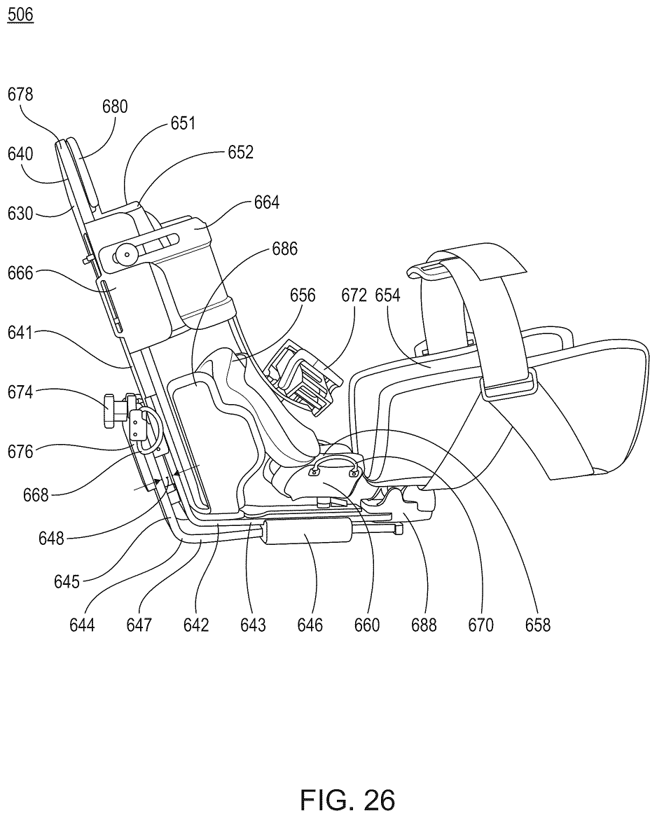

Foot support 640 is shown in FIGS. 26-29 according to exemplary embodiments. Foot support 640 may support at least one foot 36 (FIG. 18) of at least one leg 32 (FIG. 18) of patient 20 (FIG. 18). In an example, foot support 640 may be a traction boot for surgery table 200. A traction load may be applied to leg 32 of patient 20 as foot 36 is secured in foot support 640. Foot support 640 may secure foot 36 such that patient 20 experiences a level of comfort, and the risk of injury from pressure to foot 36 during traction is reduced or eliminated. In embodiments, foot support 640 may follow natural curves and motions of foot 36. In other embodiments, foot support 640 and may alternately cinch and release foot 36 when applying traction and when disengaging traction, respectively, to relieve foot 36. In other embodiments, foot support 640 may be arranged at an angle to follow the natural resting position of foot 36. Rather than about 90 degrees, foot 36 may rest at an obtuse angle relative to leg 32. Accordingly, foot support 640 may include obtuse angles along where foot 36 is received.

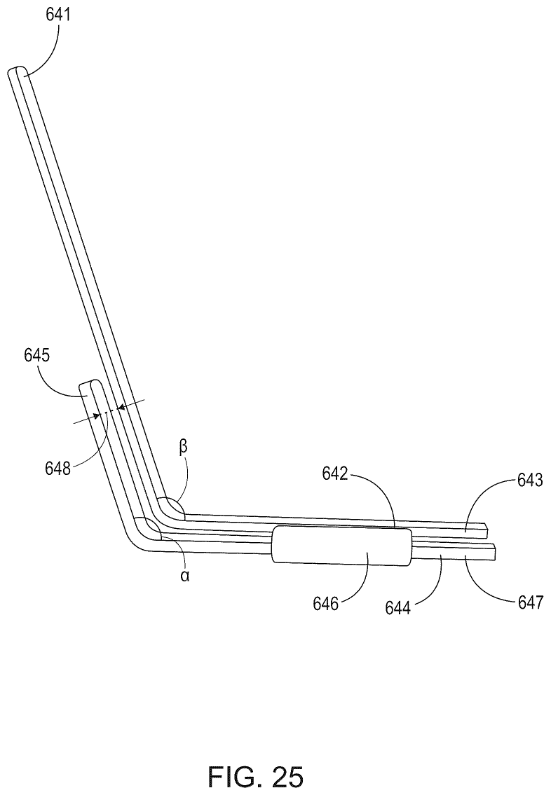

Referring to FIG. 25 according to exemplary embodiments, foot support 640 may include an inner plate 642. Inner plate 642 may include a leg portion 643. Leg portion 643 may receive at least a portion of leg 32 (FIG. 18) of patient 20 (FIG. 18). Inner plate 642 may also include a foot portion 641. Foot portion 641 may receive at least a portion of foot 36 (FIG. 18) of patient 20 (FIG. 18). As shown, leg portion 643 and foot portion 641 may be at an angle beta relative to one another. Angle beta may be an obtuse angle. In other words, inner plate 642 may not be a right-angle plate. For example, angle beta may be between about 95 degrees and about 135 degrees, such as between about 100 degrees and about 120 degrees, such as about 110 degrees.

In other embodiments, foot support 640 may include an outer plate 644. Outer plate 644 may include a leg portion 647. Leg portion 647 may receive at least a portion of leg 32 (FIG. 18) of patient 20 (FIG. 18). Inner plate 642 may also include a foot portion 645. Foot portion 645 may receive at least a portion of foot 36 (FIG. 18) of patient 20 (FIG. 18). As shown, leg portion 647 and foot portion 645 may be at an angle alpha relative to one another. Angle alpha may be an obtuse angle. In other words, outer plate 644 may not be a right-angle plate. For example, angle alpha may be between about 95 degrees and about 135 degrees, such as between about 100 degrees and about 120 degrees, such as about 110 degrees. In one embodiment, angle beta may correspond generally to angle alpha, and in other embodiments the angles are the same.

In an embodiment, outer plate 644 may be proximal to inner plate 642. Outer plate 644 may be coupled to inner plate 642. For example, inner plate 642 and outer plate 644 may be coupled to one another by a bushing 646. Bushing 646 may couple outer plate 644 and inner plate 642 such that outer plate 644 and inner plate 642 may be movable relative to one another. For example, outer plate 644 may slide relative to inner plate 642. In other words, outer plate 644 may be pushed such that outer plate 644 is moved, or slid, in inferior direction 103 (FIG. 1) as inner plate 642 may remain generally stationary. In embodiments, a traction load being applied may push outer plate 644 away from inner plate 642 to create or increase a gap 648 between outer plate 644 and inner plate 642. Traction being released, reduced, or disengaged, may allow outer plate 644 to slide in superior direction 101 (FIG. 1). Accordingly, traction being released, reduced, or disengaged, may reduce or eliminate gap 648 as outer plate 644 is no longer pushed away from inner plate 642, or at least not to the same extent. Therefore, gap 648 may increase or decrease as a function of the traction load.

Outer plate 644 may be fixedly but removably coupled to spar 500 (FIG. 1). Accordingly, as spar 500 moves, outer plate 644 may move. Inner plate 642 may not be coupled fixedly to spar 500. Instead, inner plate 642 may be coupled to the anatomy, or patient 20 (FIG. 18). Inner plate 642 may be coupled to outer plate 644, and therefore spar 500, such that inner plate 642 does not move with outer plate 644 and spar 500. Rather, outer plate 644 and spar 500 may move relative to inner plate 642. In embodiments, inner plate 642 may be coupled to and to outer plate 644 by bushing 646 and cinch strap 662. Accordingly, traction being applied by surgery table 200 (FIG. 1), which may cause base 400 (FIG. 1) to translate a distance from proximal end 204 (FIG. 1) to distal end 202 (FIG. 1) of surgery table 200, may cause spar 500 to translate in inferior direction 103 (FIG. 1), and therefore outer plate 644, which is coupled to spar 500, to translate in inferior direction 103. Inner plate 642 may not be translated in inferior direction 103 as inner plate 642, or may not be translated as far in the inferior direction 103 as outer plate 644, because inner plate 642 is not fixedly coupled to spar 500. Inner plate 642 may be coupled directly to foot 36 (FIG. 19) and leg 32 (FIG. 19) of patient 20. As will be discussed below, outer plate 644 and inner plate 642 may be dynamically coupled, and movement of inner plate 642 in the inferior direction 103 may require movement of anatomy of patient 20.

Outer plate 644 and inner plate 642 may be generally rigid. In addition, outer plate 644 and inner plate 642 may be substantially radiolucent and/or radio-uniform. Alternatively, outer plate 644 and inner plate 642 may be mostly or entirely radiolucent and/or radio-uniform. For example, outer plate 644 and inner plate 642 may consist essentially of carbon fiber. In other words, outer plate 644 and inner plate 642 may be composed mostly or entirely of carbon fiber. In other embodiments, outer plate 644 and inner plate 642 may comprised of metal, for example steel or aluminum.

Referring to the embodiments of FIGS. 26-29 according to exemplary embodiments, foot support 640 may include one or more components to secure foot 36 to foot support 640. These components may be non-metal and radiolucent. These components may be non-rigid. One or more of the non-rigid components may be cinched, or tightened around, foot 36 to push or influence foot 36 into foot support 640 and away from a torso 26 (FIG. 19) of patient 20. Foot 36 may be cinched to apply traction to leg 32 as outer plate 644 is pushed in inferior direction 103 (FIG. 1) and inner plate 642 may remain generally stationary unless and until anatomy of patient 20 is moved by the traction. In this way, leg 32 may be pulled and/or stretched to apply traction.

Foot support 640 may include one or more binding straps 651. Binding straps 651 may secure foot 32 proximate to foot support 640. In other words, binding straps 651 may retain foot 36 so that foot 36 may be pushed towards or influenced towards foot support 640. Foot support 640 may include a first binding strap 652. First binding strap 652 may secure at least a portion of foot 36 of patient 20 such as a portion including a metatarsal region of foot 36. In addition, first binding strap 652 may secure foot 36 as foot support 640 is rotated by laterally containing an upper region, such as a toe region and/or ball of foot, of foot 36 as foot 36 is rotated. In other words, as foot 36 attempts to rotate, the ball of foot 36 may be pressed against a portion of foot support 640 to prevent such rotation. Foot support 640 may also include a second binding strap 654. Second binding strap 654 may secure at least a portion of leg 34 such as a portion comprising a portion of a calf region of leg 34.

In embodiments, foot support 640 may include an upper pad 656. Upper pad 656 may contact foot 36, such as a top 38 of foot 36. In embodiments, upper pad 656 may contact least a portion of the curvature between the foot 36 and leg 32 when the foot 36 is flexed at angle beta, and upper pad 656 may follow or conform to such curvature.

In embodiments, foot support 640 may include a lower pad 658. Lower pad 658 may contact a back 39 of foot 36. Back 39 of foot 36 may include a location where an Achilles tendon of foot 36 is generally located, and between a heel and a calf of patient 20, where foot 36 is flexed at an angle, and lower pad 658 may follow or conform to such curvature. Lower pad 658 may include one or more sides 660, as shown. In embodiments, one or more sides 660 may contact foot 36 at least partially above the malleolus.

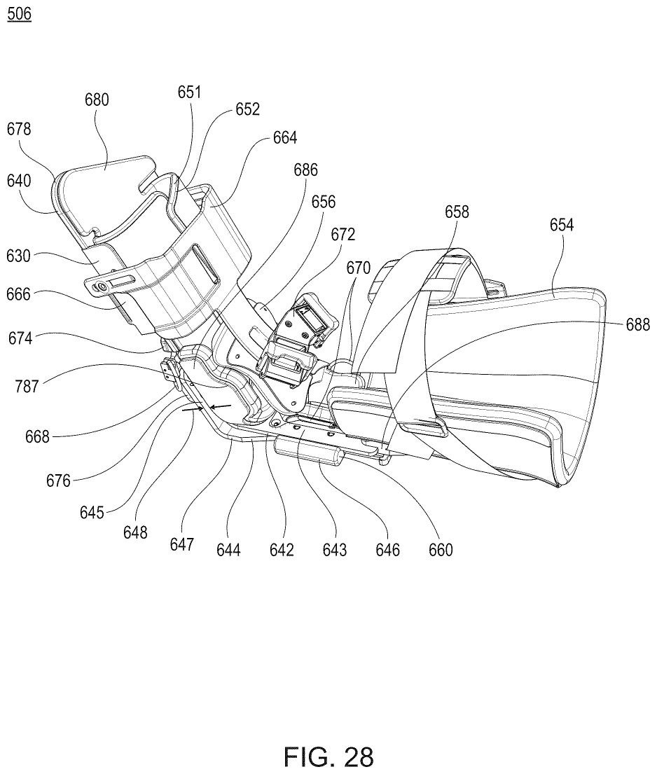

In embodiments, foot support 640 may include a plate liner 678 disposed against inner plate 642. Plate liner 678 may extend beyond foot portion 741 of inner plate 642, such as above and laterally beyond foot portion 741. Foot support 640 may also include a pad liner 680 disposed against plate liner 678. Pad liner 680 may extend beyond foot portion 741 of inner plate 642, such as above and laterally beyond foot portion 741. Pad liner 680 may include upper pad 656. As best shown in FIG. 28, upper pad 656 may extend from pad liner 680.

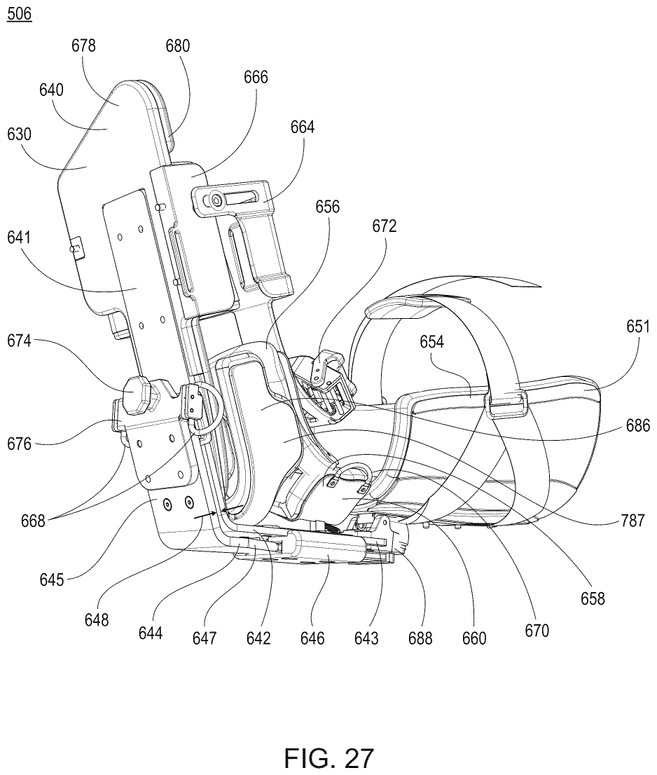

In some embodiments, plate liner 678 and pad liner 680 may be coupled together via one or more components. As shown, foot support 640 may include a clamp 664. Clamp 664 may be coupled to plate liner 678 and pad liner 680. For example, as best shown in FIG. 27, foot support 640 may include a side bracket 666. Side bracket 666 may be secured via one or more fasteners, e.g., a screw, adhesive, or a hook and loop fastener, to plate liner 678. Side bracket 666 may also be secured via one or more fasteners, e.g., a screw, adhesive, or a hook and loop fastener, to upper pad 656. Clamp 664 may be secured via one or more fasteners, e.g., a screw, adhesive, or a hook and loop fastener, to side bracket 666 with upper pad 656 disposed between plate liner 678 and clamp 664. Clamp 664 may also be coupled to a buckle 672 disposed over lower pad 658. Clamp 664 may secure foot 36 to limit or prevent supination and pronation as foot 36 is pushed into foot support 640 and/or rotated as discussed below. Clamp 664 may also raise lower pad 658 to facilitate insertion of foot 36 while being secured to inner plate 642 at foot portion 641 such that clamp 664 is pre-deployed and may be raised relative to inner plate 642 at foot portion 641. Buckle 672 and lower pad 658 may be raised together to facilitate insertion of foot 36, as in a clamshell or garage door opening motion by rotating about a hinge at the front portion of buckle 672 and lower pad 658. User 40 (FIG. 23) may insert foot 36 with one hand while the other hand palpates the anatomy. Once the foot 36 is inserted into foot portion 641, buckle 672 and lower pad 658 may be lowered into contact with foot 36 and secured, closing the clamshell or garage door.

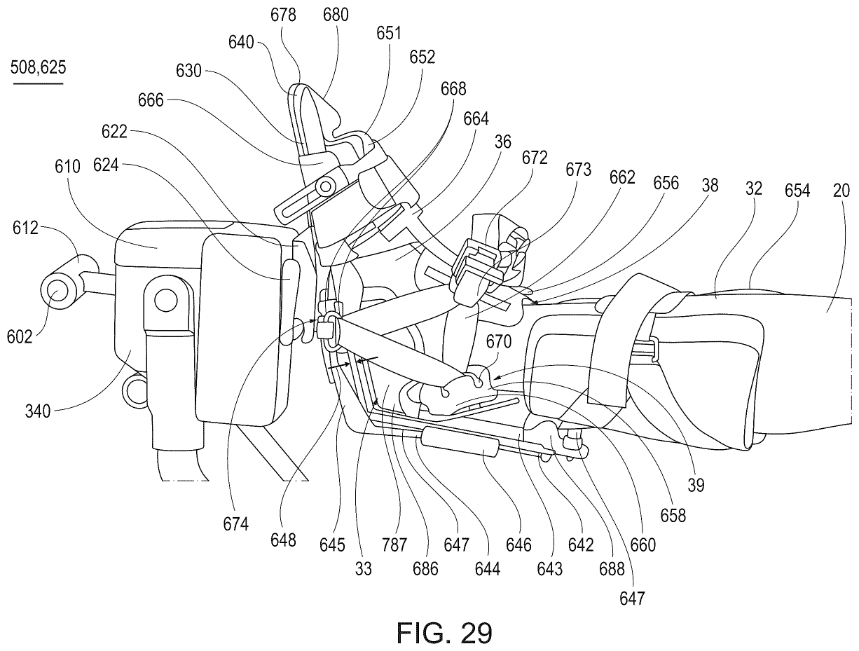

One or more components of foot support 640 may cinch, or tighten around, foot 36 when outer plate 644 is pushed in inferior direction 103 (FIG. 1). With reference to FIG. 29, foot support 640 may include a cinch strap 662 according to exemplary embodiments. Cinch strap 662 may couple to one or more components of foot support 640 to cinch foot 36 as traction is applied. For example, cinch strap 662 may form a closed loop that is coupled to components of foot support 640 and to outer plate 644 and inner plate 642. Accordingly, only one cinch strap 662 may be required to cinch foot 36. Additionally, as outer plate 644 is slid relative to inner plate 642 in inferior direction 103, cinch strap 662 may be cinched, or tightened around, foot support 640 and therefore foot 36. In one embodiment, cinch strap 662 may include an elastic material. In another embodiment, cinch strap 62 may be substantially inelastic such that cinch strap 662 may not stretch. Cinch strap 662 may cinch, or tighten, by being pulled in inferior direction 103 (FIG. 1) by outer plate 644. Cinch strap 662 may be pulled in inferior direction 103, as outer plate 644, to which cinch strap 662 is coupled, is pushed in inferior direction 103. In other words, as outer plate 644 is pushed in inferior direction 103, outer plate 644 may pull cinch strap 662 in inferior direction 103 as cinch strap 662 is coupled to outer plate 644.

As shown in FIG. 29, foot support 640 may include one or more one or more first links 668 coupled to outer plate 644. Each of one or more first links 668 may be a loop with an opening through which cinch strap 662 may be threaded. One or more first links 668 may be generally D-shaped. Foot support 640 may include one or more second links 670 coupled to lower pad 658. Each of one or more second links 670 may be a loop with an opening through which cinch strap 662 may be threaded. One or more second links 670 may be generally D-shaped. Foot support 640 may include one or more third links 673 coupled to buckle 672. Each of one or more third links 673 may be a loop with an opening through which cinch strap 662 may be threaded. One or more third links 673 may be generally D-shaped. Foot 32 and foot support 640 are shown from lateral direction 104 (FIG. 1) in FIG. 28. The opposing side of foot support 640 viewed from medial direction 102 (FIG. 1) may include another one or more first links 668 coupled to outer plate 644. Similarly, the opposing side of foot support 640 viewed from medial direction 102 may include another one or more second links 670 coupled to lower pad 658. Similarly, the opposing side of foot support 640 viewed from medial direction 102 may include another one or more third links 673 coupled to buckle 672.

Cinch strap 662 may be secured through one or more first links 668, one or more second links 670, and one or more third links 673. In other words, cinch strap 662 may be coupled to outer plate 644 and may be secured around lower pad 658 to buckle 672. Cinch strap 662 may form a closed loop around foot support 640 where cinch strap 662 is wrapped around inner plate 642 and also coupled to outer plate 644 and buckle 672 through one or more first links 668, one or more second links 670, and one or more third links 673. Cinch strap 662 may be cinched, or tightened, or pulled in inferior direction 103 (FIG. 1), to secure lower pad 658 and inner plate 642 to the at least one foot 36 of patient 20 under traction, or as a traction load is applied.

In an embodiment, cinch strap 662 may be secured through two first links 668 disposed on outer plate 644. Two passes of cinch strap 662 may route between buckle 672 and first links 668 with one end wrapping around inner plate 642 and the other end routing to second link 670 disposed on lower pad 658 and then routing to third link 673 disposed on buckle 672. Via first links 668, cinch strap 662 may be anchored to inner plate 642. Via third links 673, cinch strap 662 may be anchored to buckle 672. Tensioning of cinch strap 662 may occur therefore around inner plate 642 and through buckle 672.

Cinch strap 662 may be secured through both first links 668 to third link 673 to pull upper pad 656 into foot 36. Cinch strap 662 may be secured through both first links 668 to second link 670 to pull lower pad 658 into foot 36. Cinch strap 662 may be secured from first links 668 to both second link 670 and third link 673 to pull foot 36 into inner plate 642. Cinch strap 662 may also be secured through second link 670 to third link 673 to pull upper pad 656 and lower pad 658 into foot 36 toward one another. Cinch strap 662 may be secured through first links 668, second link 760, and buckle 672 to form essentially a triangle shape, such as an equilateral shape to generally equally pull upper pad 656 and lower pad 658 into inner plate 642 and toward one another.

Referring still to FIG. 29, in one embodiment, cinch strap 662 may be coupled through first link 668, and a first portion of cinch strap 662 may proceed to second link 670, and from second link 670 through third link 673 to buckle 672. Buckle 672 may secure a first end of cinch strap 662 in order to, for example, take up slack in the cinch strap 662 before applying tension. The first end of the cinch strap 662 may be an end of the cinch strap 662, or it may be a portion of a continuous loop cinch strap 662. A second portion of cinch strap 662 may proceed from first link 668 to third link 673, and double back over third link 673 and then around a bottom of inner plate 642 to the opposite side, which is in between inner plate 642 and outer plate 644, and then may proceed on the opposite side of the foot plate up to third link 673 on the opposite side, then is doubled back over third link 673 on the opposite side to first link 668 on the opposite side, and then from first link 668 on the opposite side to second link 670 on the opposite side, and then through third link 673 on the opposite side to the opposite side of buckle 672. Opposite side of buckle 672 may secure a second end of cinch strap 662 in order to, for example, take up slack in the cinch strap 662 before applying tension. The second end of the cinch strap 662 may be an end of the cinch strap 662, or it may be a portion of a continuous loop cinch strap 662.

Lower pad 658 and upper pad 656 coupled to lower pad 658 by clamp 664 may support natural curves of foot 36. Due to curves along foot 36, lower pad 658 and upper pad 656 may rest in curves along foot 36. For example, upper pad 656 may rest in a joint between top 38 of at least one foot 36 and at least one leg 32 of patient 20. Lower pad 658 may rest in a joint between at least one heel 33 and at least one leg 32 of patient 20. In this way, as cinch strap 662 is cinched, or tightened, or pulled in inferior direction 103 (FIG. 1), lower pad 658 may hug a curved surface of foot 36 proximate to lower pad 658. Similarly, upper pad 656 being coupled to lower pad 658 may hug a curved surface of foot 36 proximate to upper pad 656. Upper pad 656 and lower pad 658 are pulled tangentially down toward centers of each to minimize shear and position upper pad 656 and lower pad 658 at lowest points of foot 36 anatomy. Accordingly, upper pad 656 may be pulled in and down over top 38 of foot 36. Lower pad 658 may be pulled in and down over top 38 of foot 36. Heel cup 686 be pulled forward and into the Achilles/heel portion of foot 36. Together, upper pad 657, lower pad 658, and heel cup 686 press foot 36 into inner plate 642. As discussed, foot 36 may be at an obtuse angle relative to leg 32 because of the orientation of foot support 640, such as inner plate 642 and outer plate 644. The angle of foot support 640 may facilitate hugging of curves of foot 36. For example, the curve between heel 33 and leg 32 in which lower pad 658 rests may not be prominent if foot 36 is positioned at 90 degrees. Hugging curves of foot 36 may allow for greater traction control. Accordingly, the force vector of cinch strap 662, upper pad 656, and lower pad 658, may be generally in the direction of traction.

As discussed, outer plate 644 may slide relative to inner plate 642. Gap 648 may be adjusted accordingly. Outer plate 644 may move in inferior direction 103 (FIG. 1). Cinch strap 662 may be cinched, or tightened, or pulled in inferior direction 103, as outer plate 644 is pushed outwardly in inferior direction 103 away from inner plate 642 as cinch strap 662 is coupled to outer plate 644 via one or more first links 668. A traction load being applied may push outer plate 644 away from inner plate 642 to create gap 648 between outer plate 644 and inner plate 642. Gap 648 may increase as outer plate 644 is pushed away from inner plate 642, such as when traction mechanism 270 (FIG. 17) translates spar base 400 (FIG. 1) along surgery table 200 (FIG. 1) such that foot 36 is cinched by cinch strap 662 and therefore a traction load is applied to at least one leg 32 of patient 20. Gap 648 may be reduced or eliminated when the traction load is reduced or no longer applied.

Referring still to FIG. 29, gap 648 may be increased by a distance that is larger than a length of cinch strap 662 that is pulled as traction is applied. In other words, a length of cinch strap 662 that is pulled as outer plate 644 is pushed away from inner plate 642 is smaller than the size of gap 648. In an example gap 648 may increase by a distance X. A length of cinch strap 662 at any given portion may be increased by a length Y. Y may be smaller than X. This is because there is compliance in parts of patient 20, such as foot 36, leg 32, and portions thereof, and from cinch strap 662 itself, which may be elastic. Therefore, cinch strap 662 may lengthen to a lesser extent than the increase in gap 648.

As traction is alternately applied and released, or disengaged, foot support 640 may “breathe.” In other words, foot support 640 may alternately cinch, or tighten around, and release foot 36 as a function of traction. In this way, foot 36 is not cinched for the duration of a surgery necessarily, including when traction is not applied. Rather, traction may be selectively applied and released and foot 36 is cinched or released accordingly. Releasing foot 36 during a surgery may lower pressure on foot 36 and reduce or eliminate related health risks as foot 36 is not constantly “squeezed” by being cinched. By “breathing,” e.g., only cinching foot 36 when traction is needed (and not during the entire surgery) engagement of foot 36 is safer. In other words, securing foot 36 to foot support 640 is less constrictive and less intrusive over a shorter period of time.

Outer plate 644 may move relative to inner plate 642 to facilitate “breathing.” For example, outer plate 644 sliding in inferior direction 103 (FIG. 1) as traction is applied may increase gap 648 between outer plate 644 and inner plate 642 as inner plate 642 may remain generally stationary as traction is applied. Cinch strap 662 may cinch, or tighten around, foot 36 as traction is applied. When traction is released, or disengaged, outer plate 644 may slide in superior direction 101 (FIG. 1) such that gap 648 is decreased. Cinch strap 662 may release foot 36 such that foot 36 is not cinched or “squeezed.” The increase and decrease of gap 648 and cinching and releasing of foot 36 such that foot 36 is alternately “squeezed” and released is the “breathing” aspect of foot support 640. In other words, foot support 640 may allow foot 36 to “breathe.”

Foot support 640 may also include one or more features to limit or prevent rotation of foot 36 seated in foot support 640. In this way, foot support 640 may limit or prevent pronation and supination at foot 36. Thus, any rotation may be isolated to leg 34, which may be rotated during hip surgery. Clamp 664 may secure foot 36 to limit or prevent supination and pronation as foot 36 is pushed into foot support 640 and/or rotated. Lower pad 658 may also limit or prevent supination and pronation. A heel cup 686 may also limit or prevent supination and pronation. First binding strap 652 may also support foot 36 laterally to prevent foot 36 from being unseated.

As discussed, cinch strap 662 may cinch, or tighten around, foot 36 as traction is applied. Accordingly, as cinch strap 662 is routed from the third link 673 on one side, under the inner foot plate 642, and then to third link 673 on the opposite side, foot 36 may be pushed/pulled into foot support 640 as cinch strap 662 is pulled, such that foot 36 is fully seated in foot support 640. As shown in FIGS. 26-29, foot support 630 may include a heel cup 686. Heel cup 686 may be proximate to heel 33 of patient 20 when foot 36 is seated in foot support 640. Accordingly, heel cup 686 may be an anchor for heel 33. In this way, heel 33 may be supported and secured in a structure configured for heel 33. Heel cup 686 may include one or more sides 787. Sides 787 may extend around sides of foot 36 proximate to heel 33. For example, sides 787 may extend above the malleolus (not shown) of foot 36.

Cinch strap 662 may be routed through the various components in order to achieve the objectives as described, but in a different order or configuration, as understood by one of ordinary skill in the art. In other words, in certain embodiments, cinch strap 662 may be routed through upper pad 656, lower pad 658, and outer plate 644 in any order so long as foot 36 is pressed against inner plate 642, upper pad 654 is pressed against the top of foot 36 such that the forefoot is pulled down, and lower pad 658 is pressed against sides of foot 36 such that the Achilles/heel portion of foot 36 is pulled back.

Foot support 640 may also provide visualization of foot 36. Components of foot support 640, such as binding straps 651, upper pad 656, lower pad 658, and cinch strap 662 may be positioned to allow user 40 (FIG. 23) to view foot 36. For example, the malleolus (not shown), or the location of the malleolus through a surgical sock, may be visible through foot support 640. In other words, components of foot support 640 may be positioned to reveal the malleolus. In this way, user 40 may be able to monitor foot 36 and limit or prevent injury from traction being applied by having visual access to foot 36.

Foot support 640 may couple to one or more table modules 340. As shown in FIG. 29, foot support 640 may couple to foot support module 610. Foot support module 610 may include a USI port 626 to receive one or more USI attachments 630. Thus, foot support 640 may be a USI attachment 630. Foot support module 610 may include a USI port 626 that may receive a USI plug 674 of a USI attachment 630. Foot support 640 may include at least one USI plug 674. As shown, outer plate 644 may include USI plug 674. USI plug 674 may be coupled to outer plate 644 via a USI plug plate 676 that is fastened to outer plate 644 such as with screws, adhesive, or a hook and loop fastener.

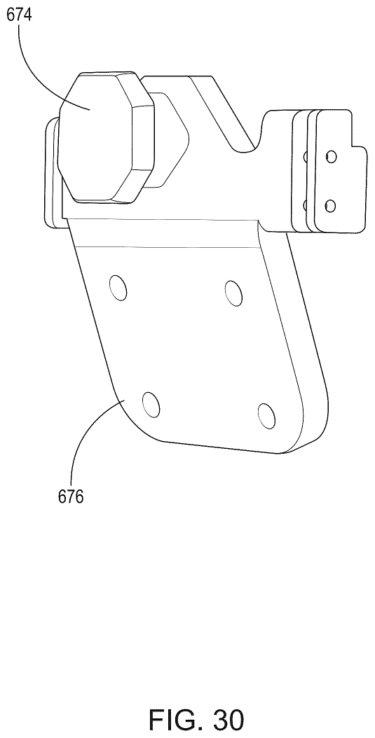

Foot support 640, and other medical tools may be locked into USI port 626 via a USI lock 624. In a first position 625 (FIGS. 29-30), foot support 640 or another medical tool may not be locked, or secured in table module 340. In a third position 627 (not shown), USI lock 624 may be actuated about 90 degrees from first position 625. In third position 627, a drape may separate foot support 640 or another medical tool from USI port 626. In a second position 626 (not shown), foot support 640 may be secured in USI port 626 without a drape therebetween. In second position 626, USI lock 624 may be actuated to a position between the position of USI lock 624 in first position 625 and third position 627. USI lock 624 is further described by lock 420 in U.S. patent application Ser. No. 19/370,426 filed Oct. 27, 2025 titled “Drape for Use in Surgical Procedures,” which is hereby incorporated by reference in its entirety.

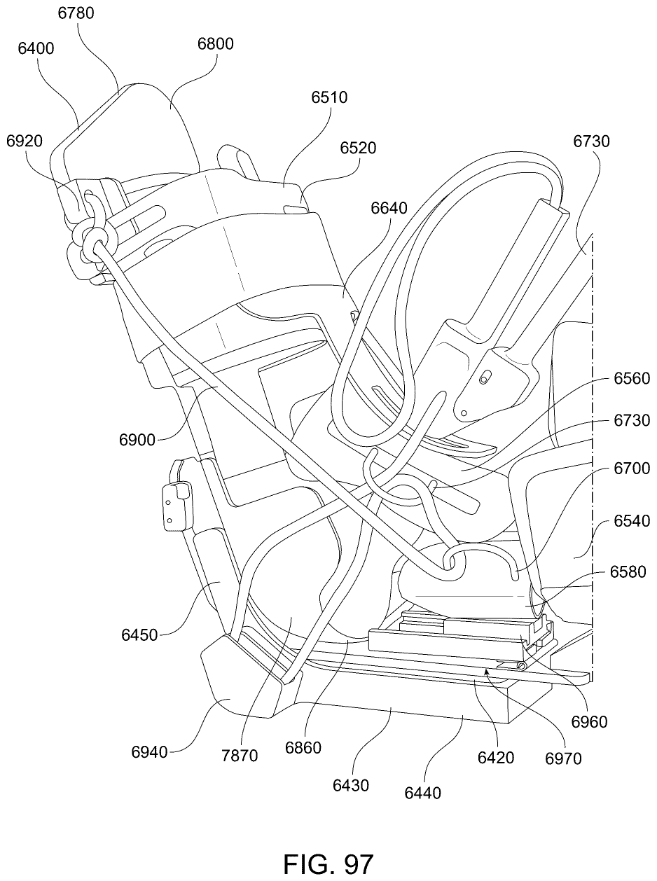

With reference to FIG. 97, a foot support 6400 is shown. Foot support 6400 may include any of the features of foot support 640 (FIG. 29) discussed above and vice versa. Instead of a strap, foot support 6400 may include a cord 6900. Cord 6900 may include a rounded cross section to facilitate the cinching discussed above. Cord 6900 may also include a small weave to reduce friction. Accordingly, cord 6900 may be dynamically routed to facilitate smooth sliding.

Instead of a bushing coupling inner plate 6420 and outer plate 6440, inner plate 6420 may slide along a bearing surface of outer plate 6440. As shown, outer plate 6400 may include a receptacle 6970 with roller bearings via which inner plate 6420 may slide. Inner plate 6420 may include a slider 6960 to slide along the bearing surface. Inner plate 6420 may be slideable about one inch. The bearing surface may accommodate motion without inner plate 5420 running out of travel space. A bumper 6470 (not shown) may manage inner plate 6420 travel and prevent inner plate 6420 from traveling farther than allowed by cord 6900. Slider 6960 may be made of plastic, such as polyurethane.

Foot support 6400 may include a similar routing for cord 6900 as discussed for foot support 640. Accordingly, upper pad 6560 and lower pad 6580 are pulled tangentially down toward centers of each to minimize shear and position upper pad 6560 and lower pad 6580 at lowest points of foot 36 (FIG. 20) anatomy. Upper pad 6560 may be pulled in and down over top 38 of foot 36. Lower pad 6580 may be pulled in and down over top 38 of foot 36. Heel cup 6860 be pulled forward and into the Achilles/heel portion of foot 36. Together, upper pad 6570, lower pad 6580, and heel cup 6860 press foot 36 into inner plate 6420.

Routing of cord 6900 may manage peak and average pressures to avoid over-cinching. As shown, cord 6900 may be coupled to an inner plate anchor 6920 of inner plate 6420 proximate to first binding strap 6520 after routing through lower pad 6580. Cord 6900 may extend to inner plate anchor 6920 only on one side of inner plate 6420. Accordingly, cord 6900 may route around foot support 6400 asymmetrically, which may provide rotational stability to resist applied torque. In particular, the toe region of foot 36 (FIG. 20) may remain static and pushes against first binding strap 6520 while the heel portion rotates, however, foot 36 remains seated in foot support 6400. As with foot support 640 (FIG. 29) discussed above, cord 6900 may be routed to avoid contact with anatomy.

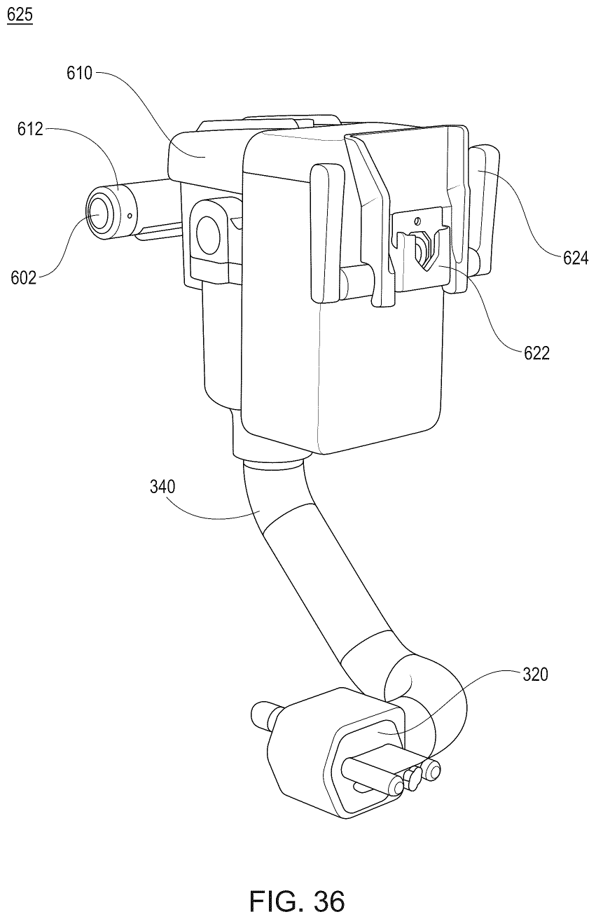

USI plug 674 is shown in FIG. 30 according to exemplary embodiments. USI plug 674 may couple to USI port 626 (FIG. 36) of table module 340 (FIG. 36). USI port 626 may receive two or more distinct USI attachments 630 (FIG. 29). In this way, USI port 626 may be universal. Drape 42 (FIG. 22) may include hard point 41 to facilitate coupling of USI attachments 630 to USI ports 722. Accordingly, USI plug 674 coupling to USI port 626 may form a universal sterile interface, as drape 42 may form a sterile barrier. USI attachments 630 may include one or more USI plugs 674.

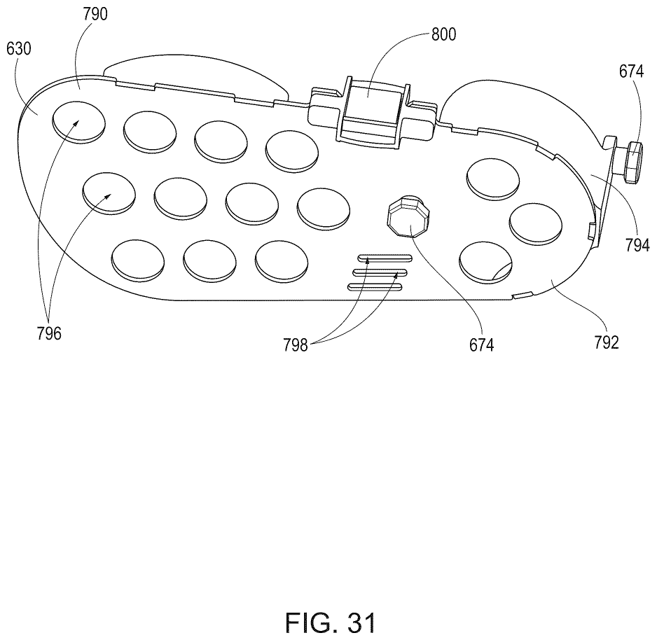

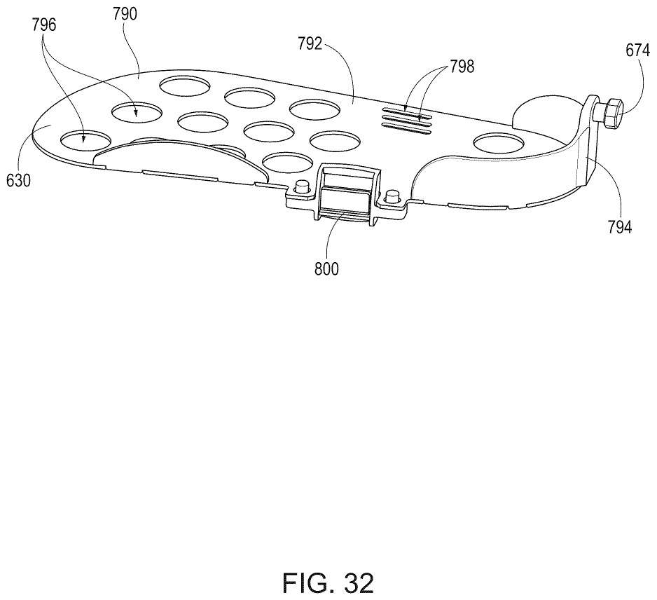

Other USI attachments 630 (FIG. 29) are described herein. A foot support 790 is shown in FIGS. 31-35 according to exemplary embodiments. Foot support 790 may support at least one foot 36 of at least one leg 32 of patient 20. Foot support 790 may be a USI attachment 630. Accordingly, foot support 790 may include one or more USI plugs 674 that may couple to USI ports 722 of table modules 340 (FIG. 29). For example, foot support 790 may couple to foot support module 610 (FIG. 29). Accordingly, foot support 790 may be coupled to spar 500 (FIG. 1) as foot support module 610 may be coupled to spar 500. Referring to FIGS. 29 and 31, USI attachments 630 may include foot support 640 and foot support 790. Foot support 640 and foot support 790 may interchangeably couple to foot support module 610. Foot support 640 may be used for hip surgeries. Foot support 790 may be used for surgeries involving trauma. Other table modules 340 that may receive foot support 790 include robotic arms (not shown) that may include one or more USI ports 626 to couple to one or more USI plugs 674 of foot support 790.

As discussed, drape 42 (FIG. 22) may include one or more hard points 41 to couple USI plugs 674 to USI ports 626. Hard points 41 may be disposed in USI ports 626 and may receive USI plugs 674 to couple USI ports 626 to USI plugs 674. Drape 42 may include a first hard point 41 to couple USI plug 674 of foot support 640 to foot support module 610. Drape 42 may include a second hard point 41 to couple one or more USI plugs 674 of foot support 790 to foot support module 610. Accordingly, USI plug 674 coupling to USI port 626 through hard points 41 may form a universal sterile interface between foot support 640 and foot support module 610, or between foot support 790 and foot support module 651, as drape 42 having hard points 41 may form a sterile barrier.

Referring to FIGS. 31-35, foot support 790 may include a foot portion 792 and a heel portion 794. Foot portion 792 may be proximate foot 36 of patient 20 when foot 36 is secured in foot support 790. Heel portion 794 may be proximate heel 33 of patient 20 when foot 36 is secured in foot support 790. Heel portion 794 may act as a short stop for heel 33 to position foot 36 against foot portion 792. Foot portion 792 may include one or more openings 796. Additionally or alternatively, foot portion 792 may include one or more slits 798. Openings 796 and slits 798 may be distinct from one another. For example, openings 796 may be generally circular. Slits 798 may be generally rectangular. Foot portion 792 may also include a buckle 800, which will be described further below.

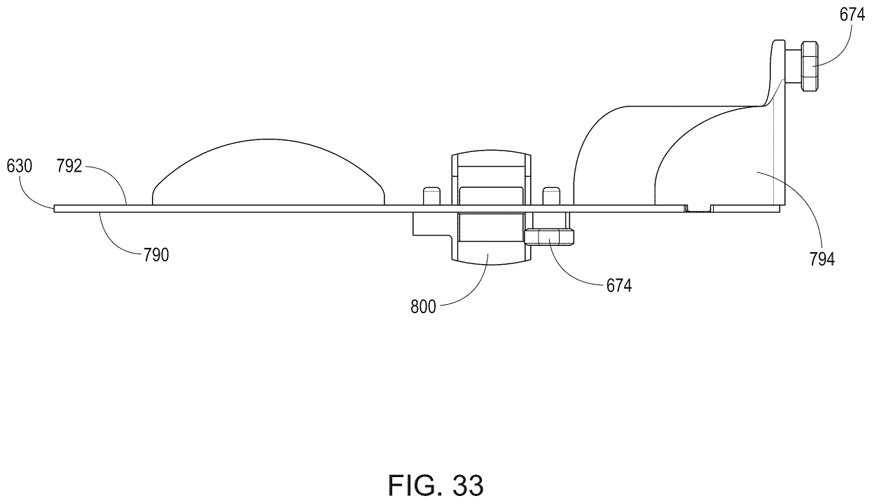

As shown in FIGS. 31-33, foot support 790 may include one or more USI plugs 674. Foot portion 792, heel portion 794, or foot portion 792 and heel portion 794 may include one or more USI plugs 674. For example, foot portion 792 may include one or more USI plugs 674. USI plugs 674 of heel portion 794 may be used to couple to table module 340 (FIG. 29) having USI port 626 (FIG. 29) when leg 32 is extended, or straight. Additionally or alternatively, heel portion 794 may include one or more USI plugs 674. As shown in FIG. 33, foot portion 792 may include USI plug 674 and heel portion 794 may include USI plug 674. USI plugs 674 of foot portion 792 may be used to couple to table module 340 having USI port 626 when leg 32 is straight. USI plugs 674 of heel portion 794 may be used to couple to table module 340 having USI port 626 when leg 32 is flexed. Alternatively, a robotic arm having USI port 626 may be used to couple foot support 790 via heel portion 794 when leg 32 is flexed. Other table modules 340 that may receive foot support 790 include robotic arms (not shown) that may include one or more USI ports 626 to couple to one or more USI plugs 674 of foot support 790 when leg 32 is flexed.

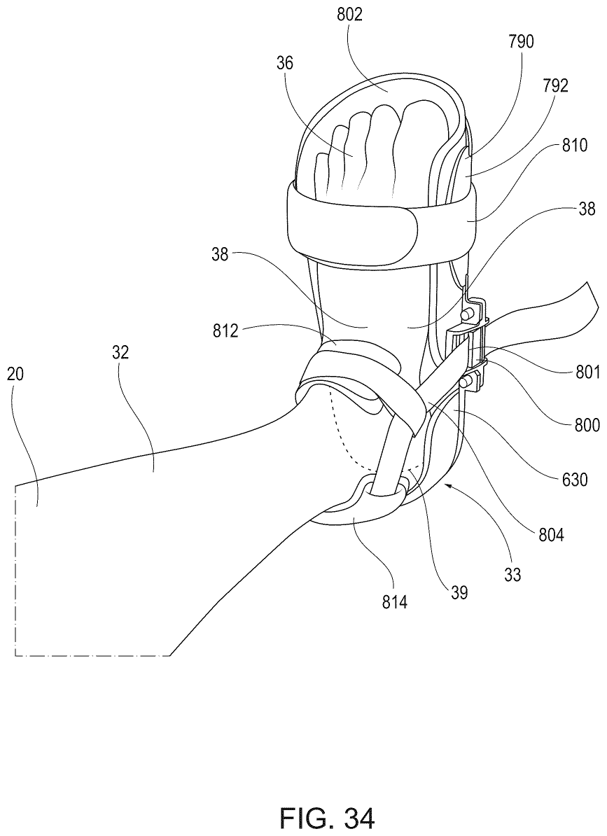

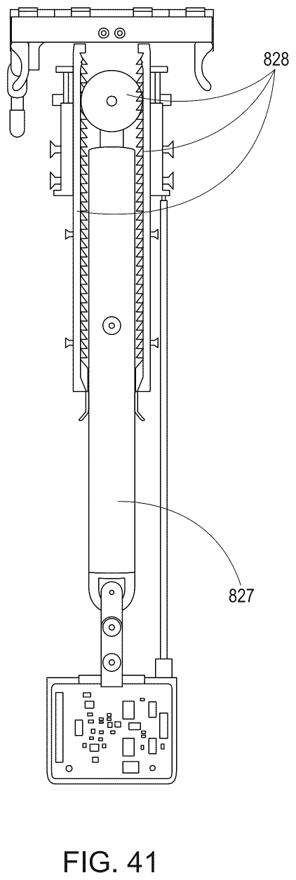

Foot support 790 may be lightweight and may provide increased access to foot 36. Foot support 790 may secure foot 36 (FIG. 34) in a way such that foot support 790 may be attached to spar 500 and support at least a portion of leg 32 (FIG. 34) of patient 20 (FIG. 34). Accordingly, foot support 790 may be suitable for use in ankle procedures and other lower limb fractures. In addition, foot support 790 may be re-sterilizable. In other words, foot support 790 may be reusable and repositionable in the sterile environment. Attachment to USI ports 626 (FIG. 29), particularly through a drape and hard point 41 (FIG. 41), may facilitate foot support 790 being detachable and reattachable in the sterile environment without breaking the sterile barrier.

With reference to the embodiment of FIG. 34, foot support 790 may include a liner 802. Foot support 790 may receive liner 802. Liner 802 may be disposable. Accordingly, liner 802 may be sterile and not reusable. Foot support 790 may also include a strap 804. Liner 802 may include strap 804. Strap 804 may be disposable. Accordingly, strap 804 may be sterile and not reusable. Strap 804 may be generally Y-shaped. Strap 804 may include an end that secures around top 38 of foot 36. Strap 804 may include another end that secures between heel 33 and leg 32. Accordingly, strap 804, when secured, may cinch, or tighten, around foot 36 to pull foot 36 into foot support 790. Strap 804 may include one or more pads along ends of strap 804. Strap 804 may include an upper pad 812 and a lower pad 814 that may rest along curves of foot 36. For example, upper pad 812 may rest along top 38 of foot 36. Lower pad 814 may rest between heel 33 and leg 32. Buckle 800 may include an opening 801 to receive strap 804. In this way, buckle 800 may secure strap 804 around foot 36. Securing strap 804 around foot 36 may include securing upper pad 812 against top 38 of foot 36 and securing lower pad 814 against foot 36 between heel 33 and leg 32.

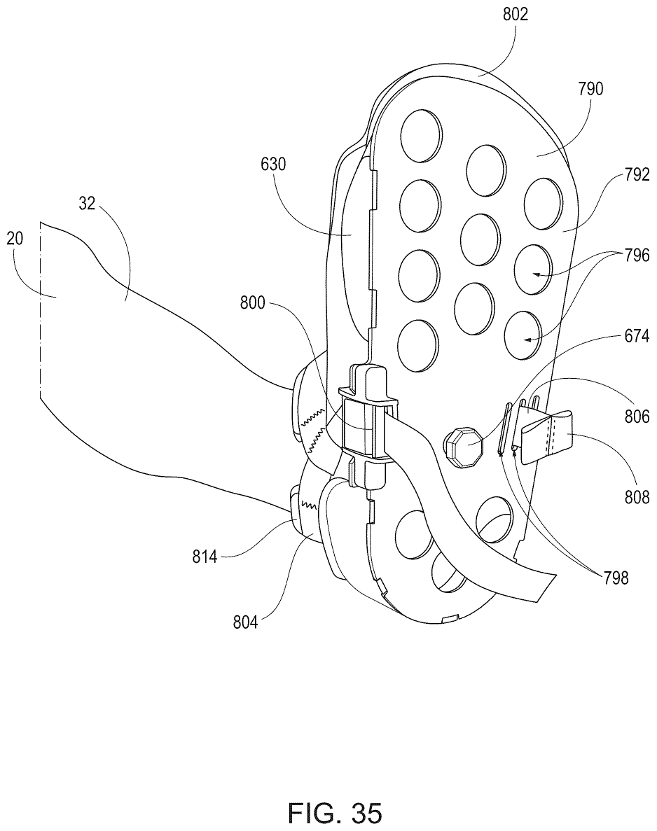

Strap 804 may be secured at one or more locations. In addition to being secured through buckle 800, strap 804 may be secured through one or more slits 798. With reference to FIG. 35, strap 804 may include a tab 806. Tab 806 may include a top edge 808. One or more slits 798 may receive tab 806. As shown in FIG. 35, top edge 808 may pass through slits 798 and may include a generally T-shape to retain strap 804 in one or more slits 798. Foot support 790 and liner 802 may be malleable such that foot support 790 and liner 802 may wrap around foot 36 of patient 20 when strap 804 is secured through foot support 790. As shown, foot support 790 may also include a retention strap 810. Retention strap 810 may secure around foot 36, foot support 790, and liner 802. Retention strap 810 may be disposable. Accordingly, retention strap 810 may be sterile and not reusable.

Retaining foot 36 in foot support 790 may allow for traction to be applied at the lower limb. Strap 804 may be similar to an ankle distractor as is known in the art to apply traction, in that strap 804 includes a portion that contacts the back of foot 36 in between the heel and the lower leg, and the front of foot 36 in between the foot and the lower leg. Like an ankle distractor, when strap 804 is pulled, the portion that contacts the back of foot 36 and the portion that contacts the front of foot 36 are pulled towards each other and away from leg 32 (FIG. 18) at the same time, which both grips the foot securely and pulls a force vector on leg 32 itself. Unlike an ankle distractor, strap 804 itself is not being pulled but strap 804 is attached to foot support 790, and traction is applied to foot support 790 by spar 500. Unlike an ankle distractor, foot support 790 can support foot 36 when traction is not being applied to foot 36/leg 32 of patient 20 (FIG. 18).

Another way of applying traction at the lower limb is through bone traction. Bone traction may include placing a wire through the femur or other leg bone of patient 20 (FIG. 18) to pull traction, the wire coupled to spar 500 (FIG. 3) via a fastening mechanism such as a clamp for spar 500, as described herein. Bone traction may be applied while leg 32 (FIG. 18) is generally straight and not flexed. Traction may be applied and/or adjusted via traction controls 280 (FIG. 1).

Various universal attachment systems are shown with reference to FIGS. 36-53 according to exemplary embodiments. In an example, universal attachment systems may be part of positioning system 100. In another example, universal attachment systems may be a part of surgery table 200. In another example, controls may function separately, such as with other positioning systems, surgery tables, or apparatuses thereof. In an example, controls may include features that are functional separately and in combination.

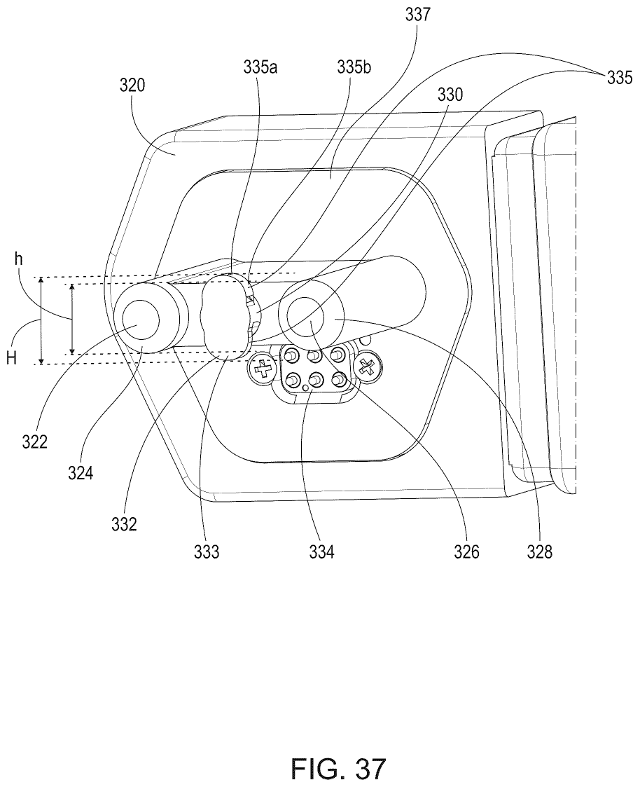

Foot support module 350 is shown in FIGS. 36-37 according to exemplary embodiments. In one embodiment, table modules 340, such as foot support module 350, may include one or more universal attachment interface (UAI) plugs 320. Referring to FIG. 37, in one embodiment, UAI plug 320 may include a “dog-bone” shape. For example, UAI plug 320 may include a first portion 322, a second portion 326, and a third portion 330 between first portion 322 and second portion 326. In some embodiments, first portion 322 and second portion 326 may be substantially spherical. In other embodiments, first portion 322 and second portion 326 may be oval, or polygonal. In an embodiment, third portion 330 may be substantially rectangular. In other embodiments, third portion 330 may include other shapes, for example, square, circular, oval, or polygonal. In certain embodiments, third portion 330 may have a height that is less than first portion 322 and/or second portion 326. Accordingly, in the embodiment shown, first portion 322, second portion 326, and third portion 330 may form a “dog-bone” shape. In embodiments where table module 340 is powered and/or communications with system 100 via a wired connection, UAI plug 320 may include an electrical plug 334.

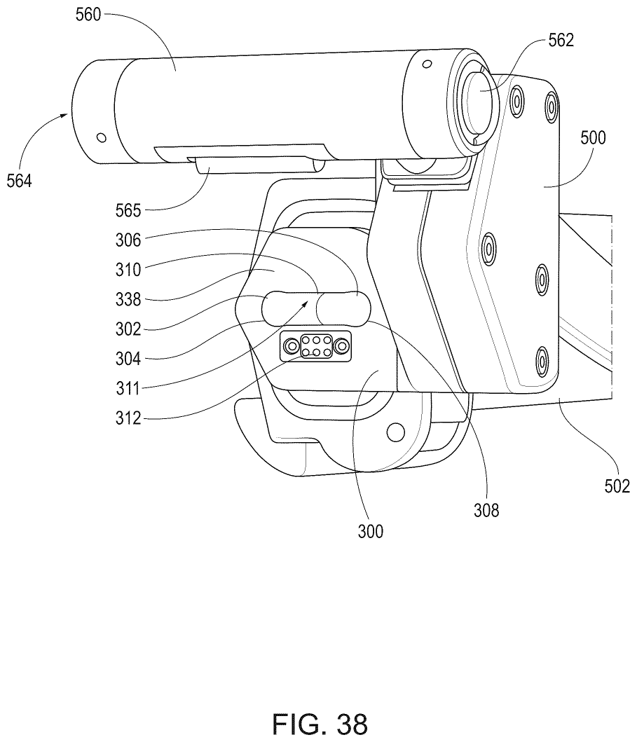

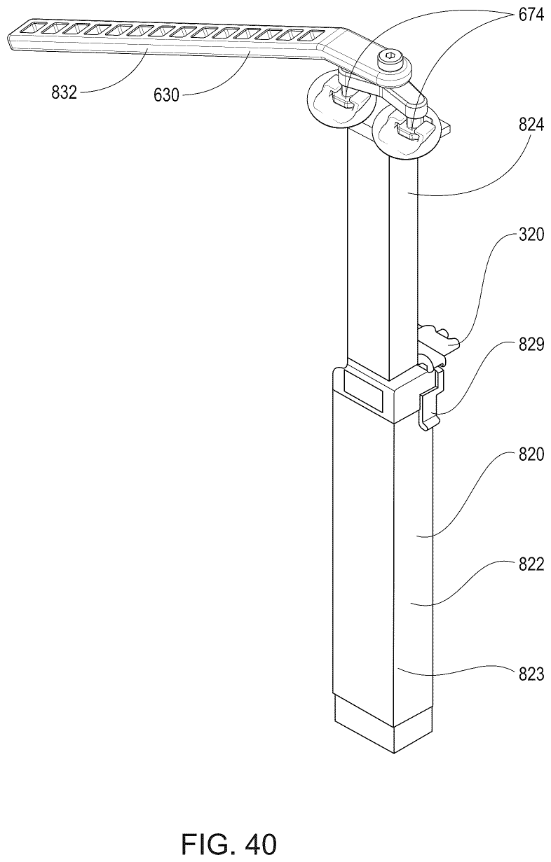

Referring still to FIG. 37, in embodiments, UAI plug 320 may include a locking portion 332. Third portion 330 may include a locking portion 334. Alternatively, locking portion 334 may extend from third portion 330. As shown in FIG. 40, locking portion 334 may be in a vertical position. Locking portion 332 may have a height and a width. In the vertical position, as shown, the height H of the locking portion 332 may be greater than height h of third portion 330. In a horizontal position, the height may be equal to or less than height h, and the width H may be less than a width of third portion 330. In other words, in a horizontal position, locking portion 332 may be sized to fit entirely within the profile of third portion 330 when viewed head-on, and when in vertical position, locking portion 332 may have a height H greater than height H of third portion 330. Locking portion 334 may be configured to rotate at least 90 degrees from a horizontal position to a vertical position to lock UAI plug 320 in UAI port 300 (FIG. 38). UAI plug 320 coupling to UAI port 300 will be discussed further below.

Positioning system 100 (FIG. 1) may include one or more UAI ports 300 as shown in FIG. 38 according to exemplary embodiments. UAI ports 300 may be universal attachments. Accordingly, UAI port 300 may alternatively receive two or more table modules 340, such as a femur hook or a robotic arm, a distractor, or foot support module 350. In other words, UAI port 300 may receive two or more table modules 340, each table module 340 being distinct from another of table modules 340. In some embodiments, UAI ports 300 may include a cutoff switch (not shown) to disengage table module 340 coupled to UAI port 300. Disengaging table module 340 may allow table module 340 to be removed from UAI port 300 and/or electrically disconnected. UAI ports 30 along positioning system 10 may be covered when not in use.

Referring to FIGS. 1 and 38, in various embodiment, surgery table 200, spar 500, or surgery table 200 and spar 500 may include one or more UAI ports 300. Distal end 502 of spar 500 may include one or more UAI ports 300. Distal end 402 of spar base 400 may include one or more UAI ports 300. Distal end 202 of surgery table 200 may include one or more UAI ports 300. In one embodiment, distal end 502 of spar 500 may include one or more UAI ports 300, distal end 402 of spar base 400 may include one or more UAI ports 300, and distal end 202 of surgery table 200 may include one or more UAI ports 300.

As shown in FIG. 38, spar 500 may include UAI port 300. For example, distal end 502 of spar 500 may include UAI port 300. With reference to the embodiment of FIG. 2, surgery table 200, such as platform 220, may include UAI port 300. For example, distal end 202 of surgery table 200 may include UAI port 300, such as along each lateral side, such as first side 206 (FIG. 1) and second side 208 (FIG. 1). In another embodiment, UAI port 300 may be disposed on a slider (not shown) that may translate along at least a portion of first side 206, for example. UAI port 300 may be disposed on a slider that may translate along at least a portion of second side 208, for example. Additionally or alternatively, UAI port 300 may be disposed on a slider that may translate out of platform 220, such as in lateral direction 104 (FIG. 1). The slider may translate in medial direction 102 (FIG. 1) back into platform 220. The slider may translate out of platform 220 up to about five inches, such as about three inches. The slider may translate out of platform 220 incrementally, such as in about one inch increments, such as in about half an inch increments. In this way, UAI port 300 may be selectively disposed on surgery table 200, such as platform 220, such as along first side 206, second side 208, or first side 206 and second side 208. In addition, the position of UAI port 300 may be adjusted according to patient 20 being on platform 220. For example, if patient 20 is larger, UAI port 300 may be located laterally from platform 220 to allow for table modules 340 (FIG. 1) to couple to UAI port 300 for user with patient 20. With reference to FIG. 9, spar base 400 may include UAI port 300. For example, UAI port 300 may be disposed between distal end 402 and proximal end 404 of spar base 400.

Referring again to the embodiment of FIG. 38, UAI port 300 may include a “dog-bone” shape. For example, UAI port 300 may include a first opening 302, a second opening 306, and a third opening 310 between first opening 302 and second opening 306. First opening 302 and second opening 306 may be substantially spherical. Third opening 310 may be substantially rectangular. Accordingly, first opening 302, second opening 306, and third opening 310 may form a “dog-bone” shape. In other embodiments, first opening 302 and second opening 306 may be oval, or polygonal. In other embodiments, third opening 310 may include other shapes, for example, square, circular, oval, or polygonal. In embodiments, first opening 302 and second opening 306 and third opening 310 correspond to the shapes of UAI plug first portion 322, second portion 326, and third portion 330. UAI port 300 may also include an electrical connection 312 to receive electrical plug 334 (FIG. 40) of UAI plug 320. Accordingly, table module 340 (FIG. 36) coupled to UAI port 300 may be electrically coupled to UAI port 300.

Referring to FIGS. 36-38, in embodiments, UAI port 300 may include an undercut 311 inside of third opening 310 and corresponding to locking portion 332 in the position shown in FIG. 36. Undercut 311 may be sized such that locking portion 334 may enter in the horizontal position, but may not be able to be removed in the vertical position. Undercut 311 may have an undercut width that is equal to or greater than the width of the locking portion 332, and an undercut height that is less than the height H of locking portion 332 in FIG. 36. When locking portion 332 is inserted into undercut 311 and rotated to the vertical position, the width of locking portion 332 (now vertical) is now greater than the height of third opening 310 and corresponding undercut height, preventing locking portion 332, and correspondingly, UAI plug 320, from being removed from UAI port 300.

In some embodiments, UAI plug 320 and UAI port 300 include a twist lock. In embodiments, UAI plug 320 may include a locking portion 332 (FIGS. 36, 40). Locking portion 332 may have a height and a width, wherein, when in a horizontal position (90 degrees from what is shown in FIGS. 36-37), the height may be equal to or less than h, and the width may be less than a width of third portion 330. Locking portion 332 may be configured to rotate at least 90 degrees from a horizontal position to a vertical position as shown in FIGS. 36-37. In the vertical position, the width of the locking portion 332 is now oriented vertically and may have a height H, and H may greater than height h of third portion 330. In embodiments, UAI port 300 includes an undercut 311 inside of third opening 310 and corresponding to locking portion 332. Undercut 311 may be sized such that locking portion 332 may enter in the horizontal position where the height of locking portion 332 is height h, but may not be able to be removed in the vertical position where the locking portion 332 is now oriented vertically and may have a height H. Undercut 311 may have an undercut width that is equal to or greater than the width of the locking portion 332 in a horizontal position, and an undercut height that is equal to or greater than height H of locking portion 332 oriented vertically.

When locking portion 332 is inserted into undercut 311 and rotated to the vertical position, height of locking portion 332 is now greater than the height of third opening 310, preventing locking portion 332 from being removed from undercut 311, and correspondingly, preventing UAI plug 320, from being removed from UAI port 300.

In embodiments, a proximal face 336 is opposite distal face 333 of locking portion 332, and in the horizontal position proximal face 336 may include one or more ramped surfaces 335, on sides of proximal face 336, such as one side shown in FIG. 36 and FIG. 40 comprising respective lower portion 335a and upper portions 335b. When locking portion 332 is rotated towards lower portions 335a (counterclockwise in the embodiment of FIGS. 36, 40), proximal face 335 may engage a proximal wall of undercut 311 beginning at lower portion 335a and moving to upper portion 335b. As locking portion 332 is rotated, ramped surfaces 335 may ride along proximal wall of undercut 311 and may pull the UAI plug 320 any remaining distance into UAI port 300, and then increase retention force of UAI plug 320 in UAI port 300. In one embodiment, UAI port face 337 is pulled by locking portion 332 against a corresponding UAI port face 338 of UAI port 300, providing a secure connection between UAI plug 320 and UAI port 300. In order to release UAI plug 320 from UAI port 300, locking portion 332 may be rotated in the opposite direction back to the horizontal position. UAI port 300 may receive UAI plugs 320 of table modules 340, with reference to FIGS. 40-41. In this way, table module 340 may couple to surgery table 200, spar 500, or surgery table 200 and spar 500. First opening 302 of UAI port 300 may receive first portion 322 of UAI plug 320. Second opening 306 of UAI port 300 may receive second portion 326 of UAI plug 320. Third opening 310 of UAI port 300 may receive third portion 330 of UAI plug 320. Table module 340 may include a UAI lock 358 to retain UAI plug 320 in UAI port 300. UAI lock 358 may be unique to each individual table module 340, however, each UAI lock 358 functions to rotate locking portion 332 from a horizontal position to a vertical position. UAI lock 358 may be a lever to secure UAI plug 320 in UAI port 300. UAI lock 358 may turn locking portion 332 such that locking portion 332 is turned withing undercut 311, and therefore UAI plug 320 is secured withing UAI port 300.

First portion 322 and second portion 326 may guide UAI plug 320 such that UAI port 300 may receive table module 340. First portion 322 may include a shape to guide UAI plug 320. For example, first portion 322 may include a bevel shape 324 to guide UAI plug 320 such that UAI port 300 may receive table module 340. In addition, second portion 326 may include a shape to guide UAI plug 320. For example, second portion 326 may include a bevel shape 328 to guide UAI plug 320 such that UAI port 300 may receive table module 340. Similarly, first opening 302 and second opening 306 may guide UAI plug 320 of table module 340 such that UAI port 300 may receive table module 340. For example, first opening 302 and second opening 306 may include a bevel shape 304 and a bevel shape 308, respectively, to guide UAI plug 320 such that UAI port 300 may receive table module 340. Respective bevel shapes may help to receive and center UAI plug 320 in UAI port 300. However, once UAI plug 320 is inserted into UAI port 300 beyond the engagement of respective bevel shapes, first opening 302 and second opening 306 and third opening 310 securely engage corresponding UAI plug first portion 322, second portion 326, and third portion 330, and UAI port face 337 being pulled by locking portion 332 against a corresponding UAI plug face 338 of UAI port 300 additionally secures connection between UAI plug 320 and UAI port 300.

An apparatus may include UAI port 300 and UAI plug 320, such as a UAI attachment system. In an example, UAI port 300 and UAI plug 320 may be part of positioning system 100. In another example, UAI port 300 and UAI plug 320 may be a part of surgery table 200, spar 500, or spar base 200. In another example, UAI port 300 and UAI plug 320 may function separately, such as with other positioning systems, surgery tables, or apparatuses thereof. In an example, UAI port 300 and UAI plug 320 may include features that are functional separately and in combination.

In an example, an attachment system for a surgical procedure may include a UAI port 300. UAI port 300 may alternatively receive two or more table modules 340, each table module 340 being distinct from another of table modules 340. The attachment system may also include a UAI plug 320. Each table module 340 may include one or more UAI plugs 320.

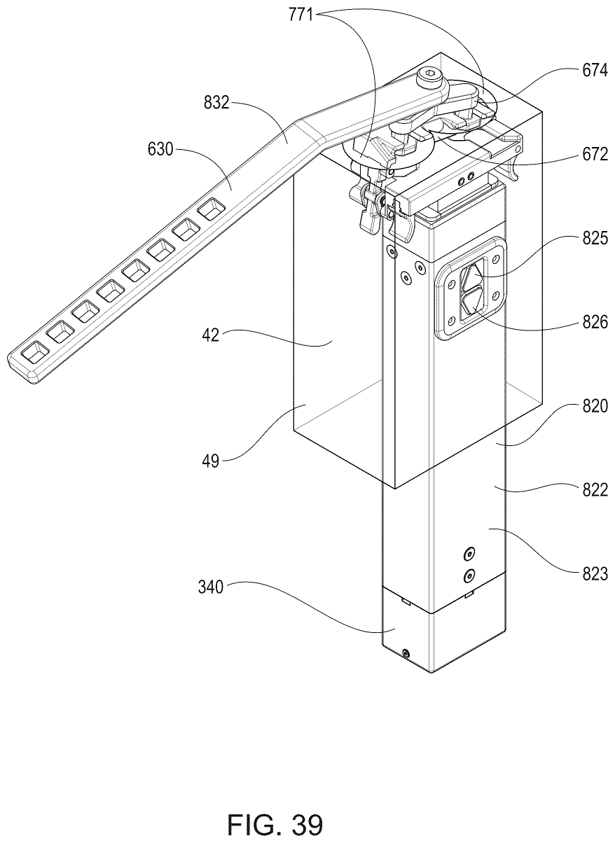

Another table module 340 is shown in FIGS. 39-41 according to exemplary embodiments. Table modules 340 may include femur hook module 820. Like foot support module 610 (FIG. 36), femur hook module 820 may include one or more USI plugs 674. Accordingly, USI attachments 630 may couple to foot hook module 651 and femur hook module 820. As discussed, bracket 832 may be coupled to femur hook module 820. Bracket 832 may couple to USI ports 672 of femur hook module 651 such that bracket 832 may be a USI attachment 630. As shown, bracket 832 may couple to USI ports 672 through hard points 41 on drape 42. Bracket 832 may include USI plug 674 that may be received by hard points 41, the hard points 41 being coupled to USI ports 672.

Femur hook module 820, like other table modules 340, may include a UAI plug 320 to couple to UAI port 300 (FIG. 38) of positioning system 100 (FIG. 1). For example, UAI plug 320 of femur hook module 820 may couple to UAI port 300 of surgery table 200 (FIG. 1) at platform 220 (FIG. 1). In this way, femur hook module 820 may be positioned proximate a leg 32 (FIG. 18) of patient 20 (FIG. 18).

As discussed, at least portions of femur hook module 820 may be visible through drape 42 (FIG. 22). Drape 42 may include a femur hook module sleeve 49 (FIG. 22), or a second film portion. Femur hook module sleeve 49 may include a film portion such that femur hook module sleeve 49 is transparent and may allow user 40 (FIG. 23) visual access through femur hook module sleeve 49. Femur hook module sleeve 49 may be disposed over femur hook module 820 when drape 42 is deployed. Accordingly, femur hook module 820 may be visible through drape 42. Femur hook module 820 may include one or more controls that may be visible, and able to be accessed, through drape 42 such that user may access one or more controls from sterile space 10 without breaking the sterile barrier formed by drape 42 to access the controls.

Femur hook module 820 may include a lift 822. Lift 822 may raise and lower femur hook module 820. As shown, lift 822 may include an outer column 823 and an inner column 824. Inner column 824 may be telescoping with outer column 823 such that inner column 824 may raise or lower within outer column 823.

In one embodiment, lift 822 may raise femur hook module 820 via a gross adjustment, a fine adjustment, or a combination of a gross adjustment and a fine adjustment. In one embodiment, gross adjustment includes the ability to manually lift and/or lower the femur hook module 820. Lift 822 may include a ratchet mechanism 828 having dual pawls to allow for manual gross adjustment and raise inner column 824 to a larger extent within outer column 823. Manual gross adjustment may be actuated by user 40 (FIG. 23) pulling on inner column 824, or bracket 832. The manual gross adjustment may have a stroke of about four inches. Lift 822 may also include a linear actuator 827. Linear actuator 827 may be electromechanical. Linear actuator 827 may allow for actuated fine adjustment once a general position for femur hook module 820 is reached via gross adjustment. The actuated fine adjustment may have a stroke of about 6 inches. An up button 825 may be used to actuate linear actuator 827 such that inner column 824 is raised. A down button 826 may be used to actuate linear actuator 727 such that inner column 824 is lowered. Up button 825 and down button 826 may be controls for femur hook module 820 that may be visible and accessible through drape 42, for example through the film portion of femur hook module sleeve 49.

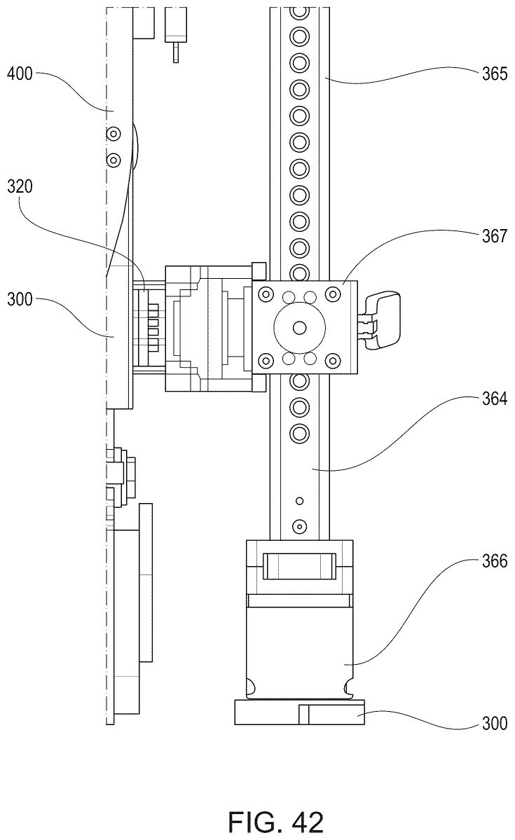

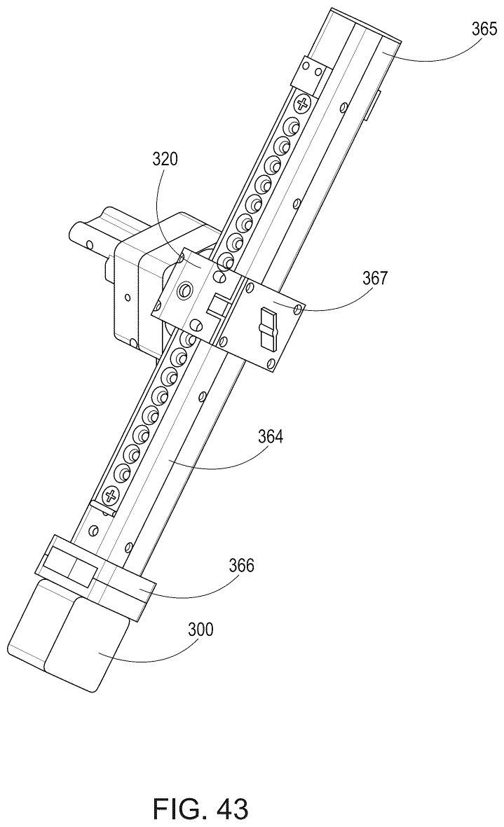

With reference to FIGS. 37-39 and 42-43, various attachments for positioning system 100 (FIG. 1), such as surgery table 200 (FIG. 1) or spar 500 (FIG. 3), or components thereof, may include UAI port 300, UAI plug 320, or UAI port 300 and UAI plug 320. In one embodiment, as shown in FIGS. 42-43 according to exemplary embodiments, positioning system 100 may include a UAI offset arm 364. UAI offset arm 364 may be disposed along positioning system 100, such as on surgery table 200 or spar 500, or components thereof. UAI offset arm 364 may be selectively disposed.

In this embodiment, UAI offset arm 364 may include an arm 364 having a proximal end 365 and a distal end 366 opposing proximal end 365. Distal end 366 may include UAI port 300. Proximal end 365 may include UAI plug 320. Alternatively, UAI plug 320 may be disposed intermediate to proximal end 365 and distal end 366. UAI plug 320 may be coupled to a bracket 367 within which arm 364 may be adjustable to change the position of proximal end 365 and distal end 366. For example, arm 364 may slide within bracket 367 to further extend distal end 366 beyond bracket 367. UAI plug 320 of UAI offset arm 364 may couple to UAI port 300 of positioning system 100, such as on surgery table 200, spar 500, spar base 400, or components thereof, such that UAI offset arm 364 is selectively disposed. For example, UAI plug 320 of UAI offset arm 364 may couple to UAI port 300 of spar base 400. UAI offset arm 364 may be selectively disposed at any UAI port 300. Arm 364 may be adjustable within bracket 367 to further extend proximally UAI port 300. In addition, arm 364 may be articulable in a pitch direction. UAI offset arm 364 rotated may be seen in FIG. 43. UAI offset arm 364 may pitch upward in anterior direction 105 (FIG. 1) or posterior direction 107 (FIG. 1) up to about 30 degrees, such as up to about 20 degrees, such as up to about 10 degrees. In this way, attachments, such as table modules 340 (FIG. 1) with UAI plugs 320 may couple to UAI port 300 of UAI offset arm 364 and may be selectively disposed along positioning system 100 (FIG. 1), such as surgery table 200 (FIG. 1) or spar 500 (FIG. 3) or spar base 300, or components thereof. UAI offset arm 364 may allow the reach of attachments to be extended and adjustable.

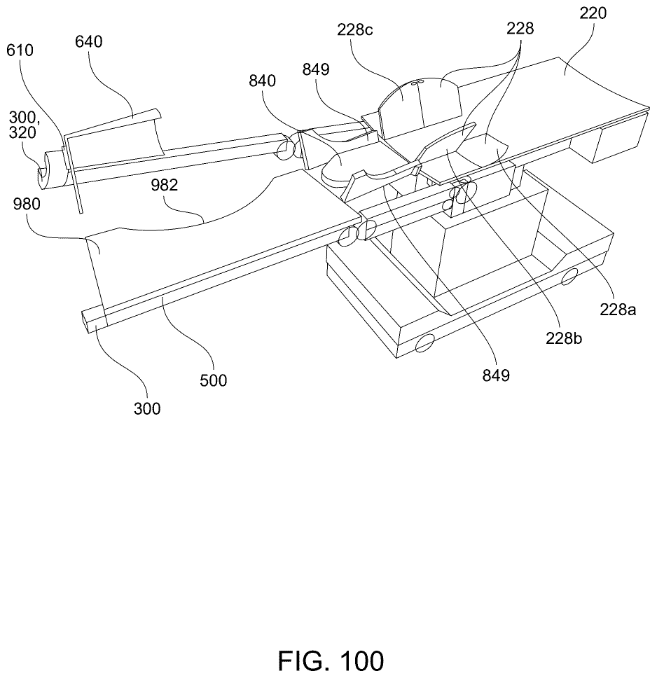

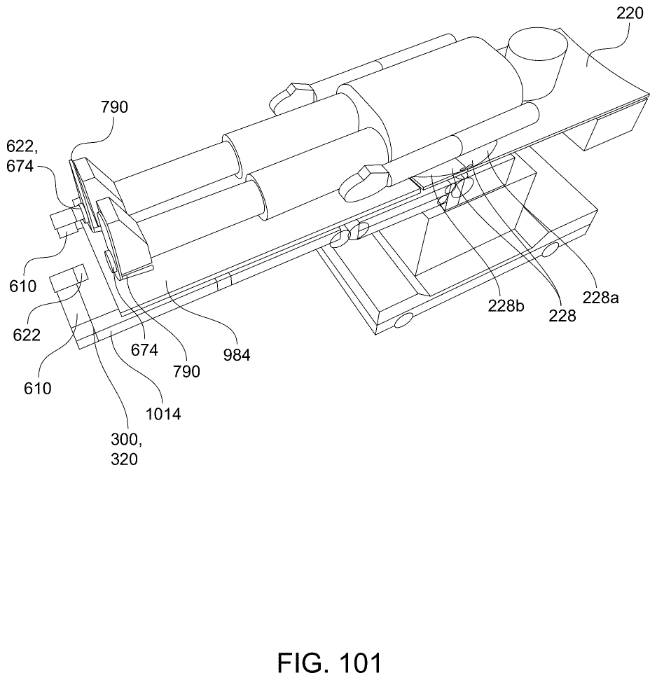

In embodiments, a portable UAI 368 (not shown) may additionally or alternatively be disposed along positioning system 100 (FIG. 1), such as surgery table 200 (FIG. 1) or spar 500 (FIG. 3) or rail 226, or components thereof. In one embodiment, portable UAI 368 may have a smaller profile, or may be more compact, in comparison to UAI offset arm 364. Like UAI offset arm 364, portable UAI 364 may be disposed along positioning system 100, such as on surgery table 200 or spar 500, or components thereof. Portable UAI 364 may be selectively disposed. For example, portable UAI 368 may have a clamp to couple to a portion of positioning system 100, such as surgery table 200, spar 500, or components thereof. Portable UAI 368 may mount to rail 226 (FIG. 1), spar 500, edges of boards that may attach to positioning system 100, such as on surgery table 200 or spar 500, or components thereof., and may be slideable before being fixed in position. Portable UAI 368 may be side-mounted to spar 500, or one or more edges of boards, such as a lateral board 980 (FIG. 100) or an imaging board 984 (FIG. 101). Portable UAI 368 may have an adapter to couple to different components. Accordingly, portable UAI 368 may couple to positioning system 100, such as on surgery table 200 or spar 500, or components thereof, such that portable UAI 368 is selectively disposed. Portable UAI 368 may include a UAI port 300. In this way, attachments, such as table modules 340 (FIG. 1) with UAI plugs 320 may couple to UAI port 300 of portable UAI 368 and may be selectively disposed along positioning system 100, such as surgery table 200 or spar 500, or components thereof. Portable UAI 368 may be selectively coupled where UAI offset arm 364 or other components with UAI ports 300 do not reach such that portable UAI 368 may extend coverage of UAI ports 300 for receiving table modules 340. Portable UAI 368 may break imageability where attached, e.g., by having an aluminum, or other metal, adapter.

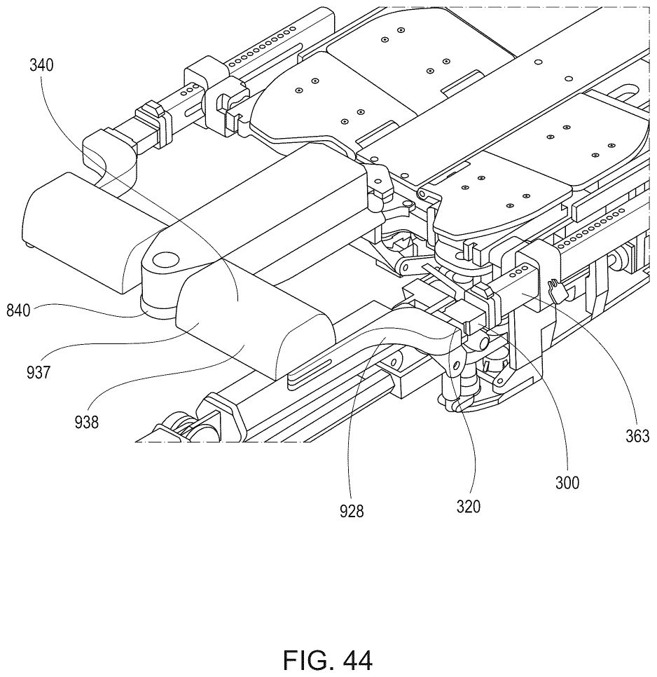

With reference to FIGS. 44-46 according to exemplary embodiments, one or more table modules 340 may include a bolster 926. Accordingly, bolster 926, like other table modules 340, may include a UAI plug 320 to couple to UAI port 300 (FIG. 38) of positioning system 100 (FIG. 1). Bolster 926 may couple to UAI port 300 of UAI offset arm 363, for example. Offset arm 363 may be articulated to position bolster 926. Bolster 926 may be used to position and cushion anatomy. For example, UAI offset arm 363 may be raised to raise bolster 926 as the corresponding anatomy is raised, and/or extended or retracted as needed to accommodate the corresponding anatomy. In this way, bolster 926 may be positioned to support the anatomy. Bolsters 926 may couple to UAI offset arm 363 such that bolsters 926 are disposed over spar 500 (FIG. 1). Bolsters 926 may couple to any UAI port 300, such as at distal end 502 (FIG. 1) of spar 500 (FIG. 1), distal end 402 (FIG. 1) of spar base 400 (FIG. 1), or distal end 202 (FIG. 1) of surgery table 200 (FIG. 1).

One or more bolsters 926 may be used in a surgery, such as trauma related surgeries or hip surgery. For example, bolster 926 may be used to support a gluteal region of patient 20 (FIG. 18). A gluteal bolster 938 may be seen in FIG. 43. Gluteal bolster 938 may be located proximate pelvic center board 840 to receive at least a portion of patient 20 such that gluteal bolster 938 may support the gluteal region. Gluteal bolster 938 may be disposed over spar 500 proximate a gluteus muscle of patient 20 (FIG. 18).

Another bolster 926 (not shown) may be used to support a femoral region of patient 20. This bolster 926 may be disposed over spar 500 proximate a femur of patient 20. Another bolster 926 (not shown) may be used to support a tibial region of patient 20. This bolster 926 may be disposed over spar 500 proximate a tibia of patient 20. Bolster 926 may be used to support a popliteal region of patient 20. This bolster 926 may be disposed over spar 500 proximate the underside of knee 34 (FIG. 17) of patient 20. These bolsters 827 to support different regions of patient 20 may be constructed similarly but may have different sized pads.

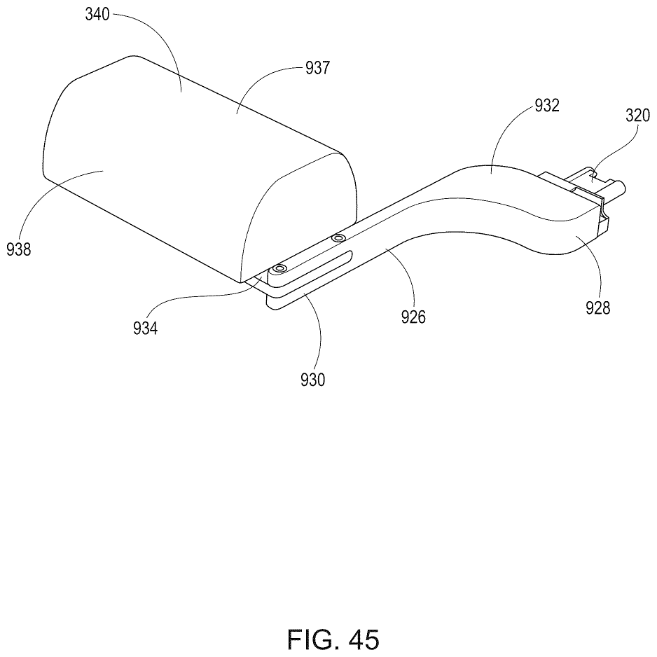

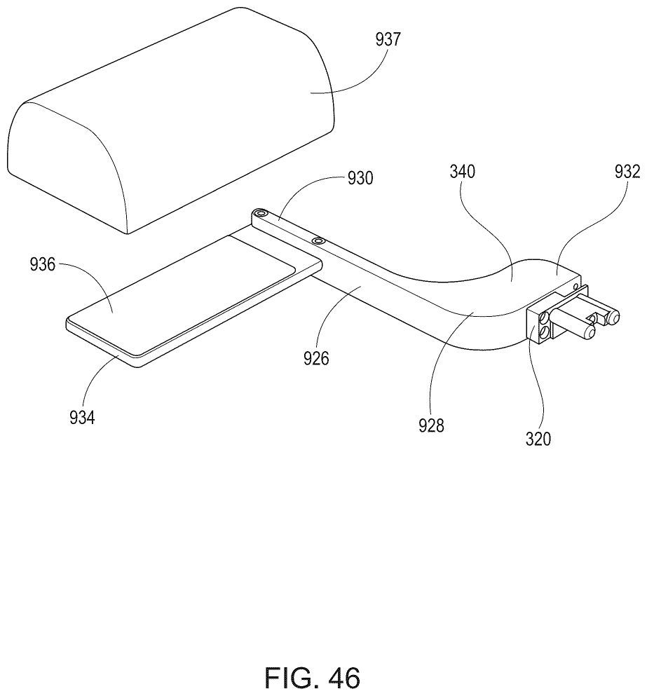

As shown in FIG. 45, bolster 926 may include an arm 928. Arm 928 may include a distal end 930 and a proximal end 932 opposing distal end 930. Arm 928 may include a generally “L” shape. In this way, proximal end 982 may couple to UAI port 300 (FIG. 44) as distal end 930 may protrude towards pelvic center board 840 (FIG. 44). Bolster 926 may thus be proximate to pelvic center board 840, extending laterally from pelvic center board 840 and providing lateral support. UAI plug 320 may be disposed at proximal end 932. Arm 928 may include aluminum. Arm 928 may be substantially radiolucent. Alternatively, arm 928 may be mostly or entirely radiolucent. Bolster 926 may also include a base 934. Arm 928 may extend from base 934. Base may include pad 937. Pad 937 may contact patient 20 (FIG. 18) to support a portion of patient 20. As shown in FIG. 46, base 934 may include a fastener 936 to secure pad 937 to base 934. Fastener 936 may include adhesive or a hook and loop fastener, for example.

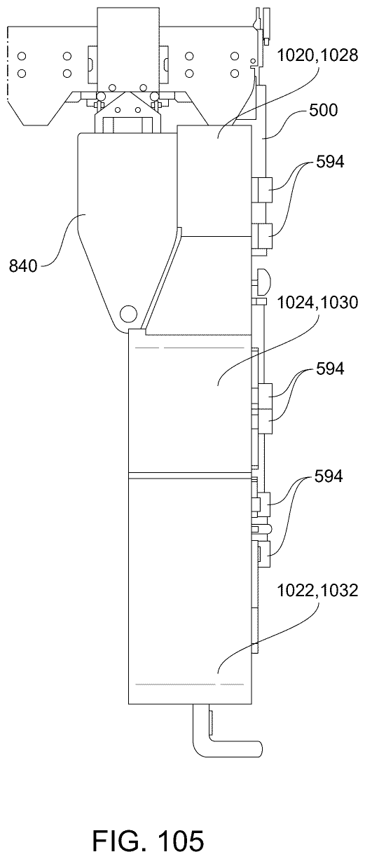

Instead of gluteal bolster 938, a gluteal support 1020 may be used to support the gluteal region as shown in FIG. 105 according to exemplary embodiments. Gluteal support 1012 may be mounted to spar 500 via one or more clamps 594, or another fastening mechanism. As shown, gluteal support 1012 may be proximate pelvic center board 840. A gluteal pad 1028 may be disposed over gluteal support 1012 to support patient 20 (FIG. 18). Similarly, a femoral support 1024 may be used to support the femoral region. Femoral support 1024 may be mounted to spar 500 via one or more clamps 594, or another fastening mechanism. A femoral pad 1030 may be disposed over femoral support 1024 to support patient 20. A tibial support 1022 may be used to support the tibial region. Tibial support 1022 may be mounted to spar 500 via one or more clamps 594, or another fastening mechanism. A tibial pad 1032 may be disposed over tibial support 1022 to support patient 20.

Each of clamps 594 may include a support board that is generally rigid on which pads are secured. In other words, each of gluteal support 1012, femoral support 1024, and tibial support 122 may include a rigid portion along the bottom of the respective pad, such that when clamps 594 are pulled apart, the rigid portion may “bridge” the gap between clamps 593 and support the respective pad. In certain embodiments, the rigid support does not extend to sections configured to fold under clamps 594 at the ends of the respective pad.

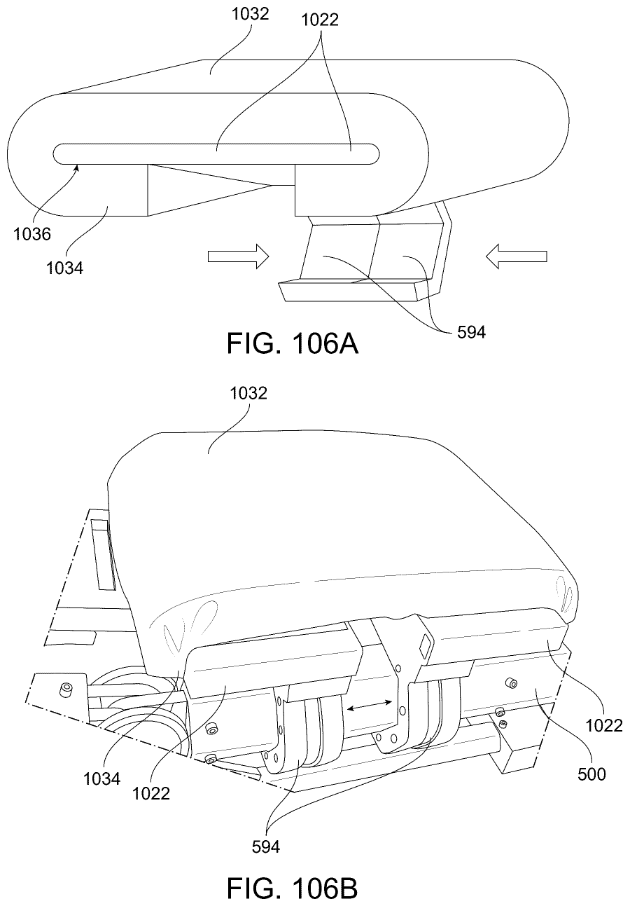

Each of gluteal support 1012, femoral support 1024, and tibial support 122 may be retractable or extendable in inferior direction 103 (FIG. 1) and/or superior direction 101 (FIG. 1). In this way, gluteal support 1012, femoral support 1024, and tibial support 122 may be adjusted based on the size of patient 20 (FIG. 18). For example, shorter patients may be supported by retracted gluteal support 1012, femoral support 1024, and tibial support 122. Taller patients may be supported by extended gluteal support 1012, femoral support 1024, and tibial support 1022. As shown in FIG. 106A according to exemplary embodiments, tibial support 1022 may be retracted. Tibial support may retract by pushing together clamps 594 such that tibial support 1022 is smaller. Excess tibial pad 1032 may be rolled over, or folded around, tibial support 1022 as shown and secured to tibial support 1022 via a fastener 1036, such as a hook and loop fastener. FIG. 106B shows tibial support 1022 according to exemplary embodiments as tibial support 1022 is extended. Here, clamps 594 are pulled apart along spar 500 such that tibial support 1022 is larger. Tibial pad 1032 may be extended over the larger tibial support 1022 by unrolling, or unfolding, tibial pad 1032 from around and under tibial support 1022. Gluteal support 1012 and gluteal pad 1028 may function similarly to tibial support 1022 and tibial pad 1032, respectively. Femoral support 1024 and femoral pad 1030 may function similarly to tibial support 1022 and tibial pad 1032, respectively.

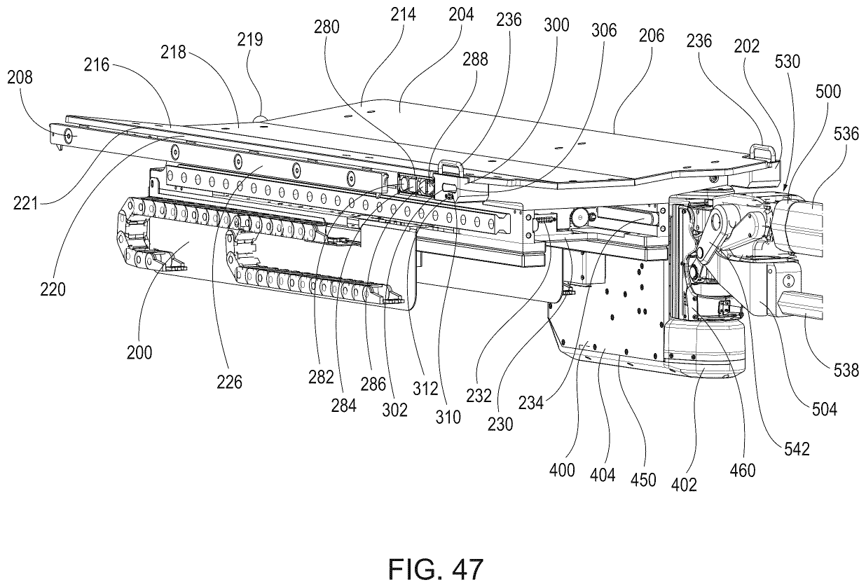

Positioning system 100 may (FIG. 1) may include one or more additional universal interfaces in that a plurality of attachments may be coupled to the same component. With reference to FIGS. 47-53, according to exemplary embodiments, positioning system 100, such as surgery table 200 may include a pelvic port 230. Pelvic port 230 may be disposed at distal end 202 of surgery table 200, for example. Accordingly, pelvic port 230 may be proximate a pelvic area of patient 20 (FIG. 18) Pelvic port 230 may receive a plurality of attachments 240 (FIG. 50) to support at least a portion of patient 20. In this way, pelvic port 230 may be a universal receptacle as it may receive a plurality of distinct attachments 240.

Pelvic port 230 may directly receive attachments 240 (FIG. 50). Additionally or alternatively, with reference to FIGS. 47-49 according to exemplary embodiments, pelvic port 230 may receive static pelvic port adapter 242. Static pelvic port adapter 242 may receive attachments 240. Pelvic port 230 may include an electrical coupling 232 to couple to attachments 240 or static pelvic port adapter 242. In addition, pelvic port 230 may include one or more rails 234. Static pelvic port adapter 242 may include a track 244. Track 244 may receive one or more rails 234 such that static pelvic port adapter 242 is coupled to pelvic port 230.

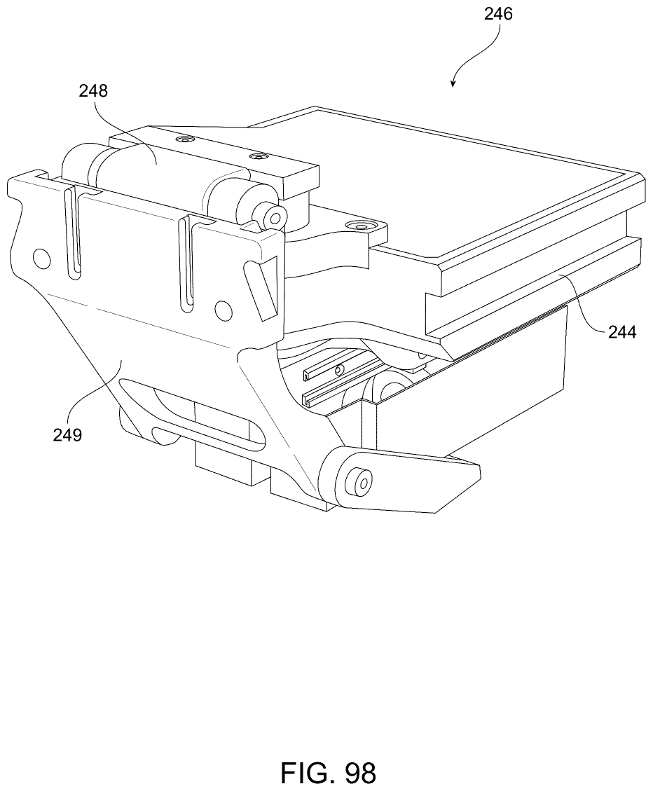

Other adapters may be received by pelvic port 230 for coupling attachments 240 to pelvic port 230. An articulable pelvic port adapter 246 is shown in FIG. 98 according to exemplary embodiments. Articulable pelvic port adapter 246 may include features of static pelvic port adapter 242, such as track 244 to receive one or more rails 234 such that static pelvic port adapter 242 is coupled to pelvic port 230. Like for static pelvic port adapter 242, pelvic port 230 may include an electrical coupling 232 to couple to articulable pelvic port adapter 246. Articulable pelvic port adapter 242 may also have a front surface 249 having a beveled, chamfered, curved, or angled shape. In this way, articulable pelvic port adapter 246 can facilitate providing increased C-arm 1012 (FIG. 93) access to facilitate oblique imaging, as the bevel, chamfer, curve, or angle allows for clearance for C-arm 1012 placement and x ray path 111. When installed, articulable pelvic port adapter 242 may include a chamfer that extends in superior direction 101 (FIG. 1). As shown, any bevel, chamfer, or angle on front surface 248 may include rounded edges. Front surface 349 may allow the x ray path 111 to extend without being intersected by articulable pelvic port adapter 242, advancing imaging. Articulable pelvic port adapter 242 will be discussed further below.

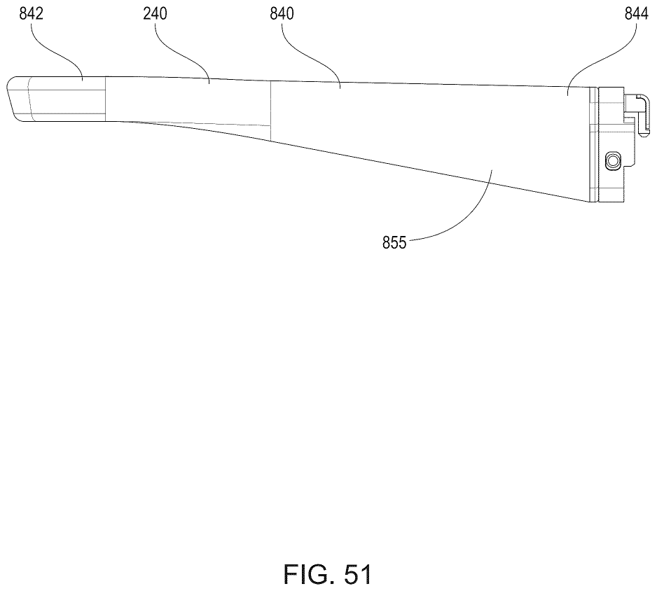

Attachments 240 may include supports for at least a portion of patient 20 (FIG. 18), such as at least a portion of a lower body of patient 20. Attachments 240 for pelvic port 230 may include pelvic center board 840 shown in FIGS. 50-51 according to exemplary embodiments. Pelvic center board 840 may be generally triangular, such as when viewing pelvic center board 840 in posterior direction 107 (FIG. 1). Pelvic center board 840 may extend from pelvic port 230 in inferior direction 103 (FIG. 1) such that pelvic center board 840 is disposed intermediate to spars 500 (FIG. 1). The triangular shape of pelvic center board 840 may allow spar 500 to articulate relative to pelvic center board 840 without pelvic center board 840 causing interference in spar 500 movement, for example when spar 500 is raised above a straight spar configuration 506 (FIG. 18).

Pelvic center board 840 may include a bottom portion 840, shown in FIG. 51. As shown, bottom portion 840 may include a curvature. In other words, bottom portion 840 may include a varying thickness. Pelvic center board 840 may include a distal end 842 and a proximal end 844 opposing distal end 842. Proximal end 844 may be thicker longitudinally than distal end 842. The transition between proximal end 844 and distal end 842 may be curved. Accordingly, the change in thickness may create a “belly” shape along bottom portion 840. The difference in thickness toward distal end 842 may also facilitate spar 500 articulation without interference from pelvic center board 840, for example when spar 500 is raised above a straight spar configuration 506 (FIG. 18).

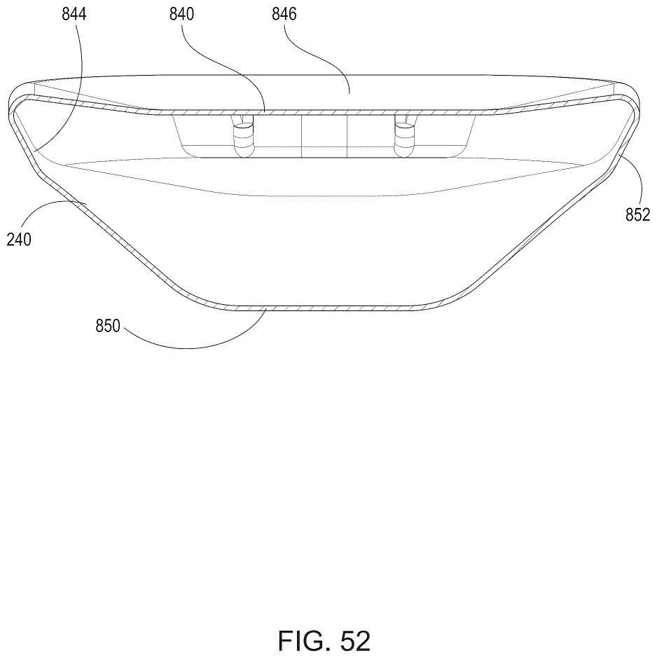

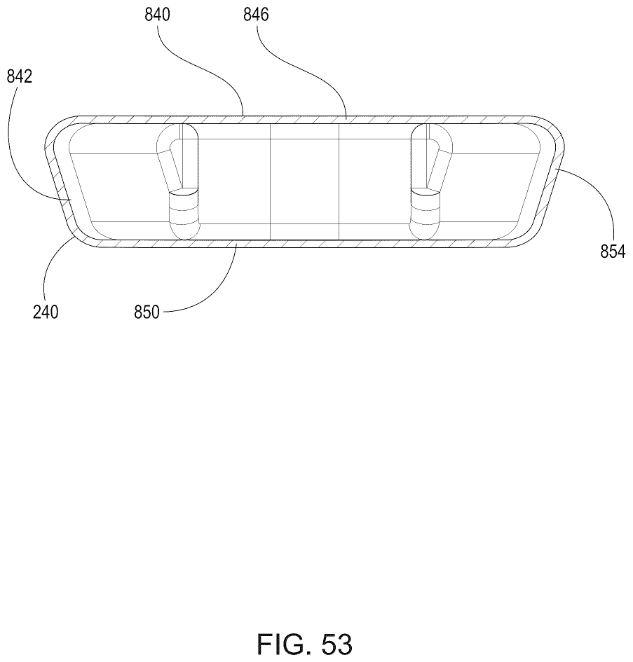

Pelvic center board 840 may be constructed such that corners are rounded and offset to enhance imaging. As shown in FIGS. 52-53 according to exemplary embodiments, pelvic center board 840 may include one or more profiles that may enhance radiolucency and/or radio-uniformity. Proximal end 844 shown in FIG. 52 may include a first shape 852. First shape 852 may be generally trapezoidal. Edges of first shape 852 may be rounded rather than sharp. Edges of first shape 852 may be offset from one another, or not vertically aligned. Distal end 842 shown in FIG. 53 may include a second shape 854. Second shape 854 may also be generally trapezoidal. Edges of second shape 854 may be rounded rather than sharp. Edges of second shape 854 may be offset from one another, or not vertically aligned. The “belly shape” and pelvic center board 840 including curves rather than sharp edges may enhance radiolucency and/or radio-uniformity.

In this way, pelvic center board 840 can provide increased C-arm 1012 (FIG. 93) access to facilitate oblique imaging. The “belly shape” and trapezoidal cross-section may allow the x ray path to extend without being intersected by pelvic center board 840, advancing imaging. In addition, pelvic center board 840 may be substantially radiolucent and/or radio-uniform. If pelvic center board 840 is within the x ray path, pelvic center board 840 is radiolucent. Alternatively, pelvic center board 840 may be mostly or entirely radiolucent. For example, pelvic center board 840 may consist essentially of carbon fiber. In other words, pelvic center board 840 may be composed mostly or entirely of carbon fiber.

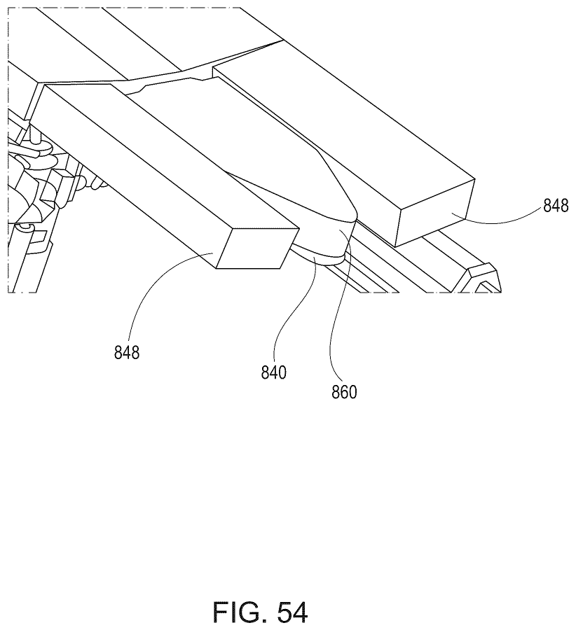

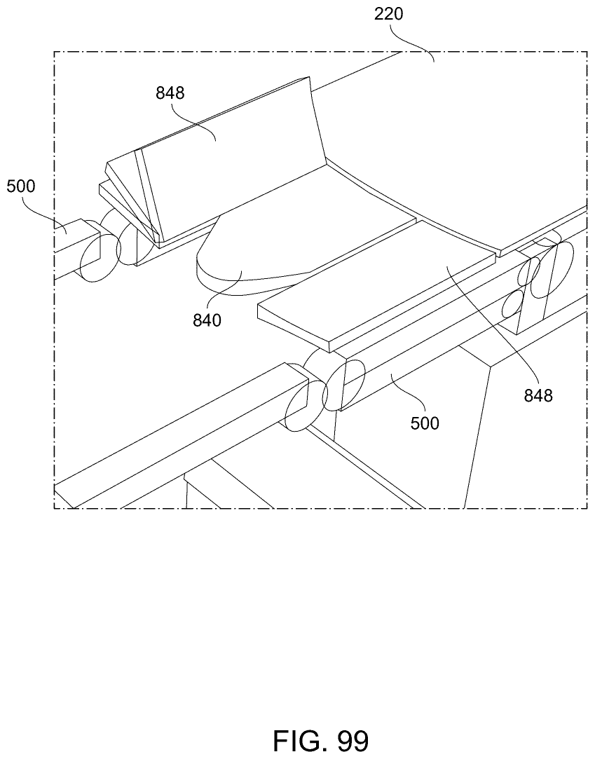

With reference to FIG. 54 according to an exemplary embodiment, various attachments may extend pelvic center board 840 such that pelvic center board 840 includes another shape. For example, pelvic center board 840 may include a center portion 846 (FIG. 49). Pelvic center board 840 may include one or more lateral portions 848 extending from center portion 846 to extend pelvic center board 840 laterally. Lateral portions 848 may facilitate stabilizing the pelvic area of patient 20 (FIG. 18) by increasing the support surface. Lateral portions 848 may slide in laterally under pelvic center board 840. With reference to FIG. 99 according to exemplary embodiments, lateral portions 848 may be articulable wings. In other words, lateral portions 848 may be pivotable relative to center portion 846. Pelvic center board 840 may include hinges, for example, or other mechanisms to facilitate articulation of lateral portions 848. In this way, lateral portion 848 may be similar to wings that rotate relative to center portion 846. Lateral portions 848 may articulate up in anterior direction 105 (FIG. 1) or down in posterior direction 107 (FIG. 1). For example, lateral portions 848 may articulate down to facilitate hip access. Pelvic center board 840 may receive a pelvic center board pad 860 that is articulable with pelvic center board 840. Similarly lateral portions 848 may receive pads that may be articulable with lateral portions 848.

Alternative to lateral portions 848, pelvic center board 840 may receive cutout lateral portions 849 shown in FIG. 100 according to exemplary embodiments. As shown, cutout lateral portions 849 may include cutout portions in comparison to lateral portions 848 (FIG. 99). This may facilitate additional access to the pelvic area of patient 20 (FIG. 18). Like lateral portions 848, cutout lateral portions 849 may be articulable and may mount similarly to lateral portions 848.

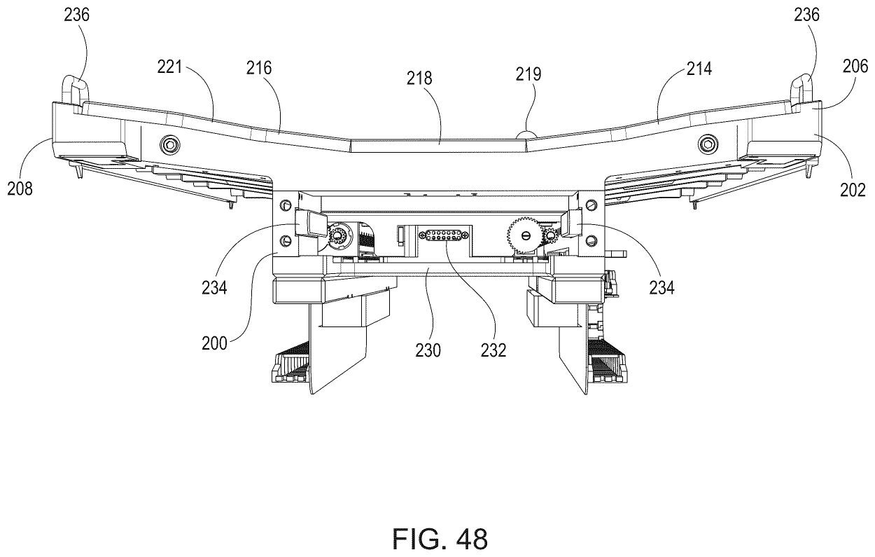

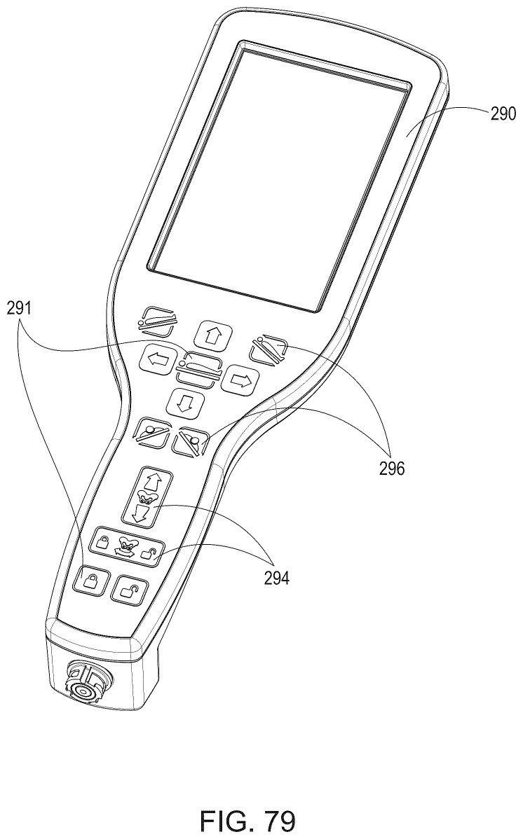

In addition, pelvic center board 840 may be articulable, such as in pitch and yaw directions. As discussed, pelvic center board 840 may be an attachment 240 for pelvic port 230 (FIG. 48). Pelvic center board 840 may couple to static pelvic port adapter 242 (FIG. 49) or articulable pelvic port adapter 246 (FIG. 98) to couple to pelvic port 230. Pelvic port 230 may include electrical coupling 232 to couple to attachments 240, static pelvic port adapter 242 or articulable pelvic port adapter 246. Static pelvic port adapter 242 may provide electrical connection to attachments 240 via pelvic port 230. Articulable pelvic port adapter 246 may also provide electrical connection to attachments 240 and may be articulable to articulate attachments 240, such as pelvic center board 840. One or more controls may be proximate to pelvic center board 840 or remote from pelvic center board 840 to control articulation of pelvic center board 840. For example, a pendant 290 (FIG. 79) may include one or more controls 294 (FIG. 79) for articulating articulable pelvic port adapter 246 and therefore attachments 240 coupled to articulable pelvic port adapter 246. In embodiments, articulable pelvic port adapter 246 may manipulate attachments 240 in at least one of pitch, yaw and tilt. Center portion 846 and lateral portions 848 (FIG. 99) or cutout lateral portions 849 may inherit the articulation of pelvic center board 840 as a whole, e.g., center portion 846 and lateral portions 848 may pitch and yaw together while lateral portions 848 or cutout lateral portions 849 independently articulate with respect to center portion 846.

Another attachment 240 may be imaging board 984, shown in FIG. 100 according to exemplary embodiments. Imaging board 984 may be coupled to pelvic port 230. Imaging board 984 may be static and not articulable. Imaging board 984 may be an attachment 240 and may couple to and extend from pelvic port 230 to distal end 502 (FIG. 1) of spars 500 (FIG. 1). Alternatively, imaging board 984 may extend from pelvic port 230 to above a part of spars 500 between proximal end 504 (FIG. 1) and distal end 502. Imaging board 984 may support at least a portion of patient 20 (FIG. 17). Spars 500 may extend under at least a portion of imaging board 984 and may not be coupled to the imaging board. Accordingly, spars 500 may be articulable under imaging board 984. In this way, imaging board 984 may function as a “diving board,” with spars 500 traveling underneath for maximum imaging flexibility. User 40 (FIG. 19) may use imaging board 984 for imaging while minimizing or eliminating interference from spars 500. While using imaging board 984, spars 500 may still be used to secure the foot of a patient 20 by any of the methods described herein. Alternatively, imaging board 984 may be coupled to surgery table 200 (FIG. 1) via pelvic port 230 and spars 500 may be removed.

Imaging board 984 may span about a full width of surgery table 200 (FIG. 1). Edges of imaging board 984 may be engineered to minimize risk of pressure injury. Imaging board 984 may be radiolucent. Imaging board 984 may include carbon fiber.

Imaging board 984 may rest over a trauma spar 1040. Trauma spar 1040 may be similar to spar 500 (FIG. 3) discussed above. However, trauma spar 104 may bend toward anterior direction 102 (FIG. 1) and generally flex pointing up. Trauma spar 1040 may be used for trauma surgeries, such as for lower limb trauma. A popliteal bolster (not shown) may couple to trauma spar 1040 to support the knee of patient 20 (FIG. 18).

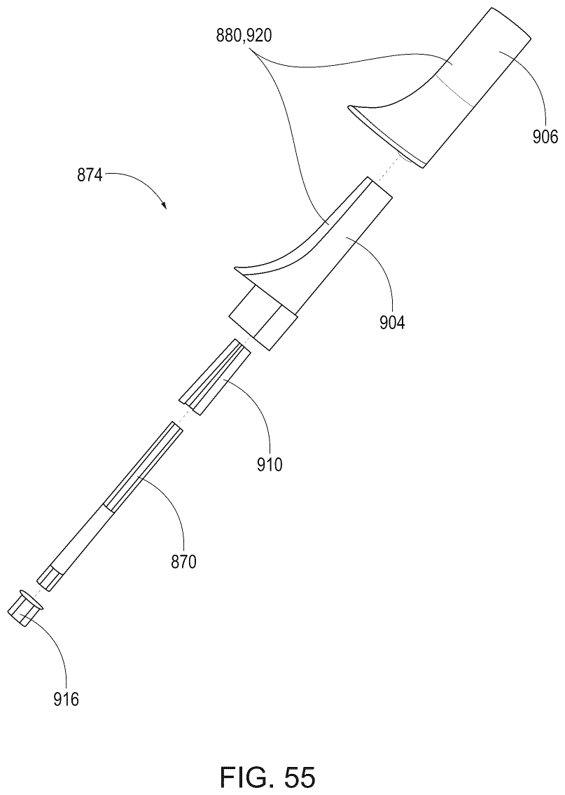

Pelvic center board 840 may include an opening 856 shown in FIG. 50. Distal end 842 of pelvic center board 840 may include opening 856. Opening 856 may receive one or more components of a perineal post 874, shown in FIG. 55 according to exemplary embodiments. Perineal post 874 may provide countertraction as traction is applied to at least one leg 32 (FIG. 18) of patient 20 (FIG. 18), legs 36 being disposed around perineal post 874 during a hip surgery when patient 20 is in a supine position, for example.

Perineal post 874 may include one or more components. For example, perineal post 874 may include a perineal post core 870. Alternatively, perineal post 874 may include perineal post core 870 and a perineal post bolster 880. Alternatively, perineal post 874 may include perineal post core 870, perineal post bolster 880, and a perineal post bolster cover 882 (not shown). Perineal post bolster 880 may be reusable. Perineal post bolster 880 may be disposed after one or more uses once there is wear. Perineal post bolster cover 882 may be disposable. Accordingly, perineal post bolster cover 882 may be single use and sterile.

Perineal post 874 may be substantially radiolucent. Alternatively, perineal post 874 may be mostly or entirely radiolucent. For example, perineal post core 870 may consist essentially of carbon fiber. In other words, perineal post core 870 may be composed mostly or entirely of carbon fiber. Accordingly, perineal post core 870 may be radiolucent. Perineal post bolster 880 may consist essentially of foam. In other words, perineal post bolster 880 may be composed mostly or entirely of foam. Accordingly, perineal post bolster 880 may be radiolucent. Other portions of perineal post 874 may include radiolucent polymers and other radiolucent materials.

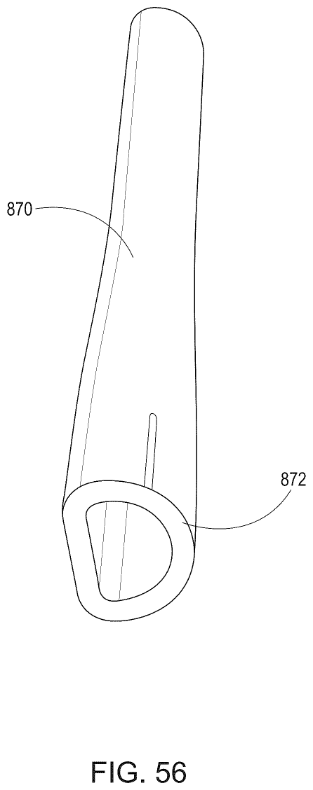

Opening 856 (FIG. 50) of pelvic center board 840 may receive perineal post core 870 through opening 856. Opening 856 may be shaped to receive perineal post core 870. As shown in FIG. 56 according to exemplary embodiments, perineal post core 870 may include a non-circular profile 872. For example, non-circular profile 872 may include generally a D-shape. Opening 856 may also be non-circular and may correspond to non-circular profile 872. For example, opening 856 may be generally D-shaped. In this way, opening 856 may receive perineal post core 870 and perineal post core 870 may not rotate within opening 856.

Alternative to perineal post 874, a lateral perineal post (not shown) may support patient 20 (FIG. 18) and may be received by opening 856 (FIG. 50). The lateral perineal post may be generally “C”-shaped. While perineal post 874 may be used while patient 20 is in a generally supine position, the lateral perineal post may be used while patient 20 is in a generally lateral position. The lateral perineal post may be positioned in between legs leg 32 (FIG. 18) of patient 20 (FIG. 18) when patient 20 is laying on their side in order to provide countertraction.

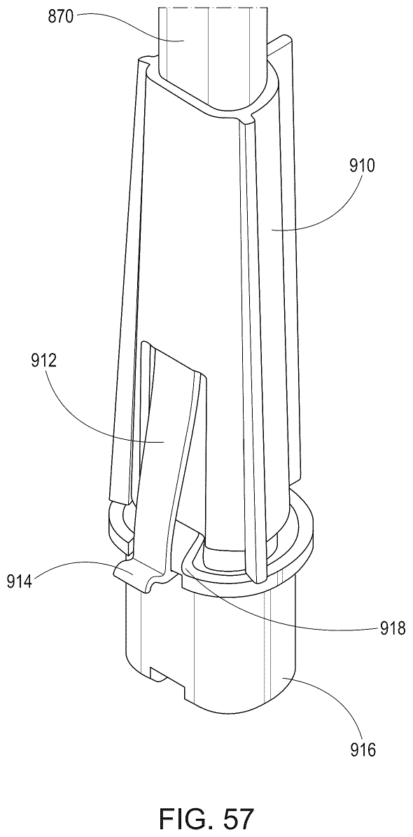

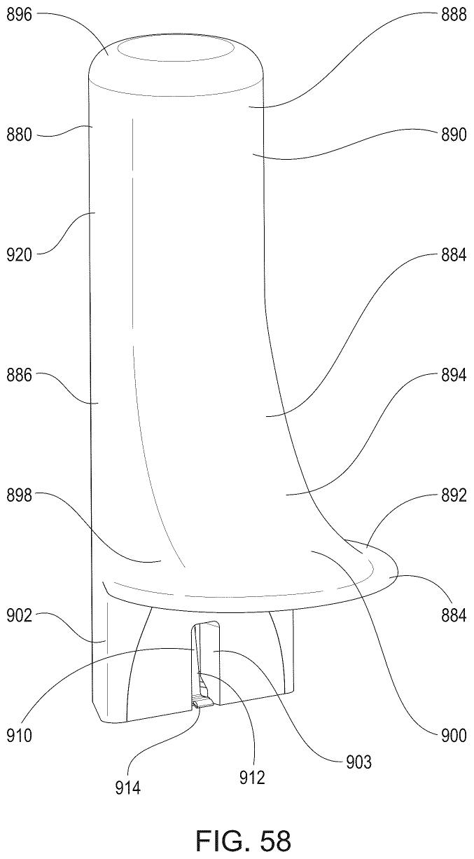

Turning back to perineal post 874, perineal post core 870 may be coupled to perineal post bolster 880. With reference to FIGS. 57-58 according to exemplary embodiments, perineal post bolster 880 may include a post cover 910 that may couple to post sleeve 916 of perineal post core 870. Perineal post bolster 880 may include an opening that may house post sleeve 916. Post sleeve 916 may be secured to perineal post bolster 880 via a fastener, such as adhesive. Post sleeve 916 may include a leaf spring 912 that may be biased outwardly away from perineal post core 870. Post sleeve 916 may include a foot 914. Foot 914 may extend from leaf spring 912 to couple to post sleeve 916. As shown in FIG. 58, foot 914 may extend outwardly from perineal post bolster 880. Perineal post bolster 880 may include an opening 903 to allow foot 914 to extend outwardly.

Referring to FIG. 57, a portion of perineal post core 870 may be surrounded by post sleeve 916 to receive foot 914 to couple perineal post bolster 880 to perineal post core 870. Perineal post sleeve 916 may include a notch 918 that may receive foot 914 to couple post cover 910 to post sleeve 916. Leaf spring 912 may bias foot 914 toward notch 918. In this way, perineal post core 870 may receive perineal post bolster 880 and perineal post cover 882 (not shown). Perineal post core 870, perineal post bolster 880, and perineal post cover 882 may be assembled together to form perineal post 874. Perineal post 874 may be then couple to pelvic center board 840 (FIG. 49), for example.

The non-circular shape of opening 856 (FIG. 49) and perineal post core 870 may maintain an orientation of perineal post bolster 880, which may be disposed on perineal post core 870. With reference to FIGS. 58-61 according to exemplary embodiments, perineal post bolster 880 may be non-circular. Perineal post bolster 880 may receive perineal post cover 882 (not shown), which may also be non-circular. Accordingly, perineal post bolster 880 and perineal post cover 882 may be non-circular. For example, perineal post bolster 880 and perineal post cover 882 may include a saddle shape 884. Saddle shape 884 may provide a structure for legs 32 (FIG. 17) to rest around perineal post bolster 874. As shown, saddle shape 884 may include curvatures on either side of a raised portion to support legs 32 as legs 32 are disposed around perineal post bolster 874.

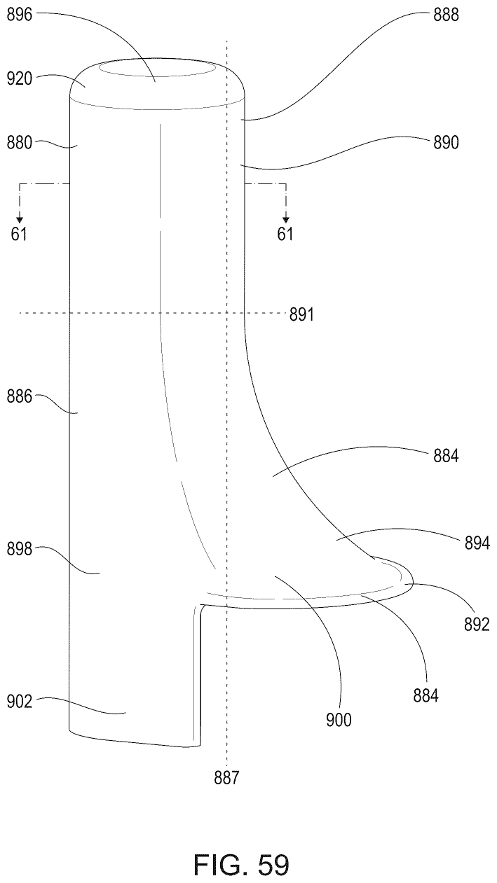

Saddle shape 884 may be considered the portion of perineal post bolster 880 extending above an extension 902 of perineal post bolster 880. Referring to FIG. 59, saddle shape 884 may include a top portion 896 and a bottom portion 898 opposing top portion 896. Saddle shape 884 may extend vertically between top portion 896 and bottom portion 898. Bottom portion 898 may be wider than top portion 896. In other words, bottom portion 898 may extend horizontally, into and away from the sheet of FIG. 59, to a greater extent than top portion 896. Top portion 896 may be generally circular.

In addition to top portion 896 and bottom portion 898, saddle shape 884 may include a distal end 886 and a proximal end 888 opposing distal end 886. Distal end 886 may extend distally from a centerline 891 of perineal post bolster 880. Proximal end 888 may extend proximally from centerline 891. Proximal end 888 may include a top portion 890 and a bottom portion 898 opposing top portion 890. Top portion 890 may extend vertically upward from a centerline 891 of perineal post bolster 880. Bottom portion 898 may extend vertically downward from centerline 891. Top portion 890 may be generally vertical. In other words, top portion 890 may extend vertically upward from centerline 891 without also extending proximally. Bottom portion 898 may extend vertically downward from centerline 891 while also extending proximally. As shown, bottom portion 898 may include a curvature 894 extending from top portion 890 to a proximal edge 895.

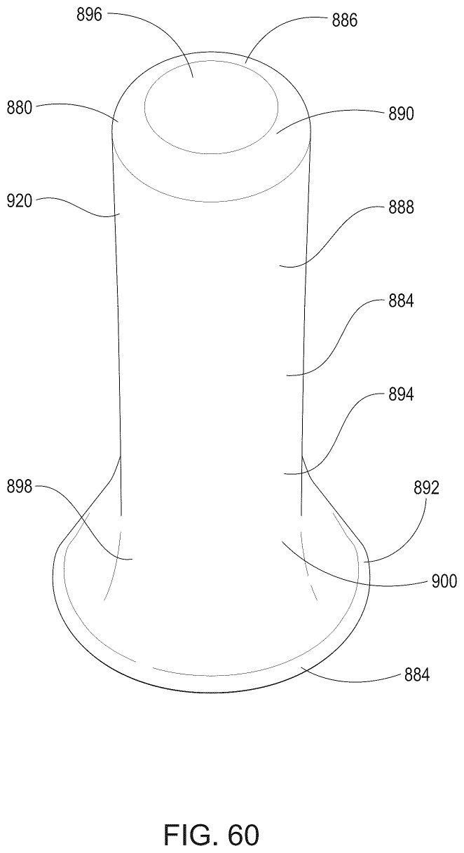

Perineal post bolster 880 may include bottom portion 898 curving both proximally and horizontally as bottom portion 898 extends vertically downward from centerline 891 to form saddle shape 884. Distal end 886 may face toward torso 26 (FIG. 17) of patient 20 (FIG. 18). Accordingly, as shown in FIG. 60, saddle shape 884 may face toward torso 26 such that legs 32 rest along saddle shape 884 as they straddle perineal post bolster 880. Saddle shape 884 may remain facing patient 20. As perineal post bolster 880 may be secured to perineal post core 870 (FIG. 56), the non-circular shape of opening 856 (FIG. 50) and perineal post core 870 may maintain an orientation of saddle shape 884 towards patient 20.

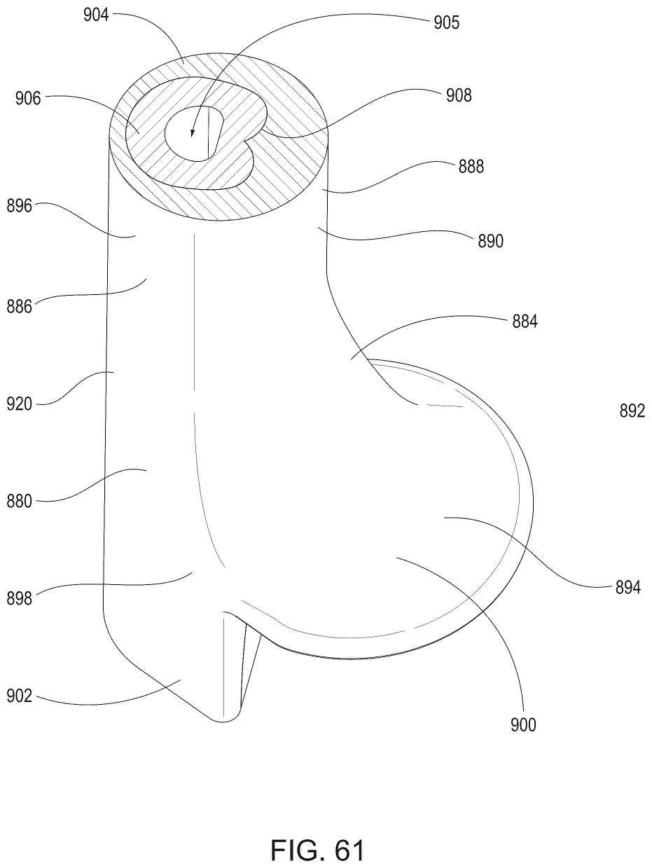

Perineal post bolster 880 may be constructed to advance comfort for patient 20 (FIG. 18). Referring to FIG. 61 according to exemplary embodiments, perineal post bolster 880 may include one or more materials to cushion patient 20. As shown, perineal post bolster 880 may include a post opening 905 to receive perineal post core 870 (FIG. 55). Perineal post bolster 880 may include one or more materials surrounding post opening 905. The one or more materials may be formed in layers. Perineal post bolster 880 may include a first layer 906 surrounding post opening 905. Perineal post bolster 880 may include a second layer 904 surrounding first layer 906. First layer 906 may be a first foam. Second layer 904 may be a second foam. The foam materials may be cushioning for patient 20. The second foam may be softer than the first foam. In this way, the patient 20 may experience additional comfort as patient 20 may be proximate to the second foam in second layer 904.

Construction of first layer 906 and second layer 904 may also advance cushioning. First layer 906 may include a groove 908. Second layer 904 may be proximate first layer 906 at groove 908. In this way, groove 908 may include the second foam. Groove 908 may be generally V-shaped. In addition, groove 908 may extend vertically along perineal post bolster 880. Groove 908 may be positioned proximate a perineal area of patient 20 (FIG. 18). Accordingly, softer foam along second layer 904 that may fill groove 908 may facilitate cushioning of patient 20 and reduce or eliminate risk of perineal nerve damage.

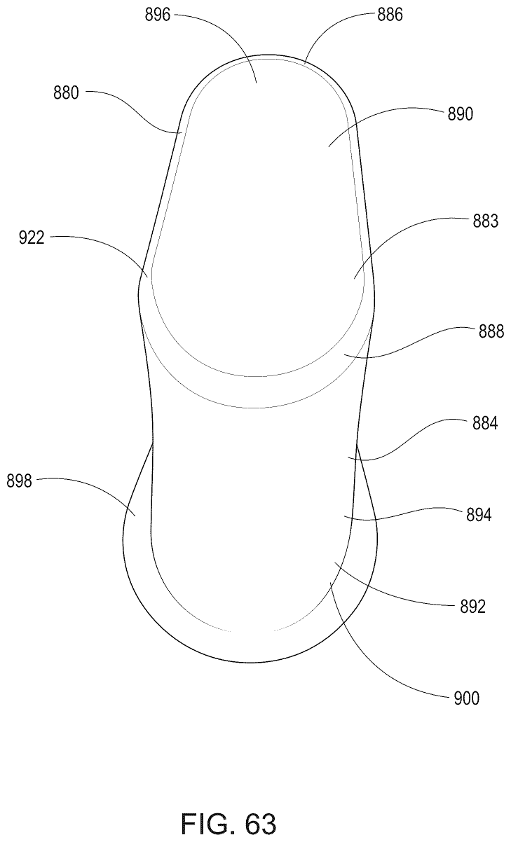

With reference to FIGS. 55-61, perineal post 874 may be configured for patient 20 (FIG. 18) in a supine position. Perineal post bolster 880 may be configured for patient 20 in the supine position. In FIGS. 55-61, perineal post bolster 880 may be a supine bolster 920. In FIGS. 621-63 according to exemplary embodiments, perineal post bolster 880 may be a scope bolster 922. Scope bolster 922 may be used during invasive surgeries. As shown, scope bolster 922 may be similar to supine bolster 920 (FIGS. 58-10). However, scope bolster 922 may include an extended saddle shape 883. Extended saddle shape 883 may be similar to saddle shape 884 (FIGS. 58-61). However, extended saddle shape 883 may be elongated in comparison. For example, distal end 886 may extend distally to a greater extend. Distal end 886 may extend horizontally, into and away from the sheet, to a lesser extent than proximal portion 888. accordingly, top portion 896 may be generally non-circular, as shown in FIG. 63. For example, top portion 896 may be generally oval-shaped. The oval shape may be asymmetrical between distal end 886 and proximal end 888. Proximal end 888 at top portion 896 may have a larger diameter than distal end 886 at top portion 896.

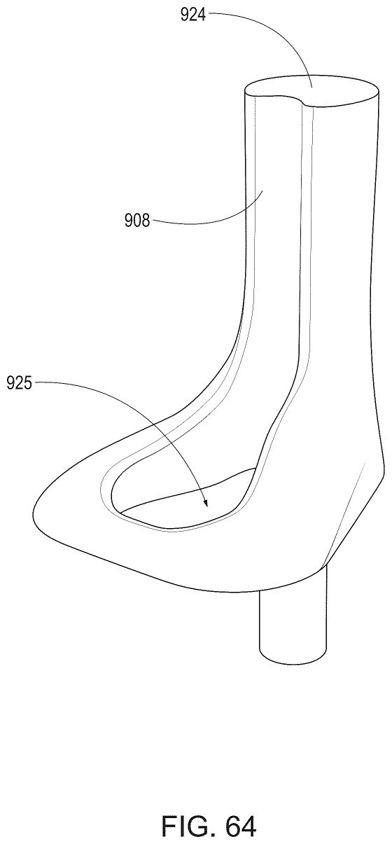

Perineal post 874 may also be configured for the prone position. Referring to FIG. 64 according to exemplary embodiments, a prone bolster 924 may be used when patient 20 is in the prone position, or facing down. Prone bolster 924 may include an opening 925 to receive patient 20 genitals to advance comfort for patient 20. In one embodiment, prone bolster 924 may include first foam 904 (FIG. 60) and second foam 906 (FIG. 60). First foam 904 may include vertical groove 908. Second foam 908 may be disposed in vertical groove 908 and may encircle first foam 904. First foam 904 and second foam 906 may not fill opening 925 such that opening 925 may be accessible.

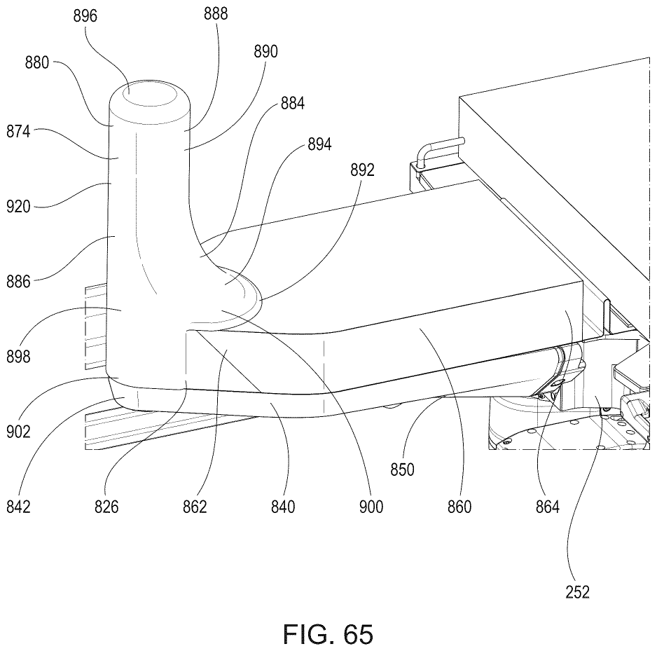

Referring to FIGS. 55-64, perineal post core 870 may receive supine bolster 920, scope bolster 922, or prone bolster 924. Perineal post core 870 may receive supine bolster 920 and then scope bolster 922 for another procedure. In this way, perineal post core 870 may be constant and may receive different bolsters 874 across surgical procedures, e.g., supine bolster 920, scope bolster 922, or prone bolster 924. Bolsters 874 may be installed onto perineal post core 870 without needing tools. Accordingly, one operator alone may install bolster 874 onto perineal post core 870 in a toolless process. Perineal post core 970, perineal post bolster 880, and perineal post cover 882 (not shown) may be assembled together to form perineal post 874. Perineal post 874 may be then couple to pelvic center board 840, as shown in FIG. 65 according to exemplary embodiments.

As discussed, perineal post bolster 880 may include an extension 902. Extension 902 may extend below saddle shape 884. Extension 902 may be disposed over distal end 842 of pelvic center board 840. Pelvic center board 840 may receive pad 860 that may be disposed between pelvic center board 840 and perineal post bolster 880. Proximal end 888 may be disposed over pad 860. Pad 860 may extend distally to extension 902. In this way, pad 860 does not extend to cover opening 856 (FIG. 49) of pelvic center board 840. Pad 860 therefore does not include an opening to cover opening 856 such that perineal post core 870 may be received. Instead, pad 860 may be snipped such that pad 860 terminates between distal end 842 and proximal end 862 of pelvic center board 840. In this way, pad 860 may accommodate bolster 874 without having openings to receive bolster 874 or its components.

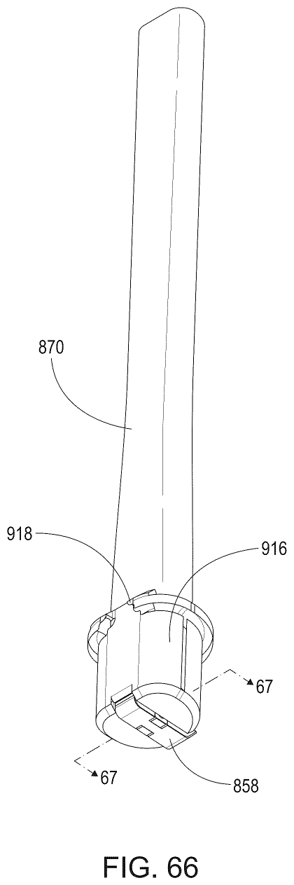

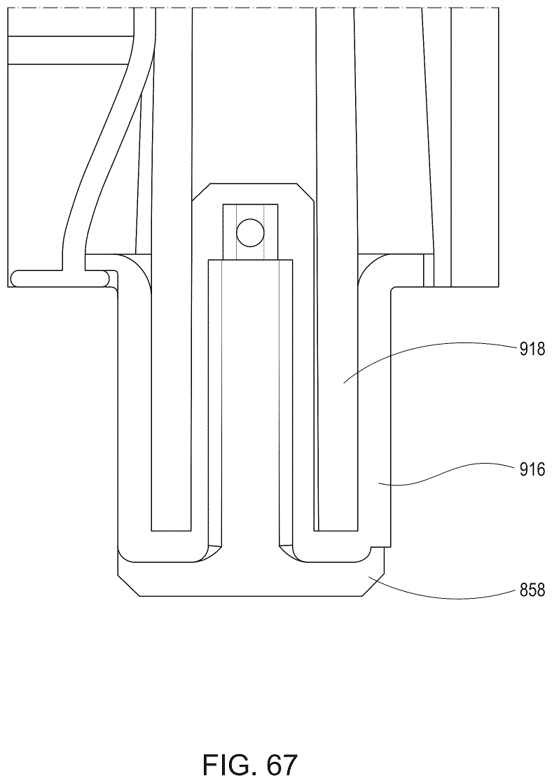

Perineal post 874 may fit within opening 856 (FIG. 49) of pelvic center board 840 such that a non-nominal force is required to remove perineal post 874. Additionally or alternatively, perineal post 874 may be latched to retain perineal post 874 in opening 856. With reference to FIGS. 66-67 according to exemplary embodiments, perineal post sleeve 916 may include a latch 858. Latch 858 may consist essentially of carbon fiber. In other words, latch 858 may be composed mostly or entirely of carbon fiber. Latch 858 may be mechanically actuated.

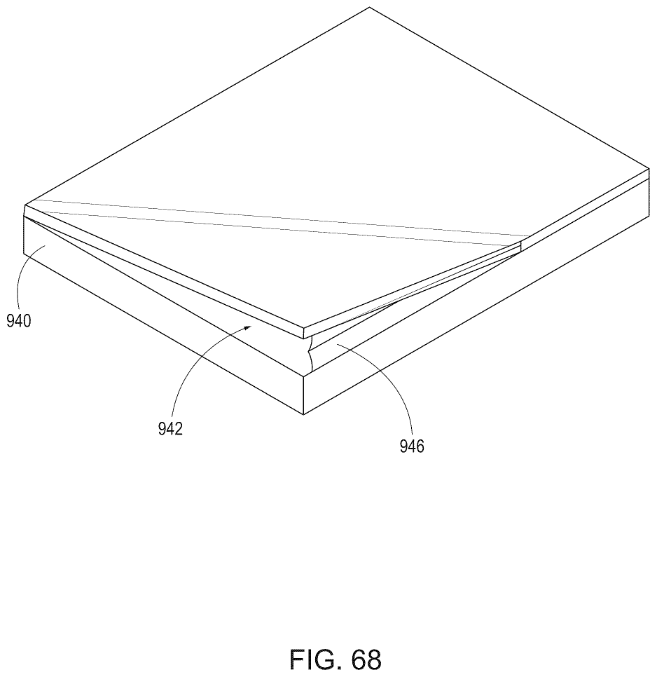

As discussed, pelvic center board 840 (FIG. 64) may receive pad 860 (FIG. 64). Alternatively, pelvic center board 840 may receive a pelvic combo pad 940 shown in FIG. 68 according to exemplary embodiments. Pelvic combo pad 940 may be disposed along center portion 846 of pelvic center board 840 to support at least a pelvic area of patient 20 (FIG. 18). For example, pelvic combo pad 940 may support portions of patient 20 to accommodate a broken pelvis. Additionally, pelvic combo pad 940 may be disposed over one or more lateral portions 848 (FIG. 54). As shown, pelvic combo pad 940 may include an opening 942. Opening 942 may receive an insert 944 (not shown), or a cushion, to adjust a portion of patient 20, such as the pelvis and hips, prior to draping. Insert 944 may be added through opening 264 to center portion 262 to provide additional support to patient 20 along this area. Insert 944 may be disposed laterally into opening 942. Pelvic combo pad 940 may also include an opening restraint 946 to limit extension of opening 942 to retain insert 944 within pelvic combo pad 940. Opening restraint 946 may be expanded up to about three inches, such as up to about two inches. Pelvic combo pad 940 may not have sewn seams on top facing edges to minimize fluid penetration. Pelvic combo pad 940 may be secured to pelvic center board 840 via a fastener, such as adhesive or a hook and loop fastener, for example.

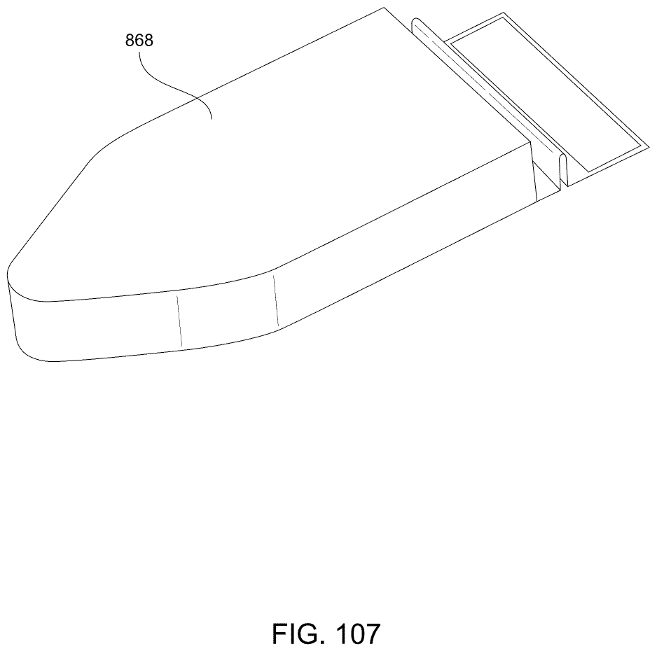

Alternatively, pelvic center board 840 (FIG. 64) may receive a postless pad 868 shown in FIG. 107 according to exemplary embodiments. Postless pad 868 may support at least a pelvic area of patient 20 (FIG. 18). Postless pad 868 does not have an opening for perineal post 874 (FIG. 66).

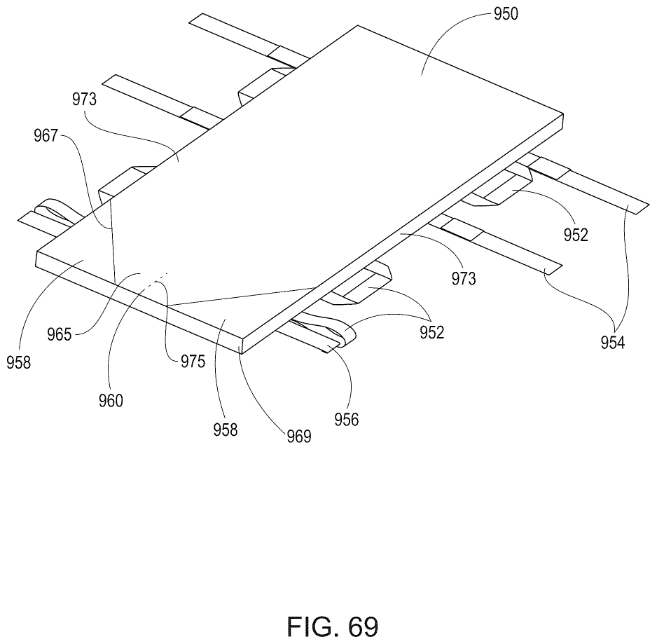

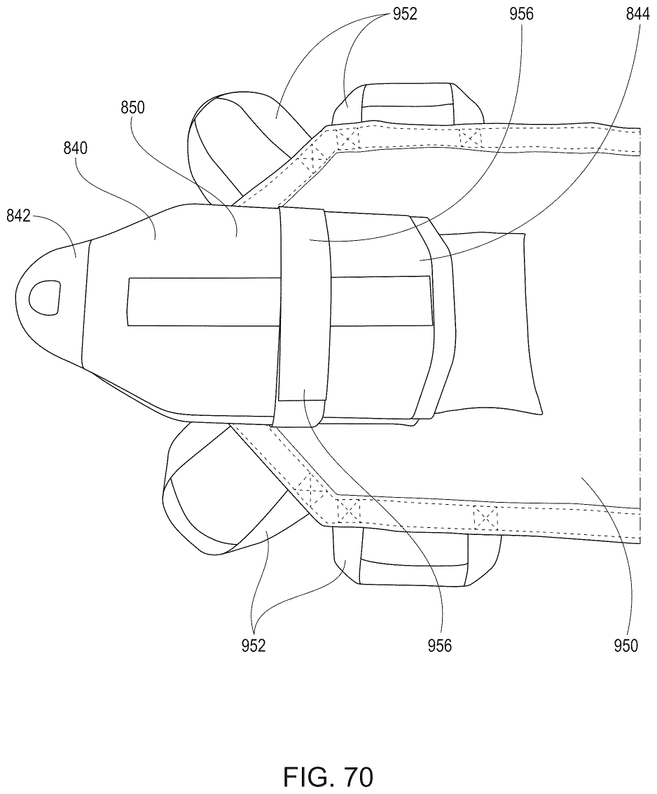

A traction pad 950 is shown in FIG. 69 according to exemplary embodiments. Traction pad 950 may include one or more positioning handles 952 to facilitate placing traction pad 950 along platform 220 (FIG. 1), in some embodiments, while supporting patient 20. Traction pad 950 may be disposed along platform 220. Traction pad 950 may include one or more side rail straps 954 to secure to rails 226 (FIG. 1) of surgery table 200 (FIG. 1). In addition, traction pad 950 may include one or more pelvic center board straps 956 to couple traction pad 950 to pelvic center board 840 (FIG. 64). As shown in FIG. 70 according to exemplary embodiments, pelvic center board straps 956 may secure around bottom portion 850 of pelvic center board 840 via fastener, such as adhesive or a hook and loop fastener, for example.

Traction pad 950 may be disposed along center portion 846 of pelvic center board 840 to support at least a pelvic area of patient 20 (FIG. 18). Additionally, traction pad 950 may be disposed over one or more lateral portions 848 (FIG. 54). Referring to FIG. 69, traction pad 950 may include one or more removable hip components 950 at a distal end 965 of traction pad 950. One or more removable hip components 950 may be removable from traction pad 950. For example, one or more removable hip components 958 may include partial cuts or perforations 967 extending at opposite angles from a distal edge 969 to respective sides 973 of traction pad 950 for removability such that one or more angled corners are formed at the perforations 967 when the one or more removable hip components 958 are removed. One or more removable hip components 958 may be removable when lateral portions 848 are articulated, such as in anterior direction 105 (FIG. 1) or posterior direction 107 (FIG. 1). In certain embodiments, one of removable hip components 958 may be removed at one of perforations 967 to allow a surgeon access to an operative hip, while the other removable hip component 958 remains in place under the non-operative hip.

Traction pad 950 may also include a post access 960 on distal end 965 extending from distal edge 969 thereof. Post access 960 may include a slit perforation to accommodate components within post access 960. For example, post access 960 may open at slit perforations 975 to allow bolster 874 (FIG. 54) to be accommodated. Traction pad 950 may be made of foam that may conform around bolster 874. Traction pad 950 may sit on top of saddle shape 884 (FIG. 57) of bolster 874 to provide a smooth surface on which patient 20 (FIG. 18) is positioned. Alternatively, traction pad 950 may extend below saddle shape 884. Accordingly, traction pad 950 may be disposed between pelvic center board 840 (FIG. 64) and bolster 874. Additionally, traction pad 950 may be disposed between pad 860 (FIG. 64) and bolster 874 if traction pad 950 is used on top of pad 860. Like pad 860, traction pad 950 may be snipped such that traction pad 950 does not terminate with distal end 842 (FIG. 64) of pelvic center board 840. In this way, traction pad 950 may accommodate bolster 874 without having openings to receive bolster 874 or its components.

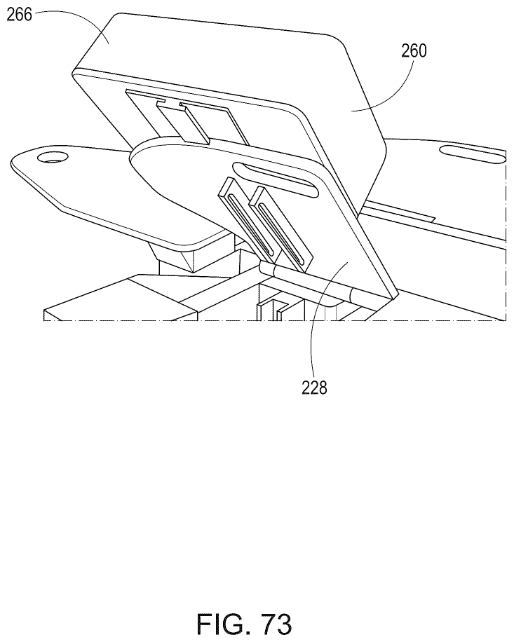

Traction pad 950 may be a lateral traction pad for lateral positioning. The lateral traction pad may couple to flaps 228 (FIG. 73). Traction pad 950 may additionally or alternatively be for prone positioning. Here, traction pad 950 may couple to flaps 228. Flaps 228 will be described further below.

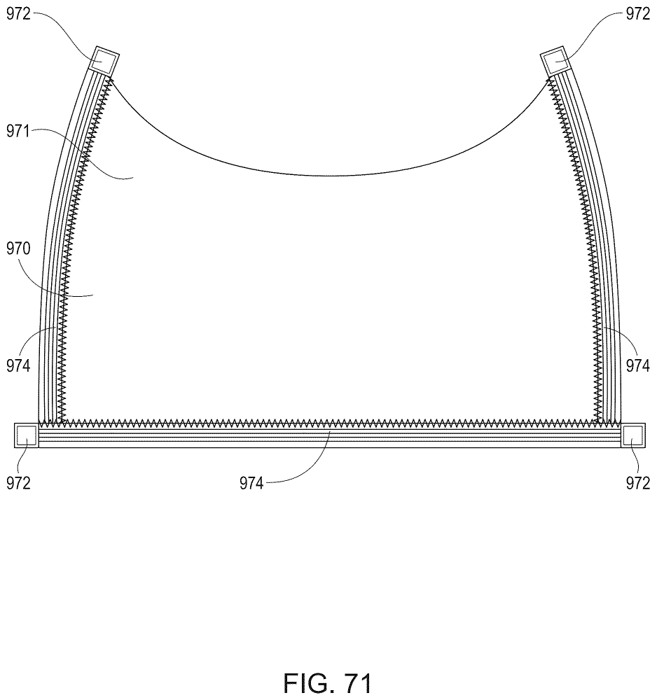

A wrapper 970 is shown in FIG. 71 according to exemplary embodiments. Wrapper 970 may support at least a portion of patient 20 (FIG. 18). Wrapper 970 may include a stretch portion 971 that may be generally square-shaped when unstretched. Wrapper 970 may include one or more attachment points 972 disposed at each corner of stretch portion 971. Wrapper 970 may include a stiction trim 974 to adhere to patient 20.

Stretch portion 971 may be stretched, or expanded, to wrap around a portion of patient 20, such as the pannus tissue. At least two attachment points 972 may be coupled together to hold at least a portion of patient 20 (FIG. 18) in wrapper 970 such as about four attachment points 972. Two bottom attachment points 972 may extend to lateral sides of a lower abdomen region of patient 20 and attach to surgery table 200 (FIG. 1), for example at handles 236 (FIG. 1) on either side of surgery table 200. Two top attachment points 972 may extend along a shoulder or upper torso of patient 20 and attach elsewhere on the surgery table 200, for example rails 226 (FIG. 1) on either side of surgery table 200. Therefore, wrapper 970 may form a sling for the pannus tissue, biasing pannus tissue away from the hip and/or pelvis of patient 20. Additionally or alternatively, attachment points 972 may couple to other fasteners along surgery table 200 (FIG. 1).

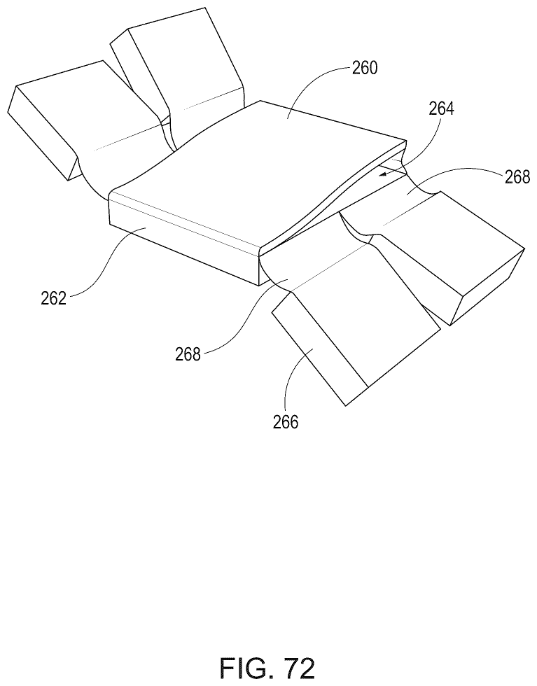

Trunk pad 260 is shown in FIG. 72 according to exemplary embodiments. As discussed, trunk pad 260 may be disposed along platform 220 (FIG. 1) of surgery table 200 (FIG. 1). Trunk pad 260 may support at least a portion of patient 20 (FIG. 18), such as at least a torso 26 (FIG. 20) of patient 20. Trunk pad 260 may include a flexible, cushioning material. Trunk pad 260 therefore may provide support and prevent pressure injuries. Trunk pad 260 may include a center pad 262. Center pad 262 may be disposed under at least a portion of torso 26. Trunk pad 260 may also include an opening 264. Opening 264 may be formed in center pad 262. Opening 264 may receive an insert, or a cushion, to provide additional support to at least a portion of patient 20. For example, patient 20 may be positioned laterally and may require additional support along a waist area or a back area. The insert may be added through opening 264 to center portion 262 to provide additional support to patient 20 along these areas. Inserts therefore may provide support and prevent pressure injuries. Inserts may be generally wedge shaped, rounded, polygonal, or any other shape, for example.

Trunk pad 260 may also include one or more lateral pads 266. Lateral pads 266 may extend from center pad 262 in lateral direction 104 (FIG. 1), for example. Lateral pads 266 may support at least a portion of patient 20. For example, at least a portion of patient 20 may extend laterally from center pad 262. Lateral pads 266 may provide support to patient 20 accordingly. Trunk pad 260 may also include one or more hammock attachments 268. Lateral pads 266 mat be coupled to center pad 262 via hammock attachments 268. Each hammock attachment 268 may include a length of flexible material to adjust the extension of the respective lateral pad 266 relative to center pad 262 in medial direction 102 (FIG. 1) and lateral direction 104. For example, lateral pad 266 may extend further laterally. Surgery table 200 may include about two lateral pads 266 along each lateral side, such as first side 206 (FIG. 1) and second side 208 (FIG. 1). Alternatively, surgery table 200 may include about three lateral pads 266 along each lateral side, such as first side 206 (FIG. 1) and second side 208 (FIG. 1). Each lateral pad 266 may be individually adjustable separate from other lateral pads 266.

Surgery table 200 (FIG. 1) may include one or more components to receive trunk pad 260. Platform 220 (FIG. 1), for example, may receive at least a portion of trunk pad 260, such as center pad 262. Surgery table 200 may also include one or more lateral flaps 228, shown in FIG. 73 according to exemplary embodiments. Lateral flaps 228 may extend from platform 220 in lateral direction 104 (FIG. 1). Alternatively, lateral flaps 228 may be formed as part of platform 220 such that lateral flaps 228 replace first static flap 214 (FIG. 2) and second static flap 216 (FIG. 2). Lateral flaps 228 may receive lateral pads 266. Lateral flaps 228 may be translatable and rotatable. Lateral pads 266 may be translatable and rotatable with lateral flaps 228. Lateral flaps 228 may each be independently articulable.

Lateral flaps 228 may be translatable such that the position of each lateral flap 228 relative to platform 220 is adjustable in medial direction 102 (FIG. 1) and lateral direction 104 (FIG. 1). For example, lateral flaps 228 may translate out of platform 220, such as in lateral direction 104. Lateral flaps 228 may translate in medial direction 102 back into platform 220. Lateral flaps 228 may translate out of platform 220 up to about five inches, such as about four inches. Lateral flaps 228 may translate out of platform 220 incrementally, such as in about one inch increments, such as in about half an inch increments.

In addition, lateral flaps 228 may be rotatable. Accordingly, the pitch of lateral flaps 228 relative to platform 220 may be adjustable. In other words, lateral flaps 228 may be rotatable such that the position of each lateral flap 228 relative to platform 220 is adjustable in anterior direction 105 (FIG. 1) and posterior direction 107 (FIG. 1). Lateral flaps 228 may be rotatable continuously. Additionally or alternatively, lateral flaps 228 may be rotatable incrementally. Lateral flaps 228 may pitch in anterior direction 105 up to about 90 degrees, such as up to about 75 degrees. Lateral flaps 228 may pitch in anterior direction 105 incrementally, such as between about three degree and about eight degree increments, such as between about four degree and about six degree increments, such as in about five degree increments.

Lateral flaps 228 may be translatable and rotatable via a single control, or user interface, and configured such that a user may manipulate the single control with a single hand. In this way, lateral flaps 228 may be selectively disposed on surgery table 200, such as platform 220. In addition, the position of lateral flaps 228 may be adjusted according to patient 20 being on platform 220. For example, if patient 20 is larger, lateral flaps 228 may be located laterally from platform 220 to support patient 20.

Surgery table 200 may include about two lateral flaps 228 along each lateral side, such as first side 206 (FIG. 1) and second side 208 (FIG. 1). Alternatively, surgery table 200 may include about three lateral flaps 228 along each lateral side, such as first side 206 (FIG. 1) and second side 208 (FIG. 1). Each lateral flap 228 may be individually adjustable separate from other lateral flaps 220.

Referring to FIGS. 72-73, in one embodiment, when patient 20 (FIG. 18) is supine, all lateral flaps 228 may be lowered all of the way. In other embodiments, when patient 20 is supine, all lateral flaps 228 may be raised at some increment in order to cradle the body of patient 20. Lateral flaps 228 may be adjusted in medial direction 102 (FIG. 1) and lateral direction 104 (FIG. 1) to accommodate different sized patients 20. For example, lateral flaps 228 may be adjusted to translate laterally to accommodate larger sized patients. In other embodiments, when patient 20 is prone, all lateral flaps 228 may be lowered all of the way. In other embodiments, when patient 20 is prone, all lateral flaps 228 may be raised at some increment in order to cradle the body of patient 20, and lateral flaps 228 may be adjusted in the medial direction 102 and lateral direction 104 to accommodate different sized patients. In still further embodiments when patient 20 is prone, lateral flaps 228 may be raised at some increment in order to cradle the body of patient 20, and used in combination with trunk pads 260 and hammock attachment 268. In still further embodiments, when patient 20 is lying laterally, one side of lateral flaps 228 may be raised to support the back of patient 20, while the other side of lateral flaps 228 may be lowered, or alternatively, also raised to support the front side of patient 20. In any position, the proximal most lateral flap 228 may be lowered to accommodate one or more arms 22 (FIG. 20) of patient 20.

Pads, liners, and wrappers discussed herein, e.g., foot support pads, liners, wrapper, 970, pelvic center board pad 860, and trunk pad 260 may be disposable. Accordingly, pads, liners, and wrappers may be single use and sterile. Pads, liners, and wrappers may be part of positioning system 100. In another example, pads, liners, wrappers, and boards may be a part of surgery table 200. In another example, pads, liners, wrappers, and boards may function separately, such as with other positioning systems, surgery tables, or apparatuses thereof. In an example, pads, liners, wrappers, and boards may include features that are functional separately and in combination.

Other components of positioning system 100 may include covers and restraints. Covers discussed herein, e.g., a shoulder cover 550, an elbow cover 552, and an end cover 554, and restraints, e.g., an arm restraint 376, a torso restraint 378, and a leg restraint 382, may be part of positioning system 100. In another example, covers and restraints may be a part of surgery table 200. In another example, covers and restraints may function separately, such as with other positioning systems, surgery tables, or apparatuses thereof. In an example covers and restraints may include features that are functional separately and in combination.

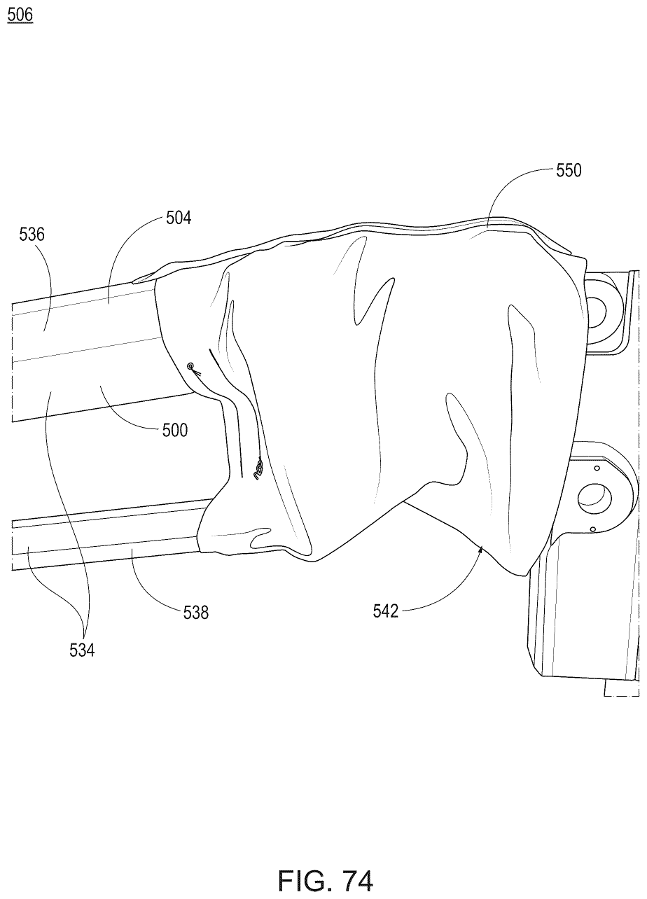

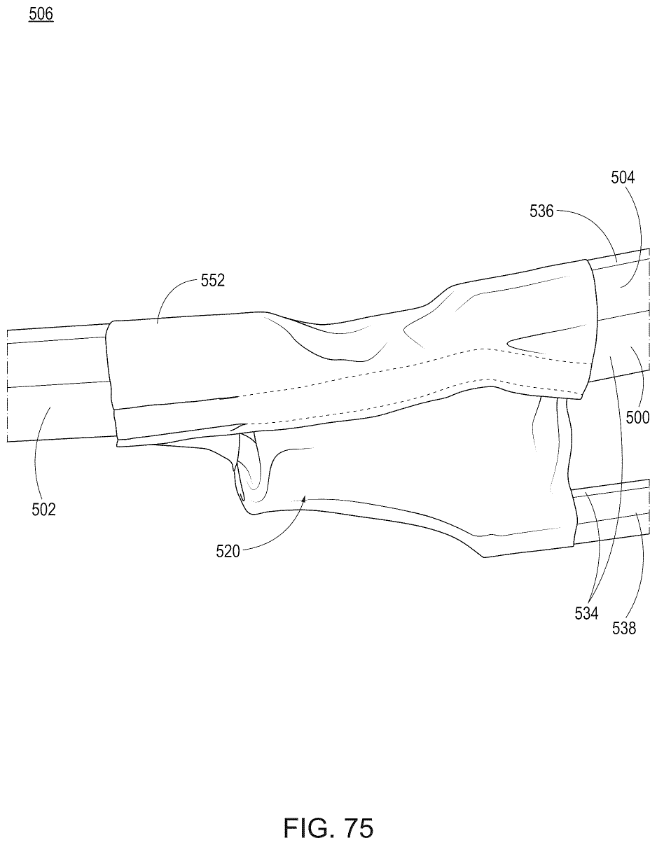

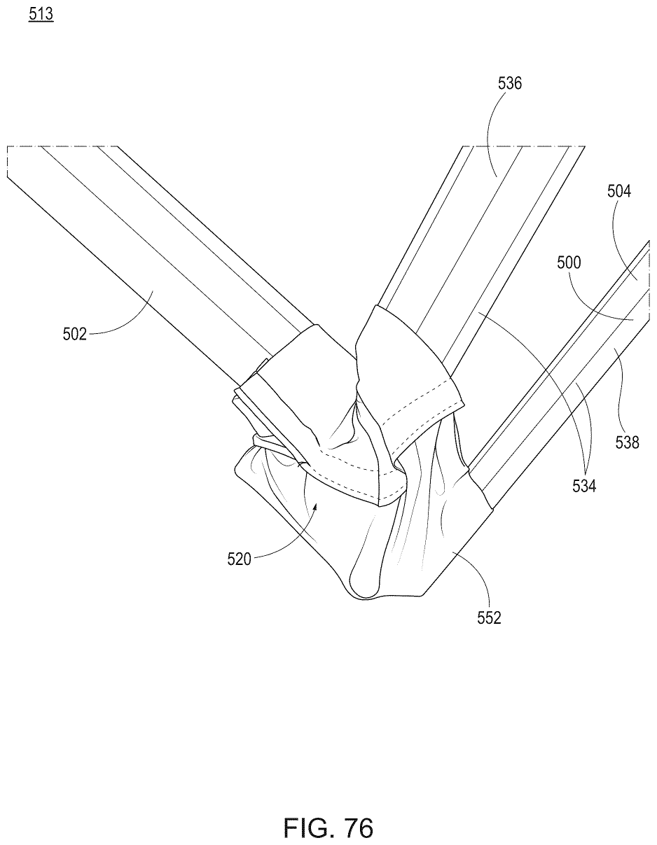

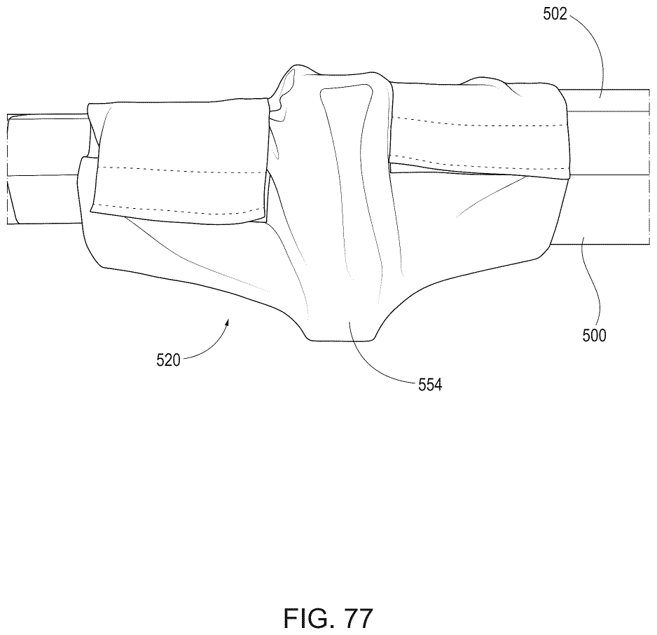

Covers may be disposable. Accordingly, covers may be single use and sterile. Covers may cover at least a portion of positioning system 100 (FIG. 1), such as a portion of surgery table 200 (FIG. 1), such as a portion of spar 500 (FIG. 3), or components thereof. For example, covers may be disposed over joints. In another example, covers may be disposed over subsystems of positioning system 100. In this way, covers maintain cleanliness of components during a surgical procedure and with repeated use. Example covers are shown in FIGS. 74-77 according to exemplary embodiments. FIG. 74 shows shoulder cover 550. Shoulder cover 550 may cover at least a portion of spar 500 (FIG. 3), such as a portion of proximal end 504 (FIG. 3) of spar 500. Shoulder cover 550 may cover at least a portion of spar base 400 (FIG. 1). In this way, shoulder cover 550 may cover at least a portion of one or more joints 420 (FIG. 14). Accordingly, shoulder cover 550 may cover at least a portion of spar 500 proximate to one or more joints 420. Shoulder cover 550 may thus protect one or more joints 420. FIG. 75-76 shows elbow cover 552. Elbow cover 552 may cover at least a portion of joint 520 (FIG. 3). FIG. 61 shows end cover 554. End cover 553 may cover at least a portion of distal end 502 (FIG. 3) of spar 500.

Referring to FIGS. 18-23, restraints may be used with patient 20. Restraints may be used to maintain patient 20 on surgery table 200. Restraints may be used in multiple surgical procedures such that they are reusable. Accordingly, restraints may be non-sterile. Restraints may maintain patient 20 on surgery table 200 and components thereof so that patient 20 does not fall off surgery table 200. Restraints may include hook and loop fasteners to be adapted for different sized patients.

As shown in FIG. 228, arm restraint 376 may be secured around at least a portion of arm 22 of patient 20. Arm 22 may be disposed on an arm board 372, which may extend laterally from surgery table 200, such as platform 220. An arm board pad 374 may be disposed on at least a portion of arm board 372. Accordingly, arm restraint 376 may be secured around at least a portion of arm 22, arm board 372, and arm board pad 374 to maintain arm 22 on surgery table 200. Arm board 372 may be substantially similar to or identical to arm boards described in U.S. Provisional Application No. 63/712,499 filed Oct. 27, 2024 titled “Arm Support for Surgical Positioning,” U.S. Provisional Application No. 63/769,459, and U.S. patent application Ser. No. 19/370,591 filed Oct. 27, 2025 titled “Arm Support for Surgical Positioning,” which are hereby incorporated by reference in their entireties.

Also as shown, torso restraint 26 may be secured around at least a portion of torso 26. Torso restraint 26 may couple to a handle 236 disposed on surgery table 200, such as lateral sides of surgery table 200, such as first side 206 and second side 208. Accordingly, torso restraint 26 may extend between handles 236 around at least a portion of torso 26 to maintain torso 26 on surgery table 200. Also as shown, leg restraint 382 may be secured around at least a portion of leg 32. Leg 32 may be disposed on spar board 590, which may be disposed on spar 500. Spar board pad 592 may be disposed on at least a portion of spar board 590. Accordingly, leg restraint 382 may be secured around at least a portion of leg 32, spar board 590, spar board pad 592, and spar 500 to maintain leg 32 on spar 500. Thus, leg restraint 382 may be used to secure non-operable leg 32.

Various controls are shown with reference to FIGS. 38 and 78-81 according to exemplary embodiments. In an example, controls may be part of positioning system 100. In another example, controls may be a part of surgery table 200. In another example, controls may function separately, such as with other positioning systems, surgery tables, or apparatuses thereof. In an example, controls may include features that are functional separately and in combination.

As shown in the embodiment of FIG. 38 handle 560 may include one or more buttons, such as control 562, control 564, and control 565, to unlock various aspects of spar 500 (FIG. 3) to allow spar 500 to be articulated. Handle 560 may be disposed on distal end 502 (FIG. 3) of spar 500. Accordingly, handle 560 may be easily accessed by user 40 (FIG. 23). In one embodiment, the functions of handle 560, control 562, control 564, and control 565 may be dependent on which table module 340 (FIG. 1) is coupled to spar 500. For example, attaching foot support module 350 to UAI port 300 may allow for spar 500 articulation in pitch, yaw, and translation motions from handle 560, control 562, control 564, and control 565. Alternatively, spar 500 articulation in flex, pitch, yaw, and translation motions from handle 560, control 562, control 564, and control 565 may be allowed. In other words, positioning system 100 (FIG. 1), such as table 200 (FIG. 1), or components thereof, may communicate with table module 340. Depending on which table module 340 is attached, a computer system in positioning system 100, such as table 200, or components thereof, may change the function control 562, control 564, and control 565, to enable or disable certain motions including flex, pitch, yaw, and translation motions of spar 500.

In one embodiment, actuating control 565 may allow for spar 500 (FIG. 3) articulation in translation and yaw motions, or any motion that is not pitch or gravity-assisted. Actuating control 562 or control 564 may allow for spar 500 articulation in pitch motion. In one embodiment, control 562 or control 564 may be actuatable, or actuating control 562 or control 564 may acuate pitch, only when control 565 is actuated first. Accordingly, control 562 and control 564, or the pitch function of control 562 and control 564, may be locked until control 565 is actuated. In one embodiment, both control 562 and control 564 may allow for pitch motion of spar 500 to accommodate the handedness of user 40 (FIG. 23). In other embodiments, actuating control 565 and either control 562 and control 564 may allow for spar 500 to be flexed. Spar 500 may only be flexed by actuating control 565 and either control 562 or control 562 if foot support module 350 is coupled to spar 500.

Control 562, control 564, and control 565 may be toggled or momentarily actuated. In one embodiment, control 562 or control 564 may be pressed once to release pitch motion and pressed once again to lock pitch motion. Similarly, control 565 may be pressed once to release yaw and translation motions and pressed once again to lock yaw and translation motions. In another embodiment, holding control 562, control 564, and control 565 may allow the respective motion(s) to be engaged such that spar 500 is articulable in the respective motion(s) only when such button is being pressed. Releasing control 562, control 564, and control 565 thereafter may lock the respective motion(s).

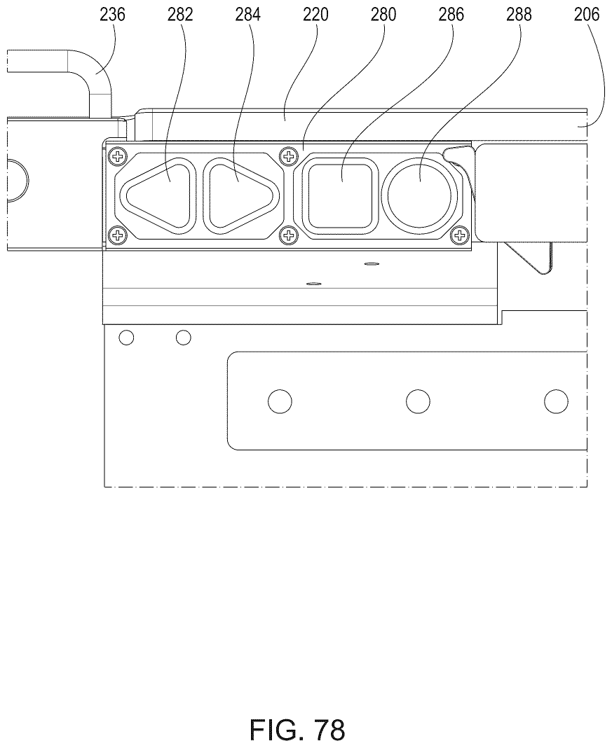

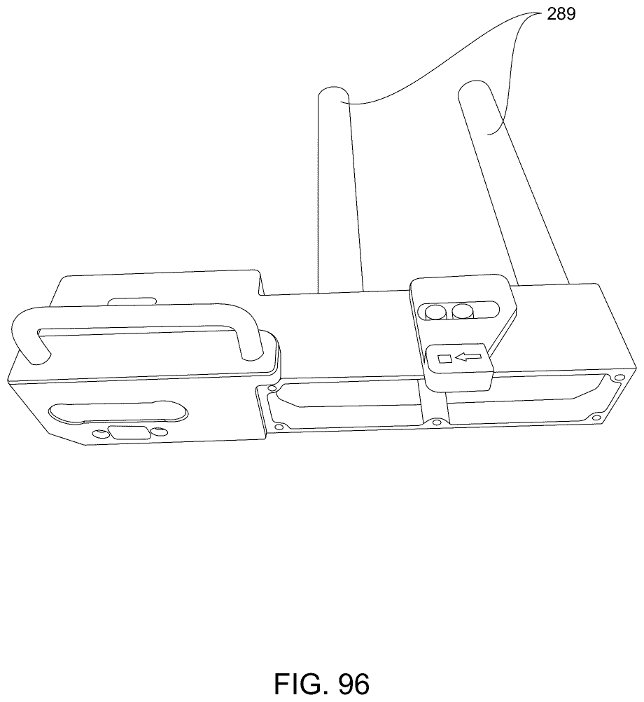

In one embodiment, one or more traction controls 280 shown in FIG. 78 may include one or more functionalities of handle 560 (FIG. 38). Traction controls 280 may be disposed along surgery table 200, such as along platform 220. Traction controls 280 may be extendable laterally from surgery table 200 with one or more traction control extensions 289 shown in FIG. 96 according to exemplary embodiments. Traction control extensions 289 may facilitate coupling traction controls 280 to surgery table 200. Traction control extensions 289 may retract into surgery table 200 or extend further outwardly from surgery table 200, sliding into or out of surgery table 200. In some embodiments, traction control extensions 289 may be locked into position to fix the lateral position of traction controls 280 with respect to surgery table 200. Traction controls 280 may be on the same module as a UAI port 300 (FIG. 38). Accordingly, retracting or extending traction controls 280 may retract or extend UAI port 300. UAI port 300 may be retracted or extended to accommodate different sized patients and receive table modules 340 (FIG. 1) accordingly.

Referring again to FIG. 78, traction controls 280 may include a first control 282. First control 282 may apply an indexed, or predetermined, translation of spar 500 (FIG. 3) to apply a traction load. In other words, pressing first control 282 once may translate spar 500 in one increment in inferior direction 103 (FIG. 1). Pressing first control 282 multiple times may translate spar 500 in corresponding multiple increments. Traction controls 280 may include a second control 284. In one embodiment, pressing second control 284 once may translate spar 500 in one increment in superior direction 101 (FIG. 1). Pressing second control 284 multiple times may translate spar 500 in corresponding multiple increments. Second control 284 may apply an indexed, or predetermined, translation of spar 500 to release at least a portion of the traction load.

Traction controls 280 may include a third control 286. One press of third control 286 may disengage traction mechanism 270 (FIG. 18). In other words, translation of spar 500 from traction mechanism 270 to apply the traction load may be deactivated, e.g., lead screw 272 (FIG. 17) may be neutralized or deenergized. Accordingly, a traction load may then only be applied by user 40 (FIG. 23) manually moving spar 500. Thus, third control 286 may allow for manual translation of spar 500. User 40 may manually position spar 500 before re-engaging traction mechanism 270 by another press of third control 286. Re-engaging traction mechanism 270 may hold the traction applied by user 40, and allows spar traction to be actuated once again by first control 282 and second control 284.

Traction controls 280 may include a fourth control 288. Fourth control 288 may allow for rotation of a foot support to support foot 36 (FIG. 20) of patient 20 (FIG. 18). A single press of fourth control 288 may unlock rotation and leg 32 (FIG. 20) of patient 20 may be rotated manually by user 40 (FIG. 19). Another press of fourth control 288 may lock rotation in the current orientation. Another press of fourth control 288 may lock rotation in the current orientation.

Traction control 286 and traction control 288 may be toggled or momentarily actuated. Accordingly, traction control 286 may be pressed once to disengage traction mechanism 270 (FIG. 18) and pressed once again to engage traction mechanism 270. Similarly, traction control 288 may be pressed once to allow for rotation of a foot support to support foot 36 (FIG. 20) of patient 20 (FIG. 18) and pressed once again to lock rotation. Holding traction control 286 may allow for traction mechanism 270 to be disengaged. Releasing traction control 286 thereafter may engage traction mechanism 270. Similarly, holding traction control 288 may allow for the foot support to be rotated. Releasing traction control 288 thereafter may lock rotation.

Pendant 290 shown in FIG. 79 may include one or more functionalities of handle 560 (FIG. 38), traction controls 280 (FIG. 78), or handle 560 and traction controls 280. Positioning system 100 (FIG. 1), such as surgery table 200 (FIG. 1), or components thereof, may include traction controls 291. For example, pendant 290 may include traction controls 291 to adjust a traction load and to engage or disengage traction. Pendant 290 may also include one or more controls 296 for surgery table 200, such as platform 220 (FIG. 1), to pitch and tilt the same. Pendant 290 may also include one or more controls 294 for articulating articulable pelvic port adapter 246 (FIG. 98) and therefore attachments 240 (FIG. 50) coupled to articulable pelvic port adapter 246. Pendant 290 may also include a display 297. Display 297 may provide user 40 (FIG. 23) with information about positioning system 100, such as surgery table 200, or components thereof. For example, display 297 may indicate that positioning system 100 is configured for knee surgery. Alternatively, display 297 may indicate that positioning system 100 is configured for another surgery, such as general surgery procedure, a specialized surgery procedure, or another orthopedic surgery, such as hip surgery. Table modules 340 (FIG. 1) may indicate which surgery is configured for. For example, foot support module 350 being coupled to spar 500 (FIG. 1) may indicate that knee surgery is configured for. Display 297 may also allow user 40 to reconfigure pedals 314 (FIG. 25). Pedals 314 may be foot switches from which user 40 may actuate different systems or apparatuses.

Pendant 290 may be functional proximate to positioning system 100 (FIG. 1), such as proximate to surgery table 200 (FIG. 1). User 40 (FIG. 23) may hold pendant 290 during at least a portion of a surgical procedure to use its controls. Positioning system 100 (FIG. 1), such as surgery table 200, spar 500 (FIG. 3), or surgery table 200 and spar 500 (FIG. 3) may receive pendant 290. For example, one or more drapes 46 (FIG. 18) may include one or more pockets 298 (not shown). Pockets 298 may receive pendant 290 to control at least articulation of spar 500. In this way, pendant 290 may be disposed in pocket 298 during at least a portion of a surgical procedure so that user 40 does not have to hold pendant 40 or find a location to store pendant 290. Pendant 290 may be disposed in pocket 298 without pocket 298 becoming contaminated from the outside.

Pocket 298 (not shown) may be disposable. Pocket 298 may include a pocket comprised partially or entirely of a film, or partially or entirely of a drape material, and may also include an adhesive, such as a pressure sensitive adhesive, on at least one side. Additionally or alternatively, pocket 298 may include another fastener, such as a button clasp, a magnetic attachment, or a hook and loop fastener. The fastener may facilitate attachment to one or more drapes 46 (FIG. 18). Pocket 298 may be coupled to one or more drapes 46 without damaging drapes 46 to maintain the sterile barrier. Pocket 298 may be selectively attachable. Pocket 298 may be selectively attachable to one or more drapes 46 for positioning system 100 (FIG. 1) along at least one of surgery table 200 (FIG. 1) and spar 500 (FIG. 1), such as along surgery table 200, along spar 500, or along surgery table 200 and spar 500. A plurality of pockets 298 may be disposed along surgery table 200, along spar 500, or along surgery table 200 and spar 500. Pocket 298 may include a sleeve to receive pendant 290 and a flap to fold over the sleeve and cover pendant 290. The flap may be secured to the sleeve with adhesive, such as a pressure sensitive adhesive, or another fastener, such as a button clasp, a magnetic attachment, or a hook and loop fastener.

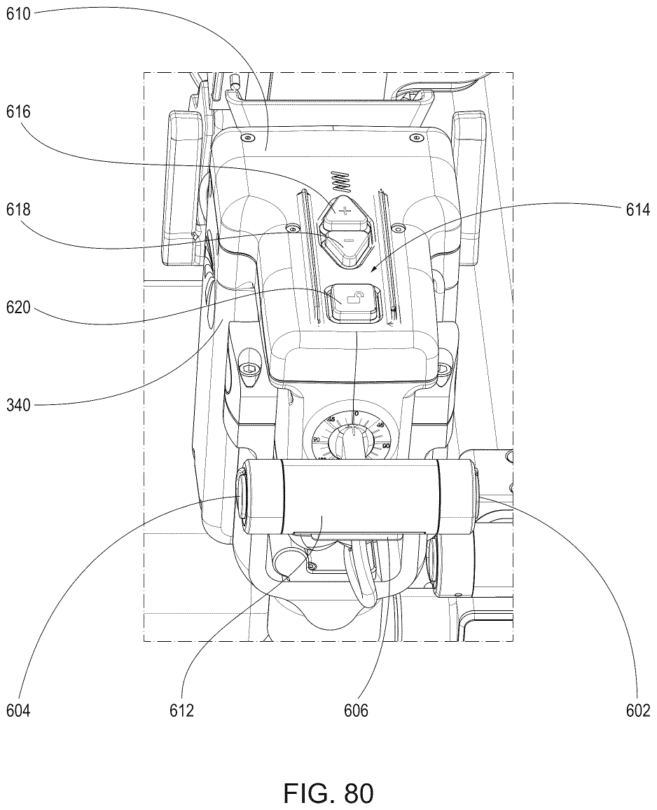

As shown in FIG. 80, table module 340, such as foot support module 610, may include one or more controls with functionalities of handle 560 (FIG. 38), traction controls 280 (FIG. 78), or handle 560 and traction controls 280. Foot support module 610 may include a handle 612. Handle 614 may include a first button 602, a second button 604, and a third button 606.

Foot support module 610 may include one or more traction controls 614 to adjust a traction load and to engage or disengage traction. Traction controls 614 may include a first button 616, a second button 618, and a third button 620. First button 616 and second button 618 may adjust the traction load, and third button 620 may disengage traction. In an embodiment, these buttons may have the same functionality as those discussed with reference to FIG. 78.

First button 602 may allow may allow for rotation of a foot support, such as foot support 640. In one embodiment, this function may enable manipulation of the leg, for example, for hip dislocation in hip surgeries. A single press of first button 602 may unlock rotation. Another press of first button 602 may lock rotation in the current orientation. Similarly, second button 604 may allow for rotation of a foot support, such as foot support 640. A single press of second button 604 may unlock rotation. Another press of second button 604 may lock rotation in the current orientation. In one embodiment, both first button 602 and second button 604 may allow for rotation of foot support 640 to accommodate the handedness of user 40 (FIG. 23). Third button 606 may disengage traction, as discussed with reference to FIG. 78, and allow the user 40 to manually pull traction by pulling on handle 612. Handle 612 also allows user 40 to simultaneously control manual traction and leg rotation by manipulating the buttons 602, 604, 606 and handle 612.

In an embodiment, surgical system 100 includes controls for at least one of traction and rotation of the leg, like those discussed with reference to FIG. 78, in at least two locations. In embodiments, those two locations are proximal to the user 40 while operating on a hip, as discussed with reference to FIG. 78, and also at the end of spar 500 as discussed herein with respect to foot support module 610. In other embodiments, surgical system 100 includes controls for at least one of traction and rotation of the leg at a third location, for example, a control pendant as discussed with reference to FIG. 79.

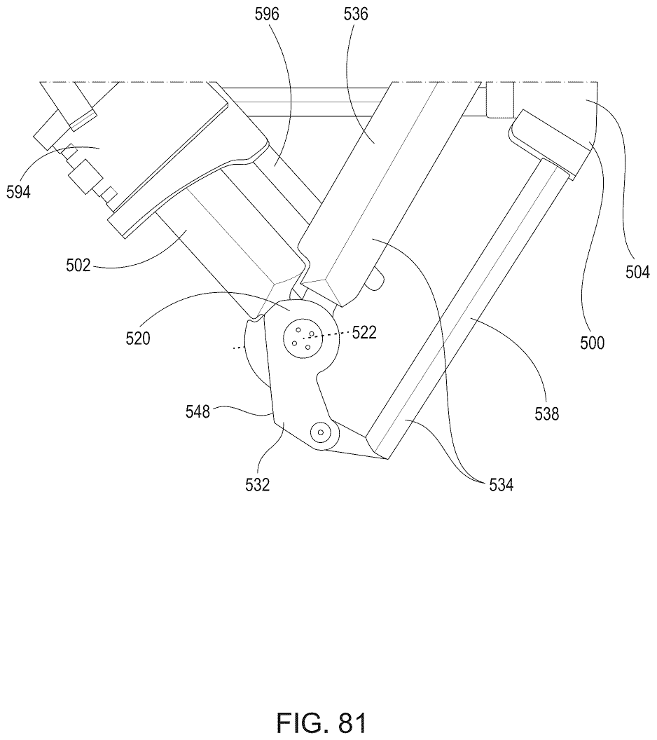

Positioning system 100 (FIG. 1), such as surgery table 200 (FIG. 1) or spar 500 (FIG. 3), or components thereof, may include one or more manual controls. Manual controls may be actuated proximate to the component that is controlled. A manual lock 548 is shown in FIG. 81.

Spar 500 may be locked via manual lock 548. For example, joint 520 of spar 500 may be locked via manual lock 548. Additionally or alternatively, spar 500 articulation in pitch, yaw, and translation motions may be unlocked via manual lock 548. In other words, manual lock 548 may be used to alternately release and lock spar 500 to articulate spar 500 in at least one of flex, pitch, yaw, and translate motions. Manual lock 548 may be used in addition or alternatively to remote controls that are not proximate to joint 520 to lock and release spar 500.

Manual lock 548 may be proximate joint 520, such as directly below joint 520. Manual lock 548 may have a small profile. Accordingly, manual lock 548 may not affect imaging. At least a portion of manual lock 548 may be embedded in spar 500, such as joint 520. In other words, manual lock 548 may be formed in joint 520. In this way, manual lock 548 may include a small profile. Manual lock 548 may have a hook end that may be pulled by user 40 (FIG. 23) to assist in spar articulation, and in certain embodiments, translation for traction. For example, manual lock 548 may be pulled by user 40 (FIG. 23) to manually translate spar 500. Manual articulation of spar 500 may allow user 40 to feel spar 500 articulation, such as traction, and how patient 20 (FIG. 18) may respond to the articulation. In addition, manual articulation may allow for lower traction loads to be applied. Manual lock 548 may be actuated from sterile space 10 (FIG. 1). may Manual lock 548 may be located between the waist and chest of user 40 such that user 40 may actuate manual lock 548 from sterile space 10. Manual lock 548 may be actuated through any one or more drapes 46 (FIG. 18). Drapes corresponding to manual lock 548 may include a film portion so that the user may locate manual lock 548.

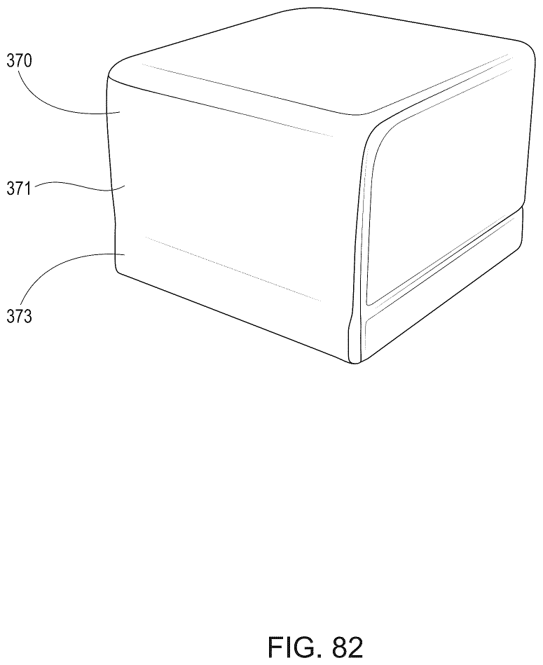

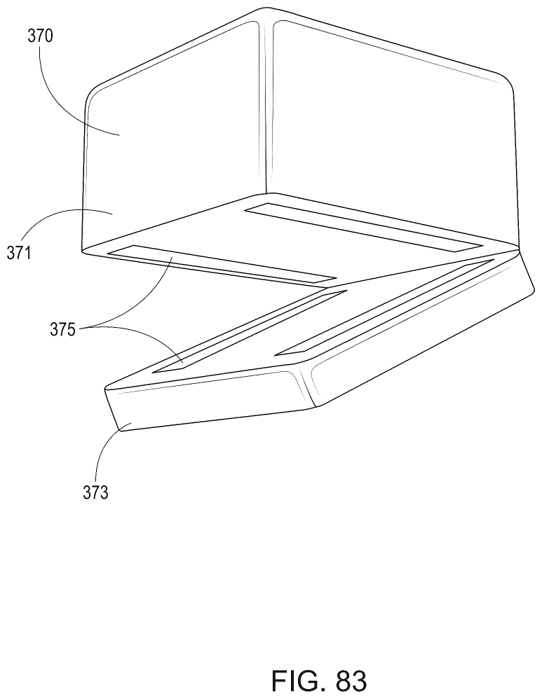

A head support 370 is shown in FIGS. 82-83 according to exemplary embodiments. Head support 370 may support patient 20 (FIG. 18), such as at least a head 24 (FIG. 18) of patient 20. Head support 370 may support patient 20 in a supine position. Additionally or alternatively, head support 370 may support patient 20 in a prone position. Additionally or alternatively, head support 370 may support patient 20 in a lateral position.

As shown, head support 370 may support patient 20 (FIG. 18) in a lateral position. Head support 370 may include a first foam 371 and a second foam 373. First foam 371 may be softer than second foam 373. First foam 371 may receive at least head 24 (FIG. 18) of patient 20. Arm 22 (FIG. 18) of patient 20 may extend laterally and may be disposed adjacent to head support 370. Second foam 373 may be pivoted outwardly to accommodate smaller sized patients. With reference to FIG. 83 first foam 371 and second foam 373 may include one or more fasteners, such as adhesive, buttons, or hook and loop fasteners, that may be alternately released and fastened to respectively outwardly pivot second foam 373 or couple first foam 371 and second foam 373. Head support 370 may receive a cover, which may be single use and sterile.

Positioning system 100 (FIG. 1), such as surgery table 200 (FIG. 1), or components thereof, may include lateral board 980, shown in FIG. 100 according to exemplary embodiments. Lateral board 980 may be coupled to one or more spars 500 (FIG. 1). For example lateral board 980 may be clamped to a part of spars 500. Lateral board 980 may be installed onto spar 500 laterally, e.g., lateral board 980 may be side-mounted onto spar 500 and fixed along spar 500. Lateral board 980 may be fixed to spar 500 via a clamp, for example, or a spar adapter also used for portable UAI 368 (not shown). Lateral board 980 may be static and not articulable. Lateral board 980 may extend from proximal end 504 (FIG. 1) to distal end 502 (FIG. 1) of spars 500 (FIG. 1). Alternatively, lateral board 980 may extend from proximal end 504 to a part of spars 500 between proximal end 504 and distal end 502. Lateral board 980 may support at least a portion of patient 20, such as when patient 20 is in a lateral position.

In hip surgery, lateral board 980 may support the non-operable leg. As lateral board 980 is mounted to spar 500, lateral board 980 may be articulated with spar 500, such as yawed or pitched. Lateral board 980 may be used on either spar 500 to support either leg. Lateral board 980 may include a width of about two-thirds of surgery table 200 (FIG. 1) to balance support for patient 20 (FIG. 18) and surgical access. As shown, lateral board 980 may include a cutout 982. Cutout 982 may create a concavity along a side of lateral board 980 such that lateral board 980 has less material but still may support patient 20 in a lateral position. In addition, cutout 982 may support user 40 (FIG. 19) in standing between spars 500 such as to access operable leg 32 (FIG. 20) directly from medial and lateral sides. Edges of lateral board 980 may be engineered to minimize risk of pressure injury. Lateral board 980 may be radiolucent. Lateral board 980 may include carbon fiber.

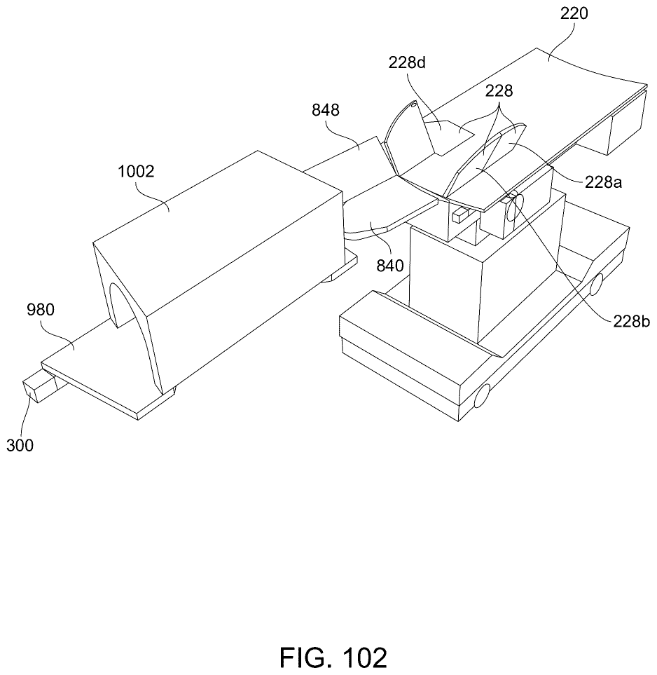

Another lateral positioning setup may be seen in FIG. 102 according to exemplary embodiments. As shown, a leg tunnel 1002 may rest on lateral board 980. Leg tunnel 1002 may be used during trauma procedures, e.g., ankle procedures and other lower limb trauma procedures. Leg tunnel 1002 ay allow complete access to the posterior pelvis area of patient 20 (FIG. 18). To facilitate this access, only one lateral portion 848 may be attached to pelvic center board 840 such that the posterior pelvis area is completely accessible without lateral portion 848 interference. Lateral wings 228a and 228b may be articulated upward to support a backside of patient 20. Lateral wing 228d may be flat and not articulated to allow arms 22 of patent 20 to extend outwardly as patient is positioned laterally.

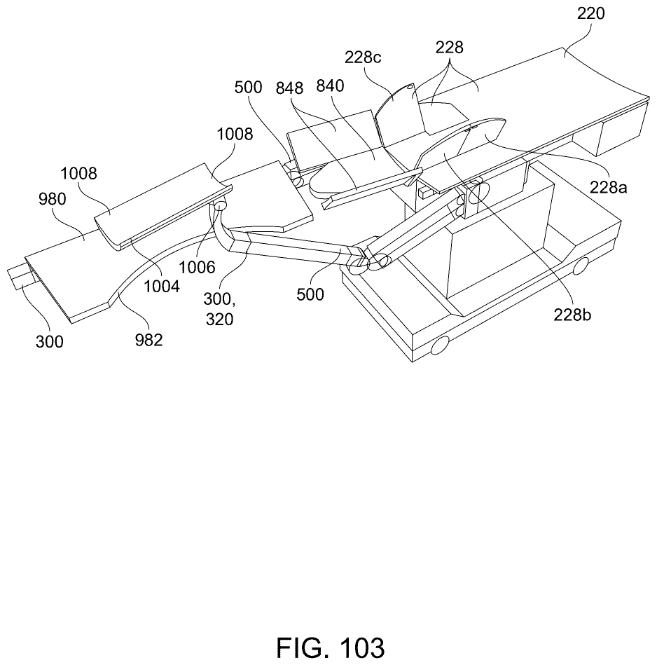

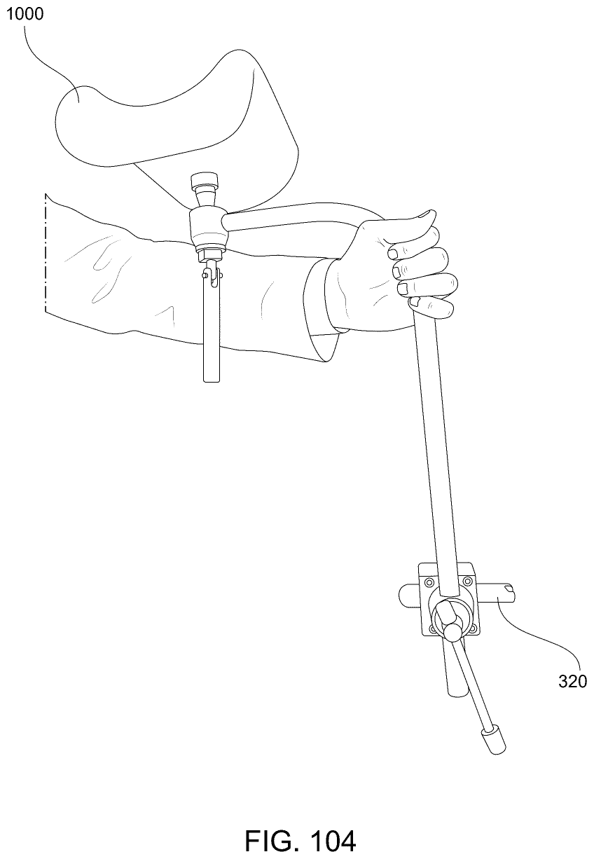

Another lateral positioning setup may be seen in FIG. 103 according to exemplary embodiments. A leg cradle 1004 may be attached to spar 500 via UAI port 300 on spar 500. Leg cradle 1004 may support leg 32 of patient 20 (FIG. 18).

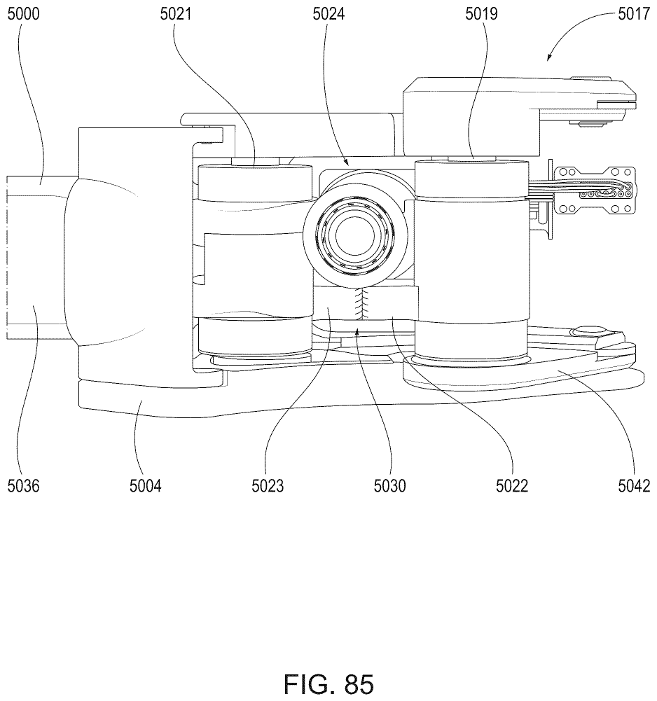

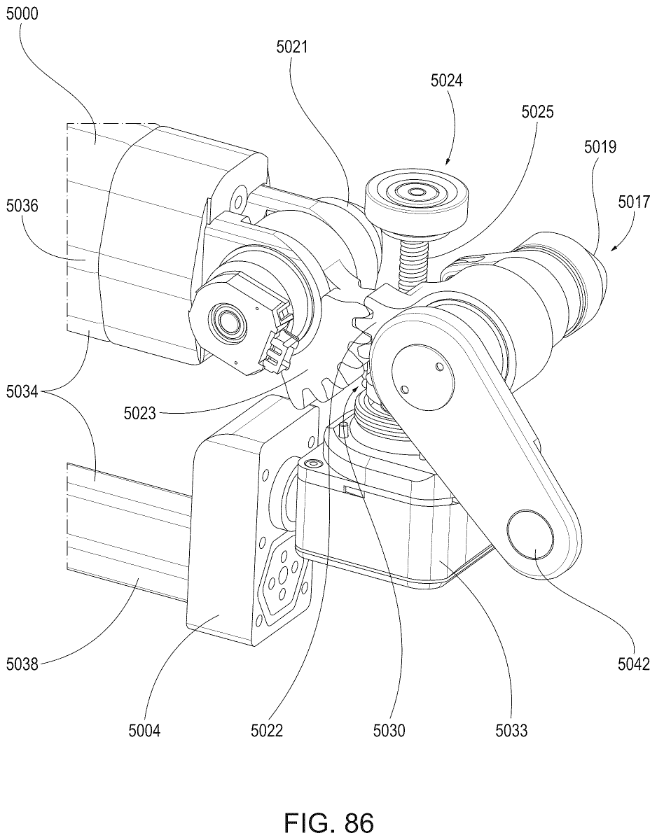

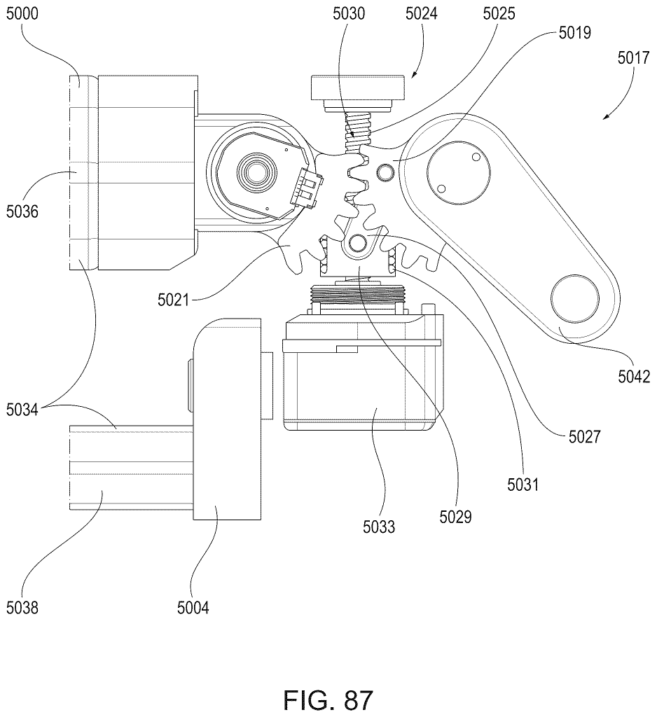

Spar 5000 is shown with reference to FIGS. 84-90 according to exemplary embodiments. Spar 5000 may include any of the features of spar 500 (FIG. 3) discussed above and vice versa. Accordingly, in an example, spar 5000 may be part of positioning system 100 (FIG. 1). In another example, spar 5000 may be a part of surgery table 200 (FIG. 1). In another example, spar 5000 may function separately, such as with other positioning systems, surgery tables, or apparatuses thereof. In an example, spar 5000 may include features that are functional separately and in combination.

As spar 5000 flexes, proximal end 5004 may fold toward distal end 5002. Referring to FIGS. 84-87, in certain embodiments, proximal end 5004 may include one or more gears 5030 that may control the orientation of proximal end 5004. For example, one or more gears 5030 may include two gears 5030, such as a proximal gear 5022 and a distal gear 5023. Gears 5030 may be arranged as a pair. Gears 5030 may counterrotate relative to one another and mesh together. Proximal gear 5022 of the pair may be coupled to a proximal rotational shaft 5019. Distal gear 5023 of the pair may be coupled to a distal rotational shaft 5021, which may be coupled to first link 5036 to control the orientation of first link 5036 of spar 5000. With reference to the discussion above for spar 500 (FIG. 3), spar 5000 may include passive link 532 (FIG. 5), stationary link 541 (FIG. 5), and rotating link 542 (FIG. 5). Gears 5030 counterrotating and meshing may cause rotating link 542 to rotate at substantially the same time as gears 5030 rotate. Rotating link 542 may rotate towards stationary link 541, as shown in FIG. 5. Accordingly, link 5036 and link 5038 may be moved such that link 5036 and link 5038 remain parallel to one another. Passive link 532 may rotate in inferior direction 103 (FIG. 1) to compensate for rotating link 542 rotating toward stationary link 541. Rotating link 542 may be rotated away from stationary link 541 and passive link 532 may rotate in superior direction 105 (FIG. 1) as spar 5000 is unfolded at least partially, such as unfolded fully, to reach straight spar configuration 506. Accordingly, in embodiments, the pitch of distal end 5002 may be controlled by rotation of passive link 532, which is linked via gears 5030 to rotation of proximal end 5004.

Referring again to FIGS. 84-87, in other embodiments, a locking mechanism 5017 of spar 5000 may lock the orientation of proximal end 5004. Accordingly, the orientation of distal end 5002 may be locked. Proximal end 5004 may include locking mechanism 5017. Locking mechanism 5017 may lock first link 5036. Accordingly, proximal end 5004 may be prevented from folding toward distal end 5002. Locking mechanism 5017 may including proximal rotational shaft 5019, distal rotational shaft 5021 coupled to first link 5036, and gears 5030. Locking mechanism 5017 may include gears 5030 to alternately rotate and lock first link 5036. Aks shown, proximal gear 5022 coupled to proximal rotational shaft 5019 may be coupled to distal gear 5023 coupled to distal rotational shaft 5021 such that distal rotational shaft 5021 may rotate relative to proximal rotational shaft 5019 as gears 5030 rotate relative to one another. Locking proximal rotational shaft 5019 may lock distal rotational shaft 5021 to lock first link 5036 in position as gears 5030 stop rotating relative to one another when proximal rotational shaft 5019 is stopped from rotating.

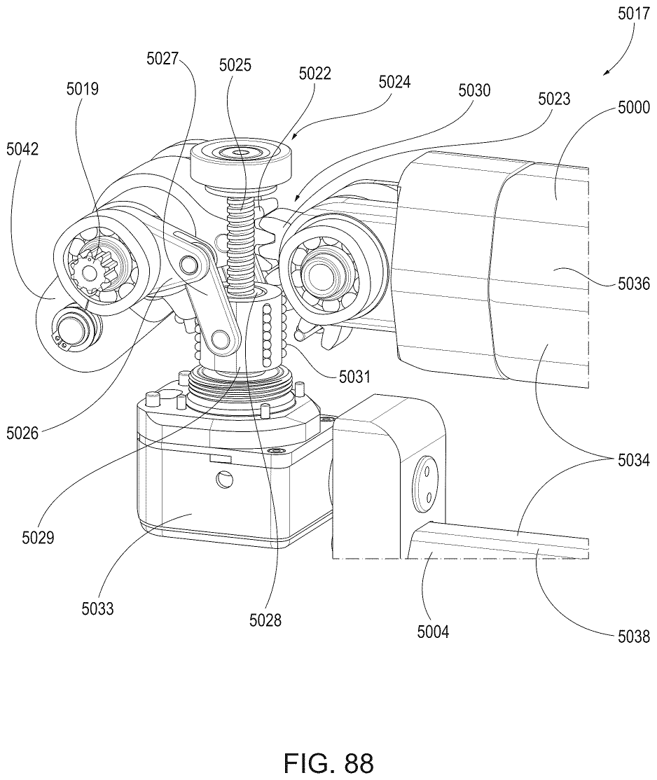

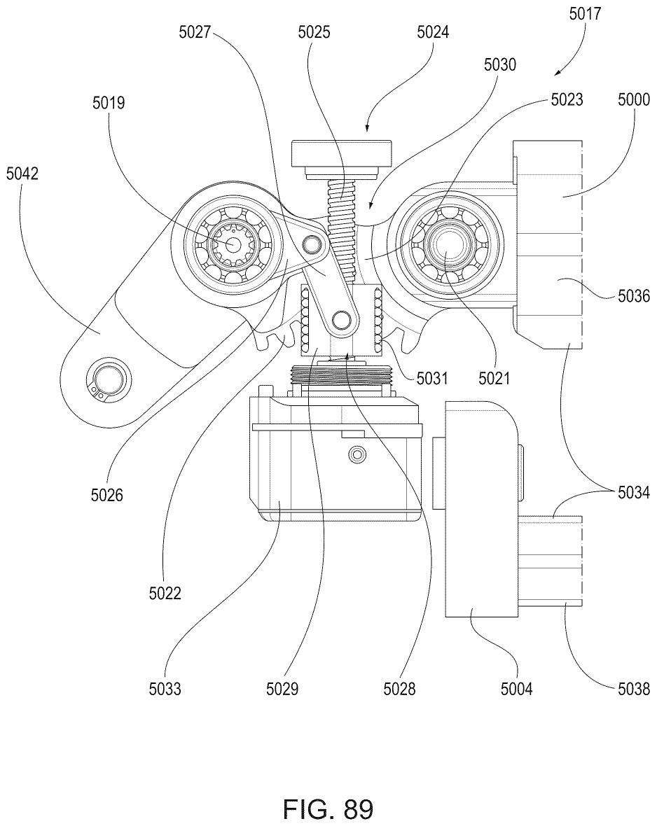

Referring to the embodiments shown in FIGS. 88-89, proximal rotational shaft 5019 may be rotated or stopped from rotating by a slider-crank mechanism 5024. Accordingly, slider-crank mechanism 5024 may control the orientation of proximal end 5004, and locking mechanism 5017 may include slider-crank mechanism 5024 to lock proximal rotational shaft 5019 and therefore first link 5036. In one embodiment, slider-crank mechanism 5024 may include an electromagnetic brake 5033. When electromagnetic brake 5033 is unlocked, proximal rotational shaft 5019 may be rotated. When electromagnetic brake 5033 is locked, proximal rotational shaft 5019 may be stopped from rotating. Slider-crank mechanism 5024 may also include a ball screw 5025 and a ball nut 5028 coupled to ball screw 5025. Ball screw 5025 may rotate and ball nut 5028 may translate vertically along ball screw 5025 when electromagnetic brake 5033 is unlocked. Ball screw 5025 may stop rotating and ball nut 5028 may be locked in position when electromagnetic brake 5033 is locked.

In embodiments, slider-crank mechanism 5024 may also include a slider link 5027. Slider link 5027 may be coupled to proximal rotational shaft 5019. Slider link 5027 may be coupled to a crank arm 5026, which is coupled to proximal rotational shaft 5019. Accordingly, slider link 5024 may rotate proximal rotational shaft 5019 when electromagnetic brake 5033 is unlocked. Slider link 5027 may be locked in position when electromagnetic brake 5033 is locked such that proximal rotational shaft 5019 is locked to lock first link 5036.

As shown in one embodiment, slider link 5027 may be coupled to ball nut 5028 and proximal rotational shaft 5019. Electromagnetic brake 5033 may be coupled to ball screw 5025 to alternately rotate and stop rotation of ball screw 5025 and alternately vertically translate and stop vertical translation of ball nut 5028. Ball nut 5028 may vertically translate along with a slider housing 5029. Ball nut 5028 may be housed by slider housing 5029 having slider bearings 5031 to rotate around ball screw 5025. Slider housing 5029 having ball nut 5028 may vertically translate along ball screw 5025, thereby vertically translating slider link 5027 to rotate proximal rotational shaft 5019 to adjust the orientation of first link 5036. In other words, ball screw 5025 may rotate such that ball nut 5028 translates vertically when electromagnetic brake 5033 is unlocked, causing slider link 5027 to translate vertically and rotate proximal rotational shaft 5019 to adjust the orientation of first link 5036. Ball screw 5025 may stop rotating when electromagnetic brake 5033 is locked such that slider link 5027 is locked in position to lock proximal rotational shaft 5019 to lock first link 5036. First link 5036 may be locked as it is coupled to distal rotational shaft 5021, which may be geared to proximal rotational shaft 5019.

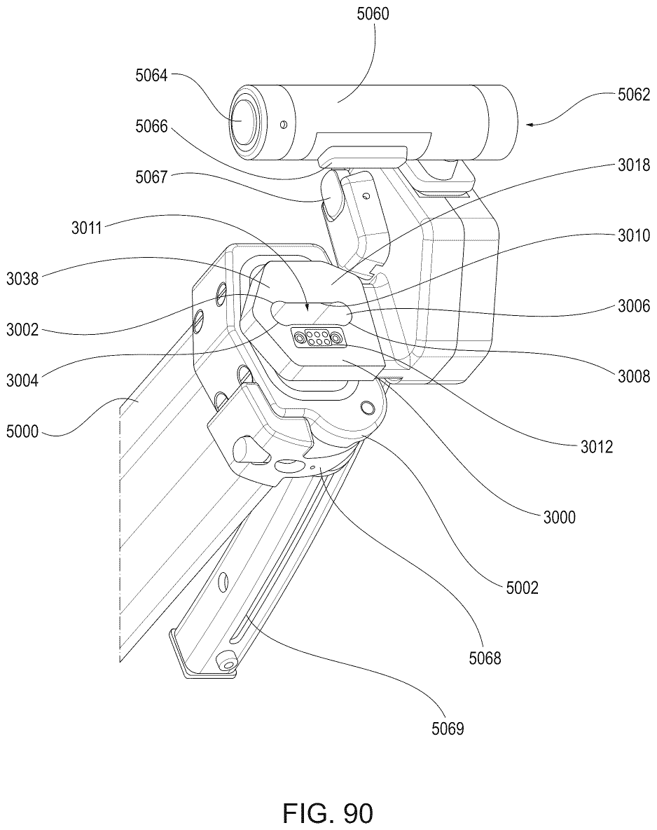

One embodiment of distal end 5002 of spar 5000 is shown in FIG. 90. As discussed above, distal end 5002 of spar 5000 may include handle 5060 to allow user 40 (FIG. 23) to articulate spar 5000. Distal end 5002 may also include one or more joint controls. In embodiments, joint 5020 (FIG. 84) may be locked in a particular orientation when a corresponding user interface is released. Accordingly, spar 5000 may be stiff, or generally immovable, when joint 5020 is locked. Handle 5060 may include one or more joint controls, such as button 5062, button 5064, and a button 5066. At least one of button 5062, button 5064, and button 5066 may include joint controls. Button 5062 may be similar to control 562 (FIG. 5) discussed above. Control 564 may be similar to control 564 (FIG. 5) discussed above. Button 5066 may be a pressure plate. Button 5066 may be similar to control 565 (FIG. 5) discussed above. In one embodiment, actuating button 5066 may allow for spar 5000 (FIG. 84) articulation in translation and yaw motions, similar to control 565.

Handle 5060 may include a handle extension lock 5067. Handle extension lock 5067 may have a safety function. Accordingly, handle extension lock 5067 may be released to allow handle 5060 to be repositionable. As shown, a handle extension slider 5069 may be extended relative to spar 5000 to extend handle 5060 in inferior direction 103 (FIG. 1). Alternatively, handle extension slider 5069 may be retracted relative to spar 5000 to retract handle 5060 in superior direction 101 (FIG. 1). Handle 5060 may include a spar extension lock 5068, which may also have a safety function. Accordingly, spar extension lock 5068 may be released to allow spar 5000 to be lengthened or shortened. Distal end 5002 may include a telescoping means to allow spar 5000 to lengthen or shorten. Proximal end 5004 (FIG. 84) may be positioned at a generally constant longitudinal distance relative to platform 220 (FIG. 1) as distal end 5002 is repositioned longitudinally relative to platform 220 by releasing spar extension lock 5068.

Referring to FIGS. 3 and 84, Spar 500 and spar 5000 may articulate relative to surgical table 200 (FIG. 1). Spar 500 and spar 5000 may be positioned relative to centerline 110 (FIG. 1) of positioning system 100 (FIG. 1), or surgical table 200, to facilitate articulation. Spar 500 and spar 5000 may be positioned laterally at a farther distance from centerline 110 to facilitate a wider range of articulation. Articulation may include pitch and yaw motions. Articulation may be described relative to straight spar configuration 506, in which spar 500 and spar 5000 extend along a horizontal plane of surgical table 100 and along axes generally parallel to centerline 110. Accordingly, in straight spar configuration 506, spar 500 and spar 5000 are not pitched or yawed. Spar 500 and spar 5000 may pitch in an upward direction from straight spar configuration 506 between about five degrees and about 40 degrees, such as between about 10 degrees and about 30 degrees, such as about 20 degrees. Spar 500 and spar 5000 may pitch in a downward direction from straight spar configuration 506 between about five degrees and about 50 degrees, such as between about 20 degrees and about 40 degrees, such as about 36 degrees. Spar 500 and spar 5000 may yaw from straight spar configuration 506 inward toward centerline 110 between about five degrees and about 40 degrees, such as between about 10 degrees and about 30 degrees, such as about 20 degrees. Spar 500 and spar 5000 may yaw from straight spar configuration 506 outward away from centerline 110 between about five degrees and about 60 degrees, such as between about 20 degrees and about 50 degrees, such as about 40 degrees.

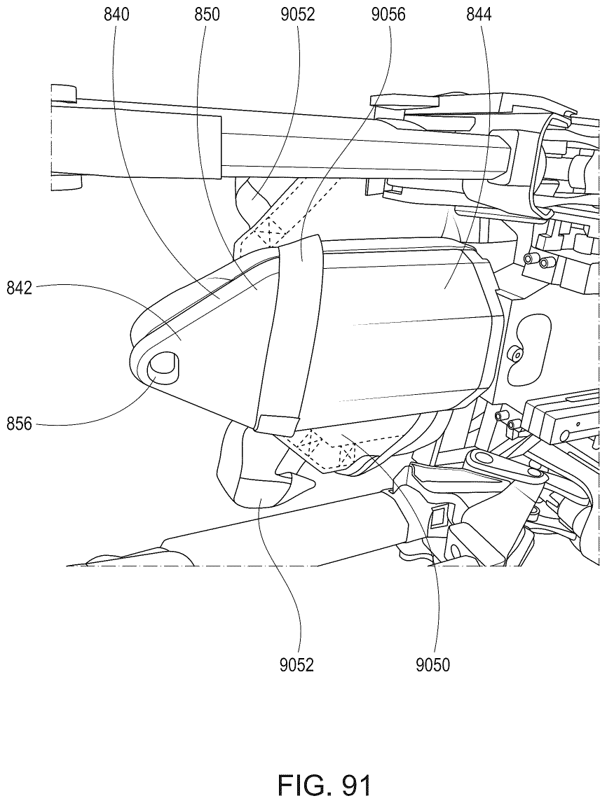

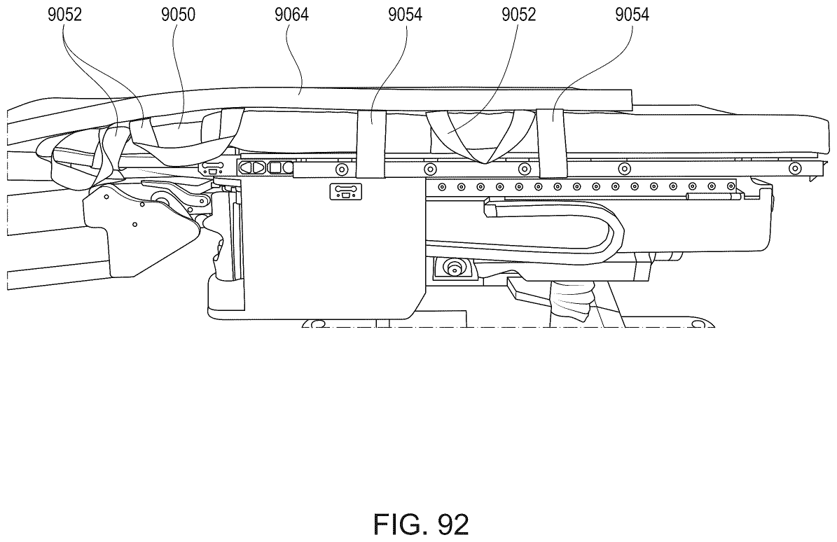

Traction pad 9050 is shown in FIGS. 91-92 according to exemplary embodiments. Traction pad 9050 may include any of the features of traction pad 950 (FIG. 69) discussed above and vice versa. Accordingly, in an example, traction pad 9050 may be part of positioning system 100 (FIG. 1). In another example, traction pad 9050 may be a part of surgery table 200 (FIG. 1). In another example, traction pad 9050 may function separately, such as with other positioning systems, surgery tables, or apparatuses thereof. In an example, traction pad 9050 may include features that are functional separately and in combination.

Traction pad 9050 may include one or more positioning handles 9052 to facilitate placing traction pad 9050 along platform 220 (FIG. 1), in some embodiments, while supporting patient 20 (FIG. 18). Traction pad 950 may be disposed along platform 220. Traction pad 950 may include one or more side rail straps 9054 to secure to rails 226 (FIG. 1) of surgery table 200 (FIG. 1). As shown, positioning handles 9052 may extend from traction pad 9050 at least partially in inferior direction 103 (FIG. 1). Alternatively, positioning handles 9052 may extend from traction pad 9050 more laterally. Additionally or alternatively, positioning handles 9052 may extend from traction pad 9050 at positions further in superior direction 101 (FIG. 1). Accordingly, positioning handles 9052 may further or wholly avoid an imaging window, such as top-down imaging window 106 (FIG. 9).

In addition, certain embodiments of traction pad 9050 may include one or more pelvic center board straps 9056 to couple traction pad 9050 to pelvic center board 840. As shown in FIG. 91, pelvic center board straps 9056 may secure around bottom portion 850 of pelvic center board 840 via fastener, such as adhesive or a hook and loop fastener, for example. Pelvic center board straps 9056 are shown extending around pelvic center board 840 laterally. Additionally or alternatively, pelvic center board straps 9056 may extend around distal end 842 of pelvic center board, such as around opening 8056. Accordingly, pelvic center board straps 9056 may extend around a nose portion of pelvic center board 840, where distal end 842 of pelvic center board 840 forms the nose portion. Pelvic center board straps 9056 may extend around distal end 842 forming the nose portion such that pelvic center board straps 9056 cross one another. Securing traction pad 9050 around angular portions of pelvic center board 840 may facilitate lateral stability in the attachment of traction pad 9050 around pelvic center board 840 as pelvic center board 840 and other components may shift or rotate during traction application. To secure pelvic center board straps 9056, pelvic center board 840 may include a fastener 866 that may extend laterally along bottom portion 850 of pelvic center board 840. Fastener 866 may be adhesive or a hook and loop fastener, for example.

As shown in FIG. 92, a foam top 9064 may be placed over traction pad 9050. Foam top 9064 may facilitate maintaining a position of patient 20 (FIG. 18) as traction is applied. Accordingly, foam top 9064 may increase countertraction forces. Foam top 9064 may also increase patient comfort. Foam top 9064 along with traction pad 9050 may form a traction pad assembly 9066. Traction pad 9050 may be stiffer or more rigid than foam top 9064. Traction pad assembly 9066 may facilitate maintaining a position of patient 20 as traction is applied.

Non-operable leg 32 may be supported by one or more components. As discussed herein, spar 500 (FIG. 3) may support non-operable leg 32 by securing foot 36 (FIG. 20) of patient 20 (FIG. 18) to a foot support coupled to spar 500. Additionally or alternatively, non-operable leg 32 may be supported on lateral board 980 (FIG. 82) or imaging board 984 (FIG. 83). Non-operable leg 32 may be positioned before the surgical procedure commences. Accordingly, non-operable leg 32 may be pre-operatively placed and then draped. Selection of which support is to be used for non-operable leg 32 may be based on procedure length, patient comfort, and user 40 (FIG. 19) preference.

As shown in FIG. 84 according to exemplary embodiments, non-operable leg 32 may be supported by a leg holder 1000. Non-operable leg 32 may rest on leg support 1000 and may hang off of leg holder 1000. As shown, leg holder 1000 may include a cradle-shape with upwardly sloping sidewalls to support non-operable leg 32, and downwardly sloping edges to allow non-operable leg 32 to hang off of well leg support 1000. Leg holder 1000 may couple to spar 500 (FIG. 3) via a UAI plug 320. UAI plug 320 of leg holder 1000 may be coupled to UAI port 300 (FIG. 38) at distal end 504 (FIG. 3) of spar 500. Alternatively, UAI plug 300 of leg holder 1000 may be coupled to portable UAI 368 having UAI port 300. UAI plug 320 may be separated from leg holder 1000 by an arm 1001. In this way, leg holder 1000 may position non-operable leg 32 away from operable leg to facilitate the surgical procedure. Leg holder 1000 may include a smaller support surface, offering flexibility for shorter procedures, such as medium-length procedures.

Other supports for non-operable leg 32 may include a foot sling (not shown). The foot sling may be similar to a “candy cane” stirrup known in the art. In positioning system 100 (FIG. 1), the foot sling may be devoid of the “candy cane” structure and, instead, an arm can attach the sling to spar base 400 and hold the sling below distal end 504 (FIG. 3) of spar 500. The foot sling may couple to spar 500 at distal end 504, such as by coupling to UAI port 300 (FIG. 38). Because of the lightweight and flexible structure of the foot sling, the foot sling may be less stable than leg holder 1000 but also may be patient-friendly by applying less pressure to patient 20 (FIG. 18) by allowing leg 32 to hang freely. The foot sling may be desirable for shorter procedures than leg holder 1000. Another support may be a leg stirrup (not shown) known in the art, which may be desirable for longer procedures. The leg stirrup may provide stability and support for longer procedures but may be bulkier. The leg stirrup, like leg holder 1000 and the foot sling, may be coupled to spar 500 at distal end 504, such as by coupling to UAI port 300. Each well leg support may articulate with spar 500. Spar 500 articulation is described herein.

With reference to FIGS. 1-108 and the discussion herein, a system 100 for supporting a patient 20 for a surgical procedure may include a surgery table 200 comprising a distal end 202, a proximal end 204 opposing distal end 202, and a platform 220 configured to support at least a portion of patient 20; a spar base 400 coupled to surgery table 200 and positioned beneath platform 220; a spar 500 coupled to and extending from spar base 400 and configured to support a leg 32 of patient 20; an electromechanical driver 270 comprised by at least one of spar base 400 or surgery table 200, electromechanical driver 270 configured to translate spar base 400 a distance along surgery table 200 between distal end 202 and proximal end 204 of surgery table 200; and one or more controls 280 configured to control electromechanical driver 270.

In some embodiments, spar base 400 may include a spar mount 410 configured to releasably couple spar 500, spar mount 410 including a spar mount electrical connection 421, and spar 500 may include a spar electrical connection 517 configured to releasably couple to spar mount electrical connection 421.

In some embodiments, spar base 400 may include one or more joints 420 configured to articulate spar mount 410.

In some embodiments, a pitch axis 424 about which spar 500 is configured to pitch and a yaw axis 428 about which spar 500 is configured to yaw may intersect distal to distal end 202 of surgery table 200, and pitch axis 424 and yaw axis 428 may not be provided by a ball joint.

In some embodiments, spar base 400 may be configured to articulate spar 500 in a pitch direction, including to articulate spar 500 in a downward pitch direction to a downward pitch angle 514 from an axis 510 extending along spar 500 when spar 500 is in a straight configuration 506, downward pitch angle 514 being up to about 45 degrees.

In some embodiments, spar 500 may include a distal end 502 and a proximal end 504 opposing distal end 502, and proximal end 504 of spar 500 may be devoid of a traction mechanism.

In some embodiments, electromechanical driver 270 may include a lead screw 272 coupled to and configured to translate spar base 400, electromechanical driver 270 fur r configured to apply traction to patient 20 by translating spar base 400 towards distal end 202, and one or more controls 280 may be configured to adjust a traction load.

In some embodiments, electromechanical driver 270 may be configured to apply traction by pushing spar 500 outwardly from surgery table 200 in an inferior direction 103.

In some embodiments, spar 500 may include a distal end 502, a proximal end 504 opposing distal end 502, and a foot support 640 disposed at distal end 502 of spar 500 and configured to support a foot 36 of patient 20, and one or more controls 280 may include a first control 282 configured to incrementally translate spar 500 in an inferior direction 103, a second control 284 configured to incrementally translate spar 500 in a superior direction 101, a third control 286 configured to disengage electromechanical driver 270 and allow for manual translation of spar 500, and a fourth control 602, 604 configured to rotate foot support 640.

In some embodiments, surgery table 200 may fur r include a first side 206 extending between proximal end 204 and distal end 202, and spar base 400 may be disposed along first side 206 such that spar 500 extends from first side 206 and is configured to extend anterior to a hip and at least a portion of a leg 32 of patient 20.

In some embodiments, one or more controls 280 may be disposed along platform 220 proximate distal end 202 of surgery table 200.

A system 100 for supporting a patient 20 for a surgical procedure may include a surgery table 200 comprising a distal end 202, a proximal end 204 opposing distal end 202, and a platform 220 configured to support at least a portion of patient 20; a spar base 400 coupled to surgery table 200 and positioned beneath platform 220; a spar 500 comprising a distal end 502 and a proximal end 504 opposing distal end 502, proximal end 504 of spar 500 coupled to and extending from spar base 400 and configured to support a leg 32 of patient 20, spar 500 fur r comprising a foot support 640 coupled to and disposed at distal end 502 of spar 500 and configured to secure a foot 36 of leg 32 of patient 20; an electromechanical driver 270 comprised by at least one of spar base 400 or surgery table 200, electromechanical driver 270 configured to translate spar base 400 a distance along surgery table 200 between distal end 202 and proximal end 204 of surgery table 200; and one or more controls 280 configured to control electromechanical driver 270, wherein electromechanical driver 270 is fur r configured to apply traction to patient 20 when foot 36 of patient 20 is secured to foot support 640 by translating spar base 400 and pushing spar 500 outwardly from surgery table 200 in an inferior direction 103.

In some embodiments, spar base 400 may include a spar mount 410 configured to releasably couple to spar 500, spar mount 410 including a spar mount electrical connection 421, and spar 500 may include a spar electrical connection 517 configured to releasably couple to spar mount electrical connection 421.

In some embodiments, spar base 400 may include one or more joints 420 configured to articulate spar mount 410.

In some embodiments, spar base 400 may be configured to articulate spar 500 in a pitch direction, including to articulate spar 500 in a downward pitch direction to a downward pitch angle 514 from an axis 510 extending along spar 500 when spar 500 is in a straight configuration 506, downward pitch angle 514 being up to about 45 degrees.

In some embodiments, proximal end 504 of spar 500 may be devoid of a traction mechanism.

In some embodiments, one or more controls 280 may be disposed along platform 220 proximate distal end 202 of surgery table 200.

In some embodiments, electromechanical driver 270 may include a lead screw 272 coupled to and configured to translate spar base 400, electromechanical driver 270 fur r configured to apply traction to patient 20 by translating spar base 400 towards distal end 202, and one or more controls 280 may be configured to adjust a traction load.

In some embodiments, one or more controls 280 may include a first control 282 configured to incrementally translate spar 500 in an inferior direction 103, a second control 284 configured to incrementally translate spar 500 in a superior direction 101, a third control 286 configured to disengage electromechanical driver 270 and allow for manual translation of spar 500, and a fourth control 602, 604 configured to rotate foot support 640.

In some embodiments, surgery table 200 may fur r include a first side 206 extending between proximal end 204 and distal end 202, and spar base 400 may be disposed along first side 206 such that spar 500 extends from first side 206 and is configured to extend anterior to a hip and at least a portion of a leg 32 of patient 20.

A system 100 for supporting a patient 20 for a surgical procedure may include a platform 220 comprising a distal end 202, a proximal end 204 opposing distal end 202, and opposing lateral sides comprising a first lateral side 206 and a second lateral side 208, platform 220 configured to support at least a portion of patient 20; a spar base 400 positioned beneath platform 220 at distal end 202 of platform 220 and disposed along at least one of lateral sides 206, 208; a spar 500 configured to extend from spar base 400 and configured to support a leg 32 of patient 20, spar 500 comprising an inside edge and fur r configured to extend lateral to a hip and at least a portion of leg 32 of patient 20; and a top-down lower body imaging window 106 bounded on two adjacent sides by a superior side located at least at distal end 202 of platform 220 and a lateral side at inside edge of spar 500, wherein any portion of system 100 comprised within lower body imaging window 106 is radiolucent.

In some embodiments, spar 500 may be at least partially comprised within top-down imaging window 106.

In some embodiments, spar 500 may consist essentially of carbon fiber.

In some embodiments, spar 500 may comprise a generally hexagonal cross-section configured to minimize x-ray attenuation and avoid imaging artifacts.

In some embodiments, system 100 may fur r include a pelvic center board 840 coupled to platform 220 at distal end 202 and configured to support a pelvis of patient 20, and fur r configured to allow imaging of at least one of at least a portion of a hip of patient 20 or at least a portion of a pelvis of patient 20.

In some embodiments, pelvic center board 840 may be at least partially comprised within top-down imaging window 106, and pelvic center board 840 may consist essentially of carbon fiber.

In some embodiments, pelvic center board 840 may comprise a length, a distal end 842, a proximal end 844 opposing distal end 842, and a bottom portion 850, wherein pelvic center board 840 comprises a thickness, wherein a thickness of proximal end 844 is thicker longitudinally than a thickness of distal end 842, wherein bottom portion 850 comprises a curvature from proximal end 844 to distal end 842, wherein pelvic center board 840 comprises a generally triangular shape, and wherein distal end 842 and proximal end 844 each comprise a cross-section comprising a generally trapezoidal shape.

In some embodiments, pelvic center board 840 may comprise a shape configured to allow C-arm 1012 access from below a proximal end 204 of platform 220 for oblique imaging.

In some embodiments, combined height 108 may comprise a distance of about 20 inches.

In some embodiments, pelvic center board 840 may comprise a length configured to allow imaging of at least a portion of a lumbar spine starting at an L3 of a patient 20 of a size of a 98th percentile.

In some embodiments, pelvic center board 840 may comprise a mount 847 configured to couple pelvic center board 840 to platform 220, wherein mount 847 is fur r configured to extend about one inch beyond distal end 202 of platform 220, and fur r configured to be outside of top-down imaging window 106, and wherein superior side of top-down imaging window 106 is located about one inch inferior to distal end 202 of platform 220.

A system 100 for supporting a patient 20 for a surgical procedure may include a surgery table 200 comprising a distal end 202, a proximal end 204 opposing distal end 202, a platform 220 configured to support at least a portion of patient 20, a column 222 configured to support platform 220 and a base 224 configured to support column 222; a pelvic center board 840 coupled to surgery table 200 at distal end 202 and configured to allow imaging of at least one of at least a portion of a hip of patient 20 or at least a portion of a pelvis of patient 20; a perineal post 874 coupled to pelvic center board 840; an adapter 242, 246 configured to couple pelvic center board 840 to surgery table 200; an imaging path configured to allow a portion of a C-arm 1012 under platform 220 and adjacent to column 222 and to image at least one of a hip or a pelvis of a patient 20 at an imaging angle 113 of between about 45 degrees and about 55 degrees, wherein system 100 is configured not to block imaging path; and a spar 500 configured to extend from surgery table 200 and configured to support a leg 32 of patient 20, and fur r configured to extend lateral to a hip and at least a portion of leg 32 of patient 20, wherein a combined height 108 of spar 500, pelvic center board 840, and perineal post 874 comprises a distance between about 15 inches and about 30 inches.

In some embodiments, system 100 may fur r include an oblique lower body imaging window bounded at least by at least a portion of column 222 and at least a portion of base 224, wherein any portion of system 100 comprised within lower body imaging window is radiolucent.

In some embodiments, pelvic center board 840 may consist essentially of carbon fiber.

In some embodiments, pelvic center board 840 may comprise a shape configured to allow C-arm 1012 access for oblique imaging.

In some embodiments, pelvic center board 840 may be elongated in a proximal direction such that pelvic center board 840 comprises a length configured to allow imaging of at least a portion of a lumbar spine starting at an L3 of a patient 20 of a size of a 98th percentile.

In some embodiments, adapter may comprise an articulating adapter 246 configured to couple pelvic center board 840 to surgery table 200, wherein articulating adapter 246 is not comprised within imaging path.

In some embodiments, articulating adapter 246 may comprise at least one of a curvature or a chamfer configured to allow C-arm 1012 access for oblique imaging.

In some embodiments, adapter may comprise a static adapter 242 configured to couple pelvic center board 840 to surgery table 200, wherein static adapter 242 is not comprised within imaging path.

In some embodiments, imaging angle 113 may comprise an angle of about 50 degrees.

It should be noted that the use of particular terminology when describing certain features or embodiments of the disclosure should not be taken to imply that the terminology is being re-defined herein to be restricted to include any specific characteristics of the features or embodiments of the disclosure with which that terminology is associated. Terms and phrases used in this application, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term “includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise.

In addition, as used herein, the term “coupled” means connected to or joined to or placed into communication with, either directly or through intermediate components. The term “patient” is broadly defined herein to include human patients of all sizes, genders and demographics, as well as animals (e.g., for veterinarian purposes). The terminology includes the words noted above, derivatives thereof and words of similar import.

It will be appreciated by those skilled in the art that changes could be made to the embodiments described above without departing from the broad inventive concept thereof. For example, various mechanical and electrical connection elements and actuators may be used to achieve the disclosed function. It is understood, therefore, that this invention is not limited to the particular embodiments disclosed, but it is intended to cover modifications within the spirit and scope of the present invention as defined by the appended claims.

What is claimed is:

1. A system for supporting a patient for a surgical procedure, the system comprising:
a platform comprising a distal end, a proximal end opposing the distal end, and opposing lateral sides comprising a first lateral side and a second lateral side, the platform configured to support at least a portion of the patient;
a spar base positioned beneath the platform at the distal end of the platform and disposed along at least one of the lateral sides;
a spar configured to extend from the spar base and configured to support a leg of the patient, the spar comprising an inside edge, the spar further configured to extend lateral to a hip and at least a portion of the leg of the patient; and
a top-down lower body imaging window bounded on two adjacent sides by a superior side located at least at the distal end of the platform and a lateral side at the inside edge of the spar, wherein any portion of the system comprised within the lower body imaging window is radiolucent.

2. The system of claim 1, wherein the spar is at least partially comprised within the top-down imaging window.

3. The system of claim 1, wherein the spar consists essentially of carbon fiber.

4. The system of claim 1, wherein the spar comprises a generally hexagonal cross-section configured to minimize xray attenuation and avoid imaging artifacts.

5. The system of claim 1, further comprising:
a pelvic center board coupled to the platform at the distal end and configured to support a pelvis of the patient, and further configured to allow imaging of at least one of at least a portion of a hip of the patient or at least a portion of a pelvis of the patient.

6. The system of claim 5, wherein the pelvic center board is at least partially comprised within the top-down imaging window, and
wherein the pelvic center board consists essentially of carbon fiber.

7. The system of claim 5, wherein the pelvic center board comprises a length, a distal end, a proximal end opposing the distal end, and a bottom portion,
wherein the pelvic center board comprises a thickness,
wherein a thickness of the proximal end is thicker longitudinally than a thickness of the distal end,
wherein the bottom portion comprises a curvature from the proximal end to the distal end,
wherein the pelvic center board comprises a generally triangular shape, and
wherein the distal end and the proximal end each comprises a cross-section comprising a generally trapezoidal shape.

8. The system of claim 5, wherein the pelvic center board comprises a shape configured to allow C-arm access from below a proximal end of the platform for oblique imaging.

9. The system of claim 8, wherein the combined height comprises a distance of about 20 inches.

10. The system of claim 5, wherein the pelvic center board comprises a length configured to allow imaging of at least a portion of a lumbar spine starting at an L3 of a patient of a size of a 98th percentile.

11. The system of claim 5, wherein the pelvic center board comprises a mount configured to couple the pelvic center board to the platform,
wherein the mount is further configured to extend about one inch beyond the distal end of the platform, and further configured to be outside of the top-down imaging window, and
wherein the superior side of the top-down imaging window is located about one inch inferior to the distal end of the platform.

12. A system for supporting a patient for a surgical procedure, the system comprising:
a surgery table comprising a distal end, a proximal end opposing the distal end, a platform configured to support at least a portion of the patient, a column configured to support the platform and a base configured to support the column;
a pelvic center board coupled to the surgery table at the distal end and configured to allow imaging of at least one of at least a portion of a hip of the patient or at least a portion of a pelvis of the patient;
a perineal post coupled to the pelvic center board;
an adapter configured to couple the pelvic center board to the surgery table,
an imaging path configured to allow a portion of a C-arm under the platform and adjacent to the column and to image at least one of a hip or a pelvis of a patient at an imaging angle of between about 45 degrees and about 55 degrees, wherein the system for supporting a patient for a surgical procedure is configured not to block the imaging path; and
a spar configured to extend from the surgery table and configured to support a leg of the patient, and further configured to extend lateral to a hip and at least a portion of the leg of the patient,
wherein a combined height of the spar, the pelvic center board, and the perineal post comprises a distance between about 15 inches and about 30 inches.

13. The system of claim 12, further comprising:
an oblique lower body imaging window bounded at least by at least a portion of the column and at least a portion of the base, wherein any portion of the system comprised within the lower body imaging window is radiolucent.

14. The system of claim 12, wherein the pelvic center board consists essentially of carbon fiber.

15. The system of claim 12, wherein the pelvic center board comprises a shape configured to allow C-arm access for oblique imaging.

16. The system of claim 12, wherein the pelvic center board is elongated in a proximal direction such that the pelvic center board comprises a length configured to allow imaging of at least a portion of a lumbar spine starting at an L3 of a patient of a size of a 98th percentile.

17. The system of claim 12, wherein the adapter comprises an articulating adapter configured to couple the pelvic center board to the surgery table,
wherein the articulating adapter is not comprised within the imaging path.

18. The system of claim 17, wherein the articulating adapter comprises at least one of a curvature or a chamfer configured to allow C-arm access for oblique imaging.

19. The system of claim 12, wherein the adapter comprises a static adapter configured to couple the pelvic center board to the surgery table,
wherein the static adapter is not comprised within the imaging path.

20. The system of claim 12, wherein the imaging angle comprises an angle of about 50 degrees.
